(19) United States
(12) Patent Application Publication
(10) Pub. No.: US 2020/0245741 A1
(43) Pub. Date: Aug. 6, 2020

(54) Pump Fed Shaving Lather Generating And Dispensing System And Method Of Operation Thereof

(71) Applicant: Carl F. Cwiok, Peabody, MA (US)

(72) Inventor: Carl F. Cwiok, Peabody, MA (US)

(21) Appl. No.: 16/268,581

(22) Filed: Feb. 6, 2019

(51) Int. Cl. A45D 27/06; B01F 3/04; B01F 15/06; B01F 15/00

(52) U.S. Cl. CPC A45D 27/06; B01F 3/04588; B01F 2015/062; B01F 15/00201; B01F 15/00396; B01F 15/065

(57) ABSTRACT

A novel and useful pump fed shaving lather generator apparatus incorporating a body having a cavity and an inlet port, A removable mixture cartridge includes a reservoir for containing a fluid, an outlet port extension coupled to the reservoir and configured to be releasably coupled to the inlet port. A first valve selectively controls flow of the fluid from the outlet port extension. A lather generator is situated within the cavity of the body and defines a cylindrical cavity with first and second openings. A cylindrical lather generating screw (LGS) situated within the cylindrical cavity is configured to generate a lather from the fluid. A motor coupled to the LGS and configured to rotate the LGS within the cylindrical cavity of the lather generator to drive the LGS to output the generated lather at the second opening.

### FIELD OF THE DISCLOSURE

The present system relates to a lathering system which can form and output a warm lather suitable for shaving and, more particularly, to a lathering system with an interchangeable lather solution cartridge and a system of operation thereof.

### BACKGROUND OF THE INVENTION

Heated lather dispensers typically include aerosol-type, pump-type, and screw-type dispensers. The aerosol-type lather dispensers rely upon a compressed lather solution which expands upon being released to atmospheric pressure to form a lather suitable for shaving. Unfortunately, the shave lather produced using this method may be inferior to that produced by other types of dispensers such as the screw-type dispenser and may include undesirable chemicals to aid in the conversion to a lather. With regard to pump-type dispensers, these dispensers rely upon piston type pumps to force a lather solution through a screen to produce a lather suitable for shaving. Unfortunately, this method also produces a shave lather which is inferior to that generated by screw-type lather machines.

With regard to screw-type lather dispensers, these machines as a class are exemplified by U.S. Pat. No. 3,580,863 to Campbell, the contents of which are incorporated herein by reference, and have large open reservoirs which may hold a lather solution suitable for forming a lather suitable for shaving. Unfortunately, these machines are bulky, difficult to clean, and require frequent maintenance. For example, individual portions such as reservoirs, etc. of these machines cannot be easily removed for service and/or cleaning. Further, conventional screw-type lather machines cannot readily dispense different types of lather (e.g., lather of different types, scents, etc.) without emptying the reservoir. Accordingly, the present systems and methods overcome these deficiencies of the above-mentioned prior art systems.

### SUMMARY OF THE INVENTION

The systems, devices, methods, user interfaces, arrangements, computer programs, processes, etc. (hereinafter each of which will be referred to as system, unless the context indicates otherwise), described herein address and/or overcome problems in prior art systems.

There is thus provided in accordance with the invention, a pump fed shaving lather generator apparatus, comprising a body having a cavity and an inlet port, a removable mixture cartridge comprising a reservoir for containing a fluid, an outlet port extension coupled to the reservoir and configured to be releasably coupled to the inlet port, and a first valve for selectively controlling flow of the fluid from the outlet port extension, a lather generator situated within the cavity of the body and defining a cylindrical cavity with first and second openings, a cylindrical lather generating screw (LGS) situated within the cylindrical cavity and configured to generate a lather from the fluid, and a motor coupled to the LGS and configured to rotate the LGS within the cylindrical cavity of the lather generator to drive the LGS to output the generated lather at the second opening.

There is also provided in accordance with the invention, a shaving lather generator apparatus, comprising a body having a cavity and an inlet port configured to couple to an outlet port of a mixture cartridge having a first valve and a reservoir for containing a fluid, a lather generator situated within the cavity of the body and defining a cylindrical cavity with first and second openings, a cylindrical lather generating screw (LGS) situated within the cylindrical cavity and configured to generate a lather from the fluid, the lather being output via the second opening of the lather generator, a motor coupled to the LGS and configured to rotate the LGS within the cylindrical cavity, a second valve situated between, and coupled to, the inlet port and the first opening, and configured to selectively control the flow of the fluid from the inlet port to the first opening, and first and second actuators, the first actuator configured to selectively control the first valve, and the second actuator configured to selectively control the second valve.

There is further provided in accordance with the invention, a lather generating device, comprising a body comprising, an opening configured to receive at least a portion of a mixture cartridge, a fluid receiving port situated in the opening and configured to receive a fluid from the mixture cartridge, a lather generator configured to receive the fluid from the fluid receiving port and generate a lather therefrom, the lather generator comprising a lather generating screw situated within an inner cavity thereof, a controller configured to determine whether a heater mode is active, and a heater configured to heat the lather generator, wherein the controller is configured to engage the heater when it is determined that the heater mode is active.

### BRIEF DESCRIPTION OF THE DRAWINGS

The present invention is explained in further detail in the following exemplary embodiments and with reference to the figures, where identical or similar elements may be partly indicated by the same or similar reference numerals, and the features of various exemplary embodiments being combinable. The invention is herein described, by way of example only, with reference to the accompanying drawings, wherein:

FIG. 1A is a block diagram illustrating a portion of a first example lathering system of the present invention;

FIG. 1B is a block diagram illustrating a portion of a second example lathering system of the present invention;

FIG. 2 is a diagram illustrating a perspective front view of a portion of an example lathering system of the present invention;

FIG. 3 is a diagram illustrating a partially exploded perspective front view of a portion of an example lathering system of the present invention;

FIG. 4 is a diagram illustrating a cross-sectional view of a portion of the lathering system 21 taken along lines 4-4 of FIG. 2;

FIG. 5A is a diagram illustrating a cross-sectional view of a portion of the lathering system taken along lines 5-5 of FIG. 2;

FIG. 5B is a diagram illustrating a detailed cross-sectional view of a portion of the system including the MCV of FIG. 5A;

FIG. 5C is a diagram illustrating an exploded detailed cross-sectional view of a portion of the MCV of FIG. 5B;

FIG. 5D is a diagram illustrating a top view of a portion of the inlet port of the lathering system;

FIG. 5E is a diagram illustrating a cross-sectional view of a portion of the port extension of the lathering system taken along lines 5E-5E of FIG. 5C;

FIG. 5F is a diagram illustrating a bottom view of a portion of the port extension of the lathering system;

FIG. 6A is a diagram illustrating a cross-sectional view of a portion of the lathering system taken along lines 6A-6A of FIG. 5A;

FIG. 6B is a diagram illustrating a cross-sectional view of a portion of the lathering system taken along lines 6B-6B of FIG. 4;

FIG. 7 is a diagram illustrating a cross-sectional view of a portion of the lathering system taken along lines 7-7 of FIG. 4;

FIG. 8 is a diagram illustrating a partially cutaway side view of a first portion of the mixture cartridge of the system;

FIG. 9 is a diagram illustrating a top perspective view of a first portion of the mixture cartridge of the system;

FIG. 10 is a diagram illustrating a bottom perspective view of a first portion of the mixture cartridge of the system;

FIG. 11 is a diagram illustrating a top perspective view of a first portion of the mixture cartridge of the system;

FIG. 12 is a diagram illustrating a partially cutaway end view of a first portion of the mixture cartridge of the system;

FIG. 13 is a diagram illustrating a top perspective view of a second portion of the mixture cartridge of the system;

FIG. 14 is a diagram illustrating a bottom perspective view illustration of a second portion of the mixture cartridge of the system;

FIG. 15 is a diagram illustrating a partially cutaway end view of a second portion of the mixture cartridge of the system;

FIG. 16 is a diagram illustrating an exploded side view illustration of the mixture cartridge being inserted within the cavity of the body with an optional spike in accordance with embodiments of the present invention;

FIG. 17 is a diagram illustrating a partially cutaway exploded side view illustration of the mixture cartridge being inserted within the cavity of the body including the optional spike in accordance with embodiments of the present invention;

FIG. 18A is a diagram illustrating a cross-sectional view of a portion of a ball-type MCV 182 of the lathering system in accordance with embodiments of the present invention;

FIG. 18B is a diagram illustrating an exploded cross-sectional view of a portion of the MCV 182 of FIG. 18A;

FIG. 18C is a diagram illustrating a cross-sectional view of a portion of the MCV 182 taken along lines 18C-18C of FIG. 18B;

FIG. 18D is a diagram illustrating a bottom view of a portion of the port extension 128;

FIG. 18E is a diagram illustrating a top view of a portion of the bottom wall 136 and an opening 186 of the port extension 128;

FIG. 19A is a diagram illustrating a cross-sectional view of a portion of a ball-type MCV 200 of the lathering system in accordance with embodiments of the present invention;

FIG. 19B is a diagram illustrating an exploded cross-sectional view of a portion of the MCV 200;

FIG. 19C is a diagram illustrating a cross-sectional view of a portion of the MCV 200 taken along lines 19C-19C of FIG. 19B;

FIG. 19D is a diagram illustrating a cross-sectional view of a portion of the MCV 200 taken along lines 19D-19D of FIG. 19B;

FIG. 19E is a diagram illustrating a top view of a portion of a poppet valve of the MCV 200;

FIG. 19F is a diagram illustrating a cross-sectional view of a portion of the MCV 200 taken along lines 19F-19F of FIG. 19B;

FIG. 20 is a diagram illustrating a partially cutaway side view of a portion of a mixture cartridge 240 including a bladder type reservoir 238 in accordance with the present invention;

FIG. 21 is a diagram illustrating a side view of a portion of a lathering system 21 of FIG. 2 in accordance with the present invention;

FIG. 22 is a diagram illustrating a rear view of a portion of a lathering system 21 of FIG. 2 in accordance with the present invention;

FIG. 23 is a diagram illustrating a front view of a portion of a lathering system 21 of FIG. 2 in accordance with the present invention;

FIG. 24 is a diagram illustrating a top view of a portion of a lathering system 21 of FIG. 2 in accordance with the present invention;

FIG. 25 is a diagram illustrating a bottom view of a portion of a lathering system 21 of FIG. 2 in accordance of the present invention;

FIG. 26 is a diagram illustrating a perspective front view of a portion of a lathering system 621 in accordance of the present invention;

FIG. 27 is a diagram illustrating a cross-sectional view of a portion of the lathering system 621 taken along lines 27-27 of FIG. 26 in accordance of the present invention;

FIG. 28 is a diagram illustrating a cross-sectional view of a portion of the lathering system 621 taken along lines 28-28 of FIG. 26 in accordance of the present invention;

FIG. 29A is a diagram illustrating a detailed top perspective view of a portion of a lather generator 256 in accordance with the present invention;

FIG. 29B is a diagram illustrating a detailed bottom perspective view of a portion of a lather generator 256 in accordance with the present invention;

FIG. 30A is a diagram illustrating a perspective front view of a portion of heating element 80 for heating the lather generator 16 in accordance with the present invention;

FIG. 30B is a diagram illustrating a front view of a portion of the heating element 80 and lather generator 16 in accordance with the present invention;

FIG. 30C is a diagram illustrating a cross-sectional view of a portion of the heating elements 80 and lather generator 16 taken along lines 30C-30C of FIG. 30A in accordance with the present invention;

FIG. 31 is a diagram illustrating an exploded partially cutaway perspective side view of a portion of the body 40 with an MCCM 260 in accordance with the present invention;

FIG. 32 is a diagram illustrating an exploded perspective top view of a portion of the spring cover 264 and MCCM 260 in accordance with the present invention;

FIG. 33 is a diagram illustrating a top view of a portion of the inlet port 54 and the MCCM 260 in accordance with the present invention;

FIG. 34 is a diagram illustrating a partial cross-sectional view of a portion of the lathering system 21 taken along lines 34-34 of FIG. 31 in accordance with the present invention;

FIG. 35 is a diagram illustrating a partial cross-sectional view of a portion of the lathering system of FIG. 34 with the mixture cartridge 8 coupled to the body 40 in accordance with the present invention;

FIG. 36 is a diagram illustrating a partial cross-sectional view of a portion of the lathering system 21 taken along lines 36-36 of FIG. 31 in accordance with the present invention;

FIG. 37A is a diagram illustrating a side view of a portion of the button 53 in accordance with the present invention;

FIG. 37B is a diagram illustrating an opposing side view of a portion of the button 53 and the release coupler 278 in accordance with the present invention;

FIG. 38 is a diagram illustrating shows a partial exploded bottom view of a portion of the MCCM 260 in accordance with the present invention;

FIG. 39 is a diagram illustrating a partial bottom view of a portion of the MCCM 260 in accordance with the present invention;

FIG. 40 is a diagram illustrating a partial exploded perspective front view of a portion of a lathering system 321 in accordance with the present invention;

FIG. 41 is a diagram illustrating a side view of a portion of the lathering system 321 of FIG. 40 in accordance with the present invention;

FIG. 42 is a diagram illustrating an exploded top view of a portion of a lathering system 321 of FIG. 40 in accordance with the present invention;

FIG. 43 is a diagram illustrating a side view of a portion of the mixture cartridge 308 of the lathering system 321 of FIG. 40 in accordance with the present invention;

FIG. 44 is a diagram illustrating a front view of a portion of the lathering system 321 of FIG. 40 in accordance with the present invention;

FIG. 45 is a diagram illustrating a partial cutaway exploded perspective front view of a portion of a lathering system 421 in accordance with the present invention;

FIG. 46 is a diagram illustrating a top view of a mixture cartridge 408 of the lathering system 421 in accordance with the present invention;

FIG. 47 is a diagram illustrating a cross-sectional view of a portion of the mixture cartridge 408 taken along lines 47-47 of FIG. 46 in accordance with the present invention;

FIG. 48 is a diagram illustrating a bottom view of the mixture cartridge 408 of the lathering system 421 in accordance with the present invention;

FIG. 49 is a diagram illustrating a partially cutaway cross-sectional view of a portion of the lathering system 421 taken along lines 49-49 of FIG. 45 in accordance with the present invention;

FIG. 50 is a diagram illustrating a cross-sectional view of a portion of the lathering system 421 taken along lines 50-50 of FIG. 45 in accordance with the present invention;

FIG. 51 is a diagram illustrating a detailed partially cutaway bottom perspective view of a portion of the mixture cartridge 408 and a motor 437 of the lathering system 421 in accordance with the present invention;

FIG. 52 is a diagram illustrating a detailed partially cutaway cross-sectional view of a portion of the mixture cartridge 408 and the motor 437 of the lathering system 421 in accordance with the present invention;

FIG. 53 is a diagram illustrating an end view of a belt drive system 493 of the lather system 421 in accordance with the present invention;

FIG. 54 is a diagram illustrating a portion of a partially cutaway side view of a motor 514 coupled to a lather generator 516 via a transmission 593 in accordance with the present invention;

FIG. 55A is a diagram illustrating a portion of a cross sectional side view of a motor 614 situated within a cavity 6102 of a lather generator 616 in accordance with the present invention;

FIG. 55B is a diagram illustrating a partially cutaway side view of a portion of the lather generator 616 of FIG. 55A in accordance with the present invention;

FIG. 56 is a diagram illustrating a front view of a portion of a lather generator 616 coupled to a carrier 723 of a lathering system 721 in accordance with the present invention;

FIG. 57 is a diagram illustrating a cross-sectional view of a portion of the lathering system 721 taken along lines 57-57 of FIG. 56 in accordance with the present invention;

FIG. 58 is a diagram illustrating an exploded front perspective view of a portion of the lathering system 721 of FIG. 56 in accordance with the present invention;

FIG. 59 is a diagram illustrating a screen shot 5900 of a portion of a start screen 5901 rendered by a lather system in accordance with the present invention;

FIG. 60 is a diagram illustrating a screen shot 6000 of a portion of an operating mode screen 6001 rendered by a lather system in accordance with the present invention;

FIG. 61 is a diagram illustrating a screen shot 6015 of a portion of an operating mode screen 6017 rendered by a lather system in accordance with the present invention;

FIG. 62 is a diagram illustrating a screen shot 6200 of a portion of a user setting information (USI) screen 6021 rendered by a lather system in accordance with the present invention;

FIG. 63 is a diagram illustrating a screen shot 6300 of a portion of a registered user screen 6301 rendered by a lather system in accordance with the present invention; and

FIG. 64 is a flow diagram illustrating a portion of a process to form lather in accordance with the present invention.

### DETAILED DESCRIPTION

In the following detailed description, numerous specific details are set forth in order to provide a thorough understanding of the invention. It will be understood by those skilled in the art, however, that the present invention may be practiced without these specific details. In other instances, well-known methods, procedures, and components have not been described in detail so as not to obscure the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary, for the understanding and appreciation of the underlying concepts of the present invention and in order not to obfuscate or distract from the teachings of the present invention.

Any reference in the specification to a method should be applied mutatis mutandis to a system capable of executing the method. Any reference in the specification to a system should be applied mutatis mutandis to a method that may be executed by the system.

Throughout the specification and claims, the following terms take the meanings explicitly associated herein, unless the context clearly dictates otherwise. The phrases “in one embodiment,” “in an example embodiment,” and “in some embodiments” as used herein do not necessarily refer to the same embodiment(s), though it may. Furthermore, the phrases “in another embodiment,” “in an alternative embodiment,” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In addition to conventional terminology, the following terms may apply without limitation. For example, the term coupling, coupled, and/or the like, may include a mechanical and/or fluid coupling unless the context indicates otherwise. Further, without limitation, as used herein the terms fluid coupling(s), fluidly coupled, fluidic coupling, and/or the like may be used to denote any fluid or gas communication pathway in which a fluid and/or a gas may flow. For example, fluid couplings may be used to denote any fluid or gas communication pathway which may include one or more conduits, hoses, pipes, pumps, valves, pathways, and/or other intermediate members. Further, a fluid coupling may further include a valve, pump, flow control device, and/or pressure control device to control the flow and/or pressure of a fluid and/or a gas.

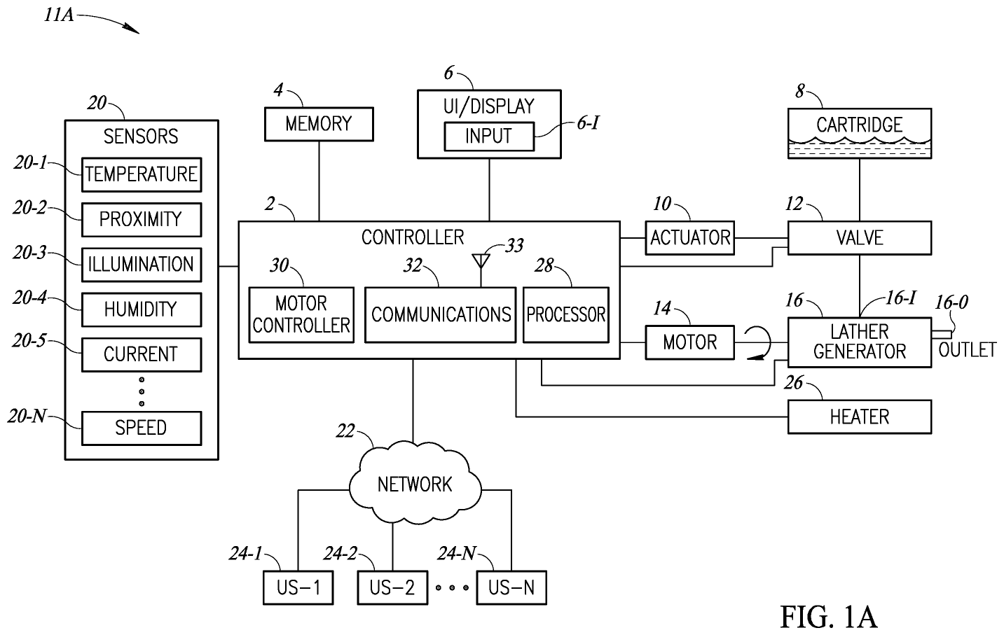

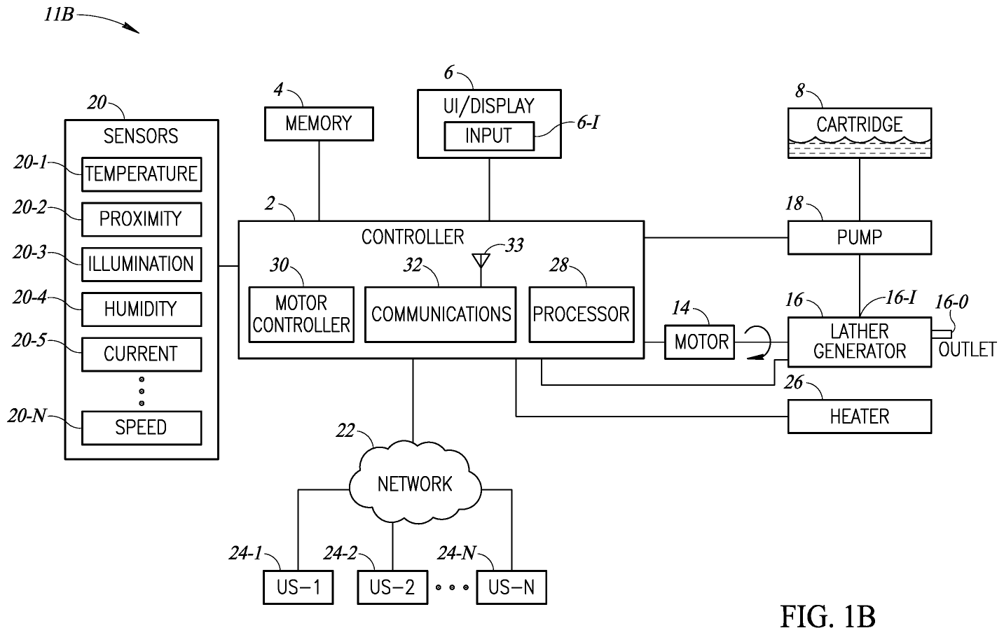

A block diagram of a portion of a lathering system 11A (hereinafter system 11A for the sake of clarity unless the context indicates otherwise) in accordance with embodiments of the present system is shown in FIG. 1A. The system 11A may include one or more of a controller 2, a memory 4, a user interface (UI)/display 6, a mixture cartridge 8, an actuator 10, a valve 12, a motor 14, a lather generator 16, sensors 20, a network 22, user stations 24-1 through 24-N, and a heater 26.

The controller 2 may control the overall operation of the system 11A and may include one more logic devices such as programmable logic devices (PLDs), microprocessors (μPs), logic circuits, and/or logic gates, etc. The one or more logic devices may local and/or remotely located relative to each other. For example, the controller may include a plurality of controllers which may be distributed through the network 22. The controller 2 may obtain information, such as operating instructions and/or setting information (SI) from a memory of the system such as the memory 4. The setting information (SI) may include user setting information (USI).

The memory 4 may include any suitable memory such as a non-transitory memory or memories which may store information desired by the system such as the operating instructions, the SI, the USI, and/or content generated by the system. The memory and/or memories may be situated locally and/or remotely from each other, and in the latter case, may be accessed via a network such as the network 22. For example, the memory may include a distributed memory such as a storage area network (SAN) memory system.

The controller 2 may include a motor controller 30, a communications portion 32, and one or more microprocessors (μPs) 28.

The motor controller 30 may be configured to drive the motor 14. For example, if the motor 14 is a stepper motor, then the motor controller 30 may include a stepper motor controller configured to drive the motor 14. The communications portion 32 may be configured and arranged to communicate with the network 22 using wired and/or wireless communication methods.

The communications portion 32 may be configured to communicate with the network 22 using any suitable wired and/or wireless communication methods. It is envisioned that the communications portion 32 may include one or more antennas 33 configured to communicate with the network 22. For example, the communications portion 32 may include a short (or long) range wireless communications portion which may communicate using a corresponding communication protocol, method, or standard such as Bluetooth, Zigbee, Wi-Fi or the like. It is further envisioned that the communication portion 32 may communicate via a cellular network such as a broadband cellular communication network (e.g., a mobile communication network such as a 4G or 5G network, etc.), an ad-hoc network, a local-area network (LAN), a wide-area network (WAN), etc.

The UI/display 6 may include any suitable display(s) which may provide a user interface (UI) with which a user may interact with the system 11A and/or may control the system 11A such as a liquid-crystal display (LCD), an organic light-emitting-diode (OLED) display, an electrophoretic display (e.g., E-Ink, etc.), and/or the like. The display 6 may further include a user input portion 61 such as a touch-screen portion (or other input device) with which a user may enter information via a touch-input of the UI/display 6. The UI/display 6 may be illuminated directly. It is also envisioned, however, that one or more illumination sources may illuminate the UI/display 6. The UI/display 6 may further indicate operative status of the system 11A such as ready and warming up operating status.

It is also envisioned that the system 11A may include other input devices such as a stylus, a mouse, a trackball, a keyboard, hard or soft keys, etc. It is further envisioned that the system 11A may track a user and determine gestures formed by the user. Thus, the system may include an image capture device such as a camera to track a user and determine gestures (e.g., using a gesture engine) formed by the user. The system 11A may then operate in accordance with the determined gesture. For example, if a user's gesture is determined to be a turn on gesture, the system 11A may exit a sleep mode and enter a wake state in which the heater 26 may be operated to preheat the lather generator 16. A user may enter gestures and map these gestures to modes (e.g., states, etc.) or actions to be performed by the system 11A. Accordingly, the system may provide a menu with which a user may interact to enter and/or edit gestures and/or corresponding modes (e.g., operative states) and/or actions to be performed by the system 11A and may store corresponding settings in a memory of the system in USI corresponding to the user. The menu may also be stored in a memory of the system and may be recalled by the system 11A with the settings set forth in the USI for the corresponding user when necessary such as to determine a gesture performed by a user and determine a corresponding mode and/or actions to be performed.

The UI/display 6 may further include a microphone and/or a speaker with which a user may interact with the system 11A. For example, the user may enter commands verbally and system may translate these commands using any suitable method such as a voice-to-text (VTT) processor. Similarly, the system 11A may provide information such as content, user instructions, USI, audio information, etc. to the user using the speaker (e.g., using text-to-voice (TTV) translator, etc.).

The actuator 10 may be coupled to the valve 12 and may be operative under the control of the controller 2 to selectively manipulate the valve 12 to selectively control a flow of a liquid such as lather solution from the mixture cartridge 8 to the lather generator 16 as may be desired. Further, the actuator 10 may be operative to control the valve 12 to prevent a flow of the lather solution when not desired such as when in off or standby modes. The actuator 10 may include any suitable type of actuators such as linear, rotary, pressure (e.g., pneumatic or hydraulic), magnetic (e.g., solenoid-type), mechanical (e.g., a cable coupled to a handle), or other actuators such that they may couple to, and be operative with, the valve 12. Accordingly, the actuator 10 may correspond with the valve 12. A linkage may be provided to couple the actuator 10 to the valve 12. It is envisioned that the actuator 10 may be directly coupled to the valve 12. It is envisioned that the actuator 10 and the valve 12 may be as formed as a single assembly. In accordance with embodiments of the present system, the actuator 10 and the valve 12 may be as formed from the same or separate assemblies, with the latter being capable of being removably coupled to each other so that they may be removed from each other and/or the system for easy replacement. Further, one or more of the valve 12, the actuator 10, and/or portions thereof, may be incorporated with the mixture cartridge 8. For example, the valve 12 may be incorporated with the mixture cartridge 8 as a unit and may be coupled to the actuator 10 (or its linkage, which for the sake of clarity herein, will be assumed to be part of the actuator 10 unless the context indicates otherwise) when the mixture cartridge 8 is installed in a body of the system. Similarly, when the mixture cartridge 8 is removed from the body, the valve 12 may be decoupled from the actuator 10.

In accordance with embodiments of the present system, the actuator 10 may be an electrical actuator such as a solenoid which may be configured to magnetically couple with the valve 12 to open and/or close the valve 12.

It should also be appreciated that the actuator 10 may include a mechanical actuator which may be coupled to the valve 12 and may be operative by applying a force to a lever coupled to the actuator 10 (e.g., under the control of the user). The lever may be fixedly or removably positioned and/or operated.

In accordance with embodiments of the present system, the valve 12 may include a poppet valve and the actuator 10 may be operative to open or close the poppet valve when the mixture cartridge 8 is installed in a body of the system for use. Accordingly, the actuator 10 may control the flow of liquid from the mixture cartridge 8 to the lather generator 16 by manipulating the poppet valve 12 to an open or closed position. It is also envisioned that another valve may be provided in addition to the poppet valve to control flow of liquid from the mixture cartridge 8 once the poppet valve is opened. For example, one or more actuators 10 may be provided to correspondingly actuate each valve coupled thereto. It is envisioned that an actuator 10 may be fixedly positioned in a fixed or variably configurable position.

The valve 12 may be any suitable valve such as ball valves, butterfly valves, ceramic disc valves, diaphragm valves, duckbill valves, gate valves, needle valves, rotary valves, pinch valves, piston valves, plugs (e.g., silicone plugs), poppet valves umbrella valves, and/or other types of valves. It should be appreciated that more than one valve 12, of the same or of different types, may be provided and may be operated by one or more actuators 10. The valve 12 may further include a valve cartridge which may be easily replaced independent of the actuator 10. Thus, the valve 12 and actuator 10 may be formed as a single assembly or from separate assemblies. For example, the valve 12 and/or the actuator 10 may be part of the mixture cartridge 8 or may be formed separately from the mixture cartridge 8. A portion of the valve 12 may be positioned on the mixture cartridge 8 such that flow of fluid from the mixture cartridge 8 may be prevented or reduced during installation and/or removal of the mixture cartridge 8 as may be described elsewhere in this application.

The motor 14 may be operative under the control of the controller 2 and may provide a force (e.g., a rotational or linear force depending upon embodiments) to drive one or more portions of the system 11A such as a whipping screw or element such as a lather generating screw (hereinafter a lather generating screw (LGS) unless the context indicates otherwise) of a lather generator 16. In accordance with embodiments of the present system, other types of whipping elements may be employed such as a whipping blade, a whipping plunger, a screen, and/or the like.

The motor 14 may include one or more motors of the same or different types. For example, the motor 14 may include any suitable motor or motors such as an alternating current (AC) motor, a direct current (DC) motor, a stepper motor, and/or any other suitable type of motor or motors. It will be appreciated that the motor 14 may include linear and/or rotary type motors. It is further envisioned that the motor may be driven by stored energy such as stored energy from a capacitor, one or more batteries, pneumatic cartridge (e.g., high-pressure gas such as from a CO₂ cartridge), kinetic energy source (e.g., a wound spring, gyroscopic wheel, etc.), and/or the like.

The motor 14 may include one or more output shafts for driving portions of the system such as the LGS of the lather generator 16 and/or one or more pumps (e.g., pumps for pumping a liquid mixture and/or air). The speed and/or direction of the motor 14 may be controlled by the controller 2 in accordance with system and/or user settings. For example, the motor 14 may drive a peristaltic pump to pump the liquid mixture from the mixture cartridge 8 to the lather generator 16 depending upon embodiments.

The lather generator 16 may receive a liquid such as the lather solution at its inlet 16-I and may operate on this lather solution to it to build it into a lather which is then output at its outlet 16-O. The lather generator 16 may be driven by the motor 14 under the control of the controller 2. The lather generator 16 may include portions which may whip or otherwise operate upon the liquid mixture to turn it lather suitable for shaving. Suitable methods to turn the lather solution into a lather may employ a rotating whipping screw, a reciprocating plunger and/or screen, a rotating or reciprocating spring, etc. In accordance with embodiments of the present system, other methods of generating a lather such as pneumatic methods are also envisioned. The lather generator 16 may include an air vent for receiving air (e.g., at atmospheric pressure of pressurized) which may be added to a liquid mixture such as lather solution to generate the lather.

The heater 26 may be operative under the control of the controller 2 to heat one more of portions of the lather generator 16. It is envisioned that the heater 26 may heat portions of the system 11A through which the liquid (e.g., a liquid mixture such as the lather solution) may pass so that the lather output by the lather generator 16 may be warmed to a desirable temperature. The heater 26 may include any suitable type of heater such as a resistive type heater having one or more resistive type heating elements (e.g., a wire). In accordance with embodiments of the present system, the heater may include other types of heaters such as a composite heater, a liquid heater, a hot air heater, etc., and/or combinations thereof.

It is envisioned that the heater 26 may be wrapped about one or more portions of the lather generator 16 and may be configured to heat corresponding portions of the lather generator 16. It is envisioned that a flexible resistive wire heater may include a waterproof wrapping or shielding. It is also envisioned that the heater 26 may be formed from a solid element such as a conductive composite which may be wrapped about and/or formed integrally with the lather generator 16 or portions thereof.

In accordance with embodiments of the present system, the heater 26 may be formed integrally with, or separately from, the lather generator 16. For example, it is envisioned that one or more portions of the heater 26 may be formed from a resistive rigid composite that may form all or part of the lather generator 16 such as a barrel and/or screw of the lather generator 16. It is envisioned that the heater 26 may heat a thermal transfer agent such as a (thermal transfer liquid and/or a thermal conduit) which may transfer heat to one or more portions of the lather generator 16 using the conduit.

The network 22 may include any suitable wired and/or wireless networks. For example, the network 22 may include a short-range wireless communications network such as Bluetooth, Zigbee, a cellular network such as a broadband cellular communication network (e.g., a mobile communication network such as a 4G or 5G network or the like, etc.), a near-field network, a home automation network, a personal area network (PAN), an ad-hoc network, an internet area network (IAN) or cloud, a local-area network (LAN), metropolitan area network (MAN), a wide-area network (WAN), a Wi-Fi network, a home area network (HAN), etc., and/or combinations thereof. In accordance with embodiments of the present invention, other types of networks and/or communications protocols and/or methods may also be employed.

It is envisioned that a user or users may communicate via the network 22 using any suitable user station (US) such as USs 24-1 through 24-N (generally US-x). The US-xs may be fixed and/or mobile and may include smart phones, wired or wireless controllers (e.g., smart-home controllers), computers, laptops, chromebooks, etc. Thus, one or more users may communicate with the system 11A directly or via the network 22.

It is envisioned that the system 11A may identify a user directly using any suitable method (e.g., a direct identification input, voice recognition, facial recognition, etc.) or may identify a US 24-x of a user. For example, it is envisioned that the user may be identified by way of the US 24-x or may be identified directly. Further, the system may provide for a method for the user to be identified by the system 11A. It is also envisioned that the system may determine a location of the user using any suitable method (e.g., triangulation, global positioning system (GPS), assisted GPS (AGPS), etc.) and may enter one or more modes based upon the determined location of the user or a device of the user relative to the system. For example, when a user is far from the system (e.g., in another state, etc.) the system may remain in a sleep mode. If it is determined that the user is in close proximity such as within a threshold distance of the system (e.g., where the threshold distance may be set by the user and/or system to any value such as 20 feet, etc. and stored in the USI), the system may enter a warming mode, etc. as may be set by the system and/or user.

As discussed above, the US-xs may include any suitable US through which a user may interact with the system 11A directly or via the network 11. The US-xs may provide a user interface such as a touch-screen display through which a user may interact with the system 11A.

The sensors 20 may include one or more sensors such as temperature 20-1, proximity 20-2, illumination 20-3, humidity 20-4, current 20-5, alarm (e.g., an alarm generated by the system such as a wake-up alarm that may be generated as an alarm signal), speed (e.g., motor speed) 20-N sensors, and/or the like. In accordance with embodiments of the present system, other sensors are also envisioned. The sensors may sense a corresponding condition (e.g., temperature for temperature sensors), form corresponding sensor information (e.g., temperature information), and provide this sensor information to the controller 2 for further analysis in accordance with embodiments of the present system.

A block diagram of a portion of a lathering system 11B (hereinafter the system 11B for the sake of clarity unless the context indicates otherwise) in accordance with embodiments of the present system is shown in FIG. 11B. The system 11B may be similar to the system 11A of FIG. 1A and may include one or more of a controller 2, a memory 4, a user interface (UI)/display 6, a mixture cartridge 8, a motor 14, a lather generator 16, sensors 20, a network 22, user stations 24-1 through 24-N, and a heater 26. It is envisioned that the system 11B may include a pump 18 which may operate under the control of the controller 2 in accordance with embodiments of the present system. The pump 18 may comprise any suitable pump to selectively pump or otherwise transport fluid from the mixture cartridge 8 to the lather generator 16 (e.g., via 16-I) and may, for example, include a centrifugal pump, a peristaltic pump, a piston pump, etc. The pump may include a replaceable cartridge that may be replaced separate from a motor which drives the pump 18. The pump 18 may selectively stop the flow of liquid from the mixture cartridge 8 to the lather generator 16 when in an off mode. One or more portions of the pump 18 may be separable from each other. For example, a separable pump may include a pump head such as a cartridge body and a motor to drive the pump head. The pump head by be coupled to the mixture cartridge and may be couple to the motor which drives it when the cartridge is in an installed position for use. The pump 18 may include one or more valves and/or actuators to actuate the valves. These valves may be passive and/or actively controlled. It is also envisioned that the pump may include a pneumatic pump which may apply pneumatic pressure to fluid such as fluid within the mixture cartridge 8 to move the fluid from the mixture cartridge 8 to the lather generator 16. It is further envisioned that the pump 18 may be driven by the motor 14.

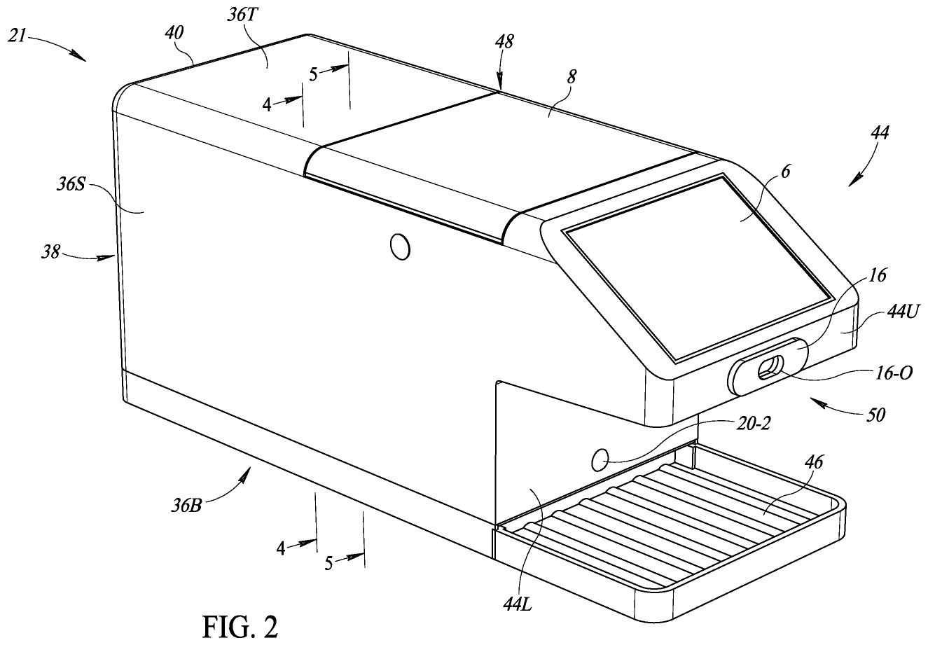

A perspective front view of a portion of a lathering system 21 (hereinafter system 21 for the sake of clarity unless the context indicates otherwise) in accordance with embodiments of the present system is shown in FIG. 2. The system 21 may include one or more of a body 40, a display 6, a mixture cartridge 8, a lather generator 16, sensors 20-2, and a drip tray 46. The display 6, the lather generator 16, the sensors 20-2 and the drip tray 46 may be part of the body 40.

The system 21 may be operated under the control of a controller. The controller may be similar to the controller 2 of FIG. 1A and may include one or more local and/or distributed controllers each of which may include a logic device such as one or more microprocessors, logic gates, logic circuits, and/or the like.

The body 40 may include a cavity 48 for receiving the mixture cartridge 8, an opening (or notched area) 50 suitable for receiving a hand of a user during use, and one or more walls such as side walls 36S which may oppose each other, a top wall 36T, a bottom wall 36B, a rear wall 38, and a front wall 44 which may include one or more portions such as a front wall upper 44U and a front wall lower 44L. The front wall 44 may include one or more portions. For example, the front wall 44 may include a plurality of portions such as a front wall upper 44U and a front wall lower 44L (generally 44X).

One or more of the walls of the body 40 (e.g., 36S, 36B, 36T, 40, and/or 44) may be removed with, or independently of, other walls. It is further envisioned that one or more walls of the body 40 may be formed integrally with, or separately from, each other.

With regard to the cavity 48, the body 40 may include one or more cavities 48 which may be referred to as cartridge cavities and which may be configured to receive one or more cartridges such as the mixture cartridge 8. Other suitable cartridges may include aftershave lotion and pre-shave oil cartridges that may have separate dispensing pumps which may dispense directly. For the sake of clarity, only a single cartridge cavity such as cavity 48 will be shown. The cavity 48 may be shaped and sized to receive the mixture cartridge 8 and may be situated in one or more of the walls so the body 40. The cavity 48 may include an opening through which the mixture cartridge 8 may be inserted when the mixture cartridge 8 is coupled or installed to the body 40. The cavity 48 may be configured to receive at least a portion of the mixture cartridge 8.

One or more of portions of the system 21 such as the body 40, or portions thereof, such as the walls, etc. may be formed from any suitable material, materials and/or combinations of materials. For example, one or more portions of the body 40 such as the walls may be formed from a material such as metal (e.g., sheet steel, stainless steel, aluminum, titanium, etc.), polymers (e.g., plastic such ABS-type plastic, etc.), reinforced fiber material, (e.g., fiberglass, carbon fiber, woven- or non-woven fibers, etc.), and/or combinations thereof (e.g., plated plastic such as chrome-plated ABS plastic, painted plastic, etc.). It is further envisioned that one or more of the walls may be coated (e.g., electro-plated (e.g., chrome plated, nickel plated, etc.)), painted, laminated, and/or plated. For example, it is envisioned that the one or more walls may include a polished aluminum wall, a chrome-plated wall, a laminate-covered wall such as wood laminate, and a vinyl-covered plastic wall. It is further envisioned that rails configured to receive an insert panel may be provided. These panels may include colored polymer panels, painted panels, metal panels (e.g., brushed stainless steel), wood-laminate panels, or the like that may be removably coupled to rails so that a user may change the panels as desired. Accordingly, embodiments of the present system may be customized according to a user's desire. It is envisioned that the panels may be coupled to the body using any suitable method or methods such as the rails, hook-and-loop fasteners (e.g., Velcro), magnetic coupling, and/or the like.

The drip tray 46 may be shaped and sized to receive excess liquid generated by the system 21, such as excess lather dripped by the system 21 and/or user during and/or after use, may be caught in the drip tray 46. Depending upon embodiments, the drip tray 46 may be fixedly attached to the body 40 or may be removably attached to the body 40. It is further envisioned that the drip tray 46 may include a liner which may be removed from the drip tray 46 and/or body 40 for cleaning and/or disposal and may be inserted within a well of the drip tray 46 for use. In accordance with embodiments of the present system, that the drip tray 46 may be formed integrally with the body 40.

A coupling mechanism (such as magnets, hook-and-loop fasteners, clips, rails, latching mechanisms, friction-fittings, screws, etc.) may be included to couple the drip tray 46 to the body 40 to releasably couple the drip tray 46 to the body 40. For example, adjacent areas of the drip tray 46 and the body 46 may include a magnetic coupler which may magnetically couple the drip tray 46 to the body 40. Accordingly, drip tray 46 may be easily removed from the body 40 for cleaning and may be easily reattached to the body 40 for use as may be desired.

The display 6 may include any suitable display such as a touch-screen display, a liquid crystal display (LCD), light emitting diode display (LED), an organic-LED display (OLED), a thin-film transistor display (TFT), etc. Accordingly, a user may interact with the system 21 using the display 6. The display 6 may include one or more displays which may be local or remotely located relative to the body 40. A user input device such as hard and/or soft keys may be provided for selection by the user.

Illumination sources may be provided to illuminate the display 6 and/or other portions of the system 21. For example, the illumination sources may be illuminated (e.g., using a different color) to indicate an operative status of the system 21 such as off, standby, warming, ready, dispensing, etc., as may be set in system settings and/or the USI. For example, the illumination sources may be illuminated red to indicate an off or standby-state, yellow to indicate an on-state (e.g., on but not yet ready such as warming), and green to indicate a ready state (e.g., on and warmed). Likewise, the illumination sources may flash in a desired pattern to indicate a state. For example, during a heating mode the illumination sources may flash (e.g., green, etc.), and when ready, the illumination sources may be solid (e.g., green, etc.).

The sensors 20 may include sensors such as the proximity sensor 20-2 may be provided to detect the presence of an object such as a hand of a user within the opening 50. The proximity sensor 20-2 may include any suitable sensor for detecting the proximity of an object and may include sensors such as infrared (IR) sensors, optical sensors, radar sensors, ultrasound sensors, etc. For example, the proximity sensor 20-2 may include an IR transmitter and an IR receiver pair. The IR transmitter may transmit a suitable signal which include be an analog and/or digitally encoded signal. In use, the proximity sensor 20-2 may detect the presence of an object (e.g., a user's hand) in proximity to the sensor, generate corresponding presence information, and provide this information to the controller of the system 21 which may then determine an action to take and correspond accordingly (e.g., in accordance with the USI).

For example, upon detecting the presence of an object, the proximity sensor 20-2 may generate corresponding presence information (e.g., a presence signal, etc.) and provide this proximity information to the controller which may operate the motor and/or the valve of the system to generate and/or output a lather suitable for shaving. The proximity sensor 20-2 may further include optical presence sensors which may analyze optical information to identify the present of an object such as a user. It is also envisioned that the proximity sensor 20-2 may include an ultrasonic sensor which may provide ultrasound information which the controller 2 analyze to determine the present of an object in proximity to the system 21. It is further envisioned that the proximity sensor 20-2 may include an optical beam type sensor which may transmit an optical beam such as an infrared beam, which when broken, or otherwise interacted with, may indicate the presence of an object. It is envisioned that the proximity sensor 20-2 may use a reflective type detection method that may detect a transmission beam that is reflected by an object such as a reflected infra-red transmission beam.

It is envisioned that the sensors 20 may include other types of sensors such as a humidity sensor, an illumination sensor (e.g., an ambient-light sensor), etc. as may be discussed elsewhere in this document.

For example, the humidity sensor may detect ambient humidity and generate corresponding humidity information which may be provided to the controller. The controller may analyze the received humidity information and/or may compare it to one more threshold values. For example, if it is determined that the humidity is greater than a threshold value (for humidity such as 90% which may be indicative of the use of a shower nearby), the controller may enter a warming mode. It is envisioned that the controller may determine a rise of humidity in a unit time and use this information to determine a mode to enter such as a warming mode. For example, if the humidity information is determined to have risen by more than a threshold amount (e.g., 10%) in a threshold time period (e.g., 10 minutes) (e.g., indicative of operation of a shower nearby), the controller may begin a heating mode in which the heater may be operated to heat portions of the system such as the lather generator which may prepare the system for lather dispensing (e.g., of warmed lather). The heating mode may then be ended after a threshold time (e.g., 10 minutes (as may be set by the user and/or system)) or after use of the system 21 (e.g., to generate lather). The system may enter a standby mode. As used herein, the term mode and state may be used interchangeably.

The illumination sensor may sense ambient lighting intensity, may form corresponding ambient lighting intensity information and provide this information to the controller. The controller may then analyze the ambient lighting intensity information with system and/user settings and may activate a mode in accordance with the determination. For example, depending upon system and/or user settings, if it is determined that the ambient lighting intensity is greater than, or equal to, a threshold value, the system may enter a warming mode. If it is determined that the ambient lighting intensity is less than a threshold value (e.g., indicative of a dark room), the system may remain in an off mode. Thus, when a user turns on a light (e.g., in a windowless room), the system may enter a warming mode.

More particularly, the system 21 may include one or more cartridges each of which may include a liquid mixture (e.g., a lather mixture) suitable for forming a desired lather in accordance with embodiments of the present system. This lather is suitable for numerous applications, especially shaving, etc.

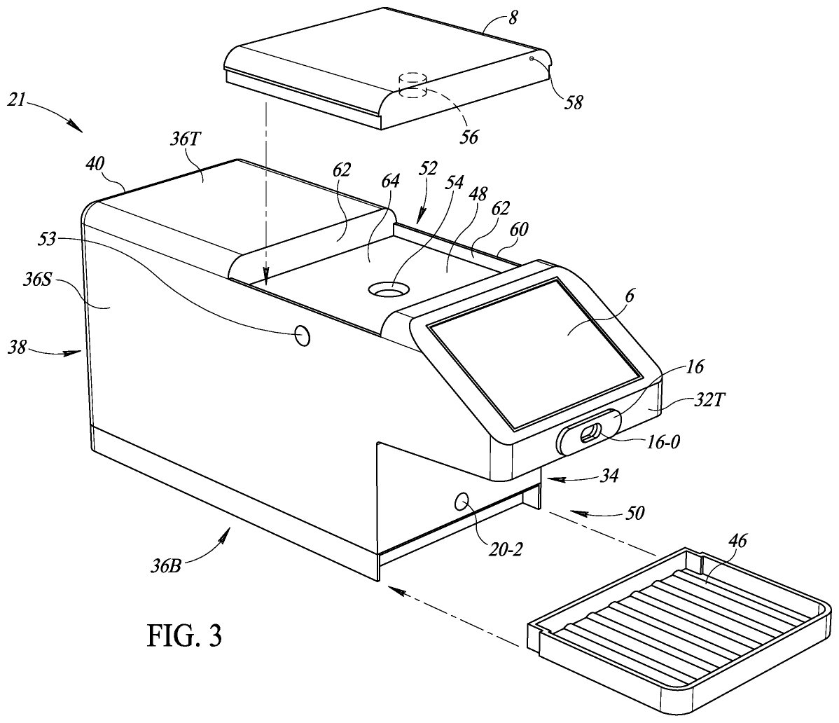

A partially exploded perspective front view of a portion of a lathering system 21 of FIG. 2 in accordance with embodiments of the present system is shown in FIG. 3. The cavity 48 may include an opening 52 and may be configured to receive at least a portion of the mixture cartridge 8 which may be coupled to the body 40. The cavity 48 may include one or more walls such as saddles 60, side walls 62, and a bottom wall 64 one or more of which may be commonly formed with one another. For example, the sidewalls 62 may include a fold which forms portions of the saddles 60. The saddles 60 may support the mixture cartridge 8 when it is installed in the cavity 48 for use to stabilize the mixture cartridge 8. The bottom wall 64 may be inclined (e.g., sloped, concave, convex, inclined, etc.) to direct any spilled liquid towards the inlet port 54 or to an opening through one of the walls such as the side walls 36S such that the spilled liquid may be directed out of the cavity 48. The bottom wall 64 may further include a drain to drain any fluid spilled in the cavity to as desired location such as the drip tray 46 (or other desired area or portion) via one or more paths.

The mixture cartridge 8 may have an outlet port 56 through which a liquid contained within a cavity of the mixture cartridge 8 such as a lather solution may flow to exit the mixture cartridge 8. The mixture cartridge 8 may include a vent port 58 for equalizing a pressure within its cavity with ambient pressure or another desired pressure. The mixture cartridge 8 may be coupled to the body 40 using any suitable method or methods such as latches, friction fits, detents, magnetic coupling, etc. For example, the coupler may include one or more latches of the body 40 which may operatively engage one or more flanges on the mixture cartridge 8 to lock the mixture cartridge 8 in position (relative to the body 40) to couple the mixture cartridge 8 to the body 40. A release such as button 53 may be provided to release the one or more latches and therefore decouple the mixture cartridge 8 from the body 40. A biasing member may be provided to provide a biasing force to which force may bias the mixture cartridge 8 away from its coupled position to ease removal of the mixture cartridge 8 from the body 40.

The vent port 58 may include a liquid barrier such as a cover, a valve, a plug, a hydrophobic filter (e.g., a membrane) and/or the like to reduce or entirely prevent the flow of lather solution through the vent port 58 during use, storage, transport, and/or handling while air may pass therethrough. A removable cover may be provided over the vent port 58 to seal the vent port 58 during shipping, handling, and/or storage to prevent the spillage of liquid from within the cavity outside of the mixture cartridge 8. This may reduce or entirely prevent the escape of liquid from the mixture cartridge 8 when it is undesirable such as during shipping, handling and/or storage. This removable cover may then be removed from the vent port 58 to prior to, during installation, and/or use of the mixture cartridge 8. It is envisioned that the removable cover may be pierced manually or automatically during or after installation of the mixture cartridge 8.

The inlet port 54 may be configured to couple to the outlet port 56 to fluidically transfer liquid contained within the reservoir of the mixture cartridge 8 to the inlet port 54. Thus, when the mixture cartridge 8 is installed into the body 40, the outlet port 56 of the mixture cartridge 8 may be coupled (e.g., fluidly and/or mechanically) to the inlet port 54. The inlet port 54 may be a female-type port. It is further envisioned that the inlet port 54 may be flush-type port, a male-type port, or other type of port and the outlet port 56 may correspond with a type of the inlet port 54 to enable coupling. Thus, regardless of port type, the outlet and inlet ports may be configured to couple to each other.

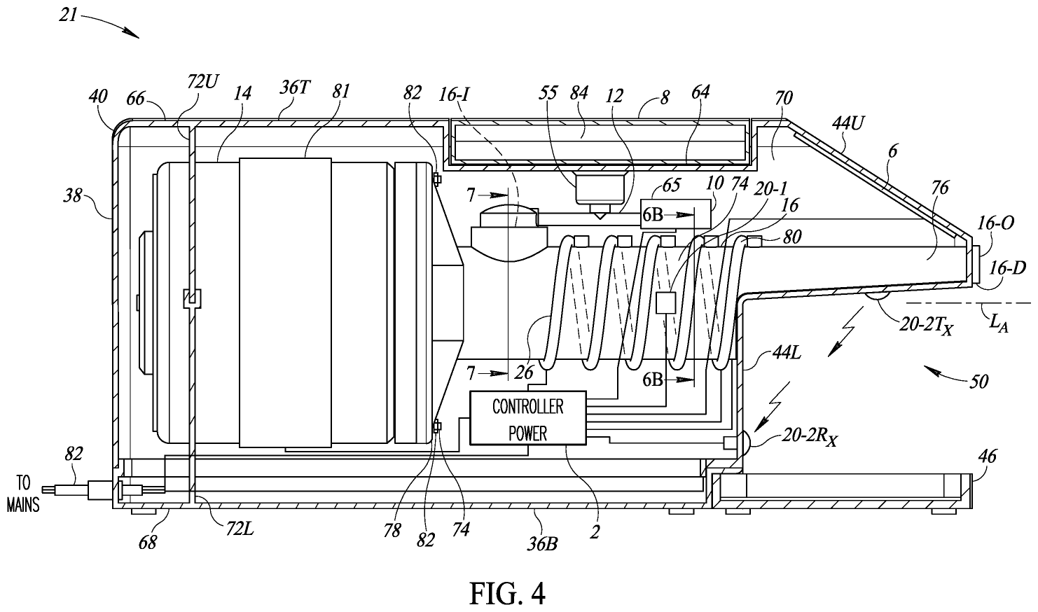

A cross-sectional view of a portion of the lathering system 21 taken along lines 4-4 of FIG. 2 in accordance with embodiments of the present system is shown in FIG. 4. The system 21 may include any suitable body 40 which may include a multipart casing, a split casing, etc. For example, the body 40 may include one more case portions such as an upper casing 66 and a lower casing 68 which may be referred to as a cover and a base respectively. The one or more case portions may be coupled to one another using any suitable coupling method or methods such as flanges, seams, friction fits, screws, latches, bonds, adhesives, and/or other suitable coupling methods. The casing, and/or portions thereof, such as the upper casing 66 and/or the lower casing 68 may define at least a portion of cavity 70 configured to receive at least a portion of the system 21 such as one or more of the controller 2, the actuator 10, the valve 12, the motor 14, the lather generator 16, the sensors 20, and the heater 26. It is further envisioned that the cavity 70 may be subdivided into sub-cavities each of which may include a portion of the system 21 as may be desired. One or more of the sub-cavities may provide a barrier to, for example, spilled liquids.

The one or more of the upper casing 66 and the lower casing 68 may include a support for one or more of the valve 12, the motor 14, and/or the lather generator 16. The support may be formed integrally with, or separately from, one or more of the upper casing 66 and the lower casing 68. For example, the support may include ribs 72U and 72L or flanges which may extend from the upper casing 66 and/or the lower casing 68, respectively, to support one or more of the valve 12, the motor 14, and/or the lather generator 16 or other portions of the system 21. The ribs 72 (only one set which is shown for the sake of clarity) may be formed integrally with or separately from one or more of the upper casing 66 and the lower casing 68. One or more of the upper casing 66 and the lower casing 68 may further include a coupler for receiving a (e.g., mains power, etc.) cord 82 which may provide power to the system 21. This coupler may include a grommet suitable for holding the cord 82 in position relative to the body 40.

Although the system 21 may be operative on mains power, it is envisioned that the system 21 may be powered by other power sources of power such as batteries, capacitors, solar power, a fuel cell, a thermoelectric (TE) power sources and/or the like.

The mixture cartridge 8 may include at least one reservoir 84 in which a fluid such as the lather mixture (or lather solution) may be stored. The reservoir 84 may be in fluid communication with the outlet port 56 (via one or more optional valves) to provide the fluid contained within (e.g., the lather mixture) to the outlet port 56 as may be desired.

An outlet port 56 of the mixture cartridge 8 may be coupled to the inlet port 54 situated within the inlet port housing 44 and the mixture cartridge 8 may rest upon the one or more of the saddles 62 of the side walls 60, the inlet port housing 44, and/or the bottom wall 64 (e.g., FIG. 3). A biasing member may be provided to provide a biasing force against the mixture cartridge 8 to as to at least partially eject the mixture cartridge 8 from the cavity 48.

The actuator 10 may be coupled to the valve 12 to control the valve 12 to open and/or close under the control of the controller 2. The actuator 10 and the valve 12 may be unitized as a commercial-off-the-shelf (COTS) unit, the combination of which may be referred to as a valve unit (VU) 65. For example, the VU 65 may include the valve 12 which may be of a normally closed (NC) type and may include inlet and outlet ports. The VU 65 may be replaced as a unit. The inlet port (54, FIG. 3) may be situated within an inlet port housing 55 and may be fluidly and/or mechanically coupled to an outlet port of the inlet port housing 55. The outlet port of the inlet port housing 55 may be fluidly and/or mechanically coupled to the inlet 16-I of the lather generator 16 so that a liquid such as the lather solution may be transferred from a reservoir of the mixture cartridge 8 to the lather generator 16. In yet other embodiments, the VU 65 may include a pump to controllably pump the fluid within the reservoir 84 of the mixture cartridge 8 to the inlet 16-I of the lather generator 16.

The lather generator 16 may include any suitable lather generator such as a screw-type lather generator including a body 74 forming a cylinder with the LGS situated therein for generating a lather. The body 74 may be situated between an extension 76 and a mount 78 and may define longitudinal axis La. The body 74 may include a positioner to position portions of the heater 26 in a desired location relative to the body 74. For example, the positioner may include one or more lugs, flanges, spiral flanges, and/or the like about which the portions of the heater 26 may be guided and/or wound. The extension 76 may extend between the body 74 and the outlet 16-O of the lather generator 16. The mount 78 may couple the lather generator 16 to the motor 14 using any suitable method such as a screwable coupling 82 include a nut and stud combination. It is further envisioned that other suitable couplings such as friction fits, bonds, flanges and rails, etc., are also envisioned. In yet other embodiments, it is envisioned that the motor 14 may be formed integrally with the lather generator 16. For example, a body 74 of the lather generator 16 may form at least a portion of an outer casing 86 of the motor 14 or the motor 14 may be located in at least the cylindrical portion of the body 74.

The heater 26 may include at least any suitable heater which may heat one or more portions of the lather generator 16 such as the body 74, the extension 76, the mount 78, and/or the LGS situated within the body 74. For example, the heater 26 may include a resistive-wire-type heating element (RWHE) such as an insulated RWHE (IRWHE) 80 which may extend along at least a portion of the body 74 of the lather generator 16. For example, the IRWHE 80 may have any suitable pattern such as coiled-pattern which may form a coil (e.g., which may include one or more closed and/or partially-open loops) which may wrap fully and/or partially about at least a portion of the body 74 of the lather generator 16 so as to transfer heat to the body 74. In yet other embodiments, it is envisioned that the RWHE may be situated within the body 74 (e.g., by molding the RWHE within a polymer of the body 74.) of the lather generator 16. Thus, it will be appreciated that at least a portion of the heater 26 may be formed integrally with the lather generator 16. In yet other embodiments, portions of the RWHE may extend along a longitudinal axis La of the body 74 as may be discussed elsewhere in this application.

In yet other embodiments, it is envisioned that the heater 26 may include one or more cartridge-type heating elements such as cartridge-type (e.g., a quartz-tube-type heating element) which may adjacent to, and/or in proximity with, at least a portion of the body 74. In yet other embodiments, it is envisioned that the heater 26 may include a microwave type heater or a hot-air-type heater. For example, it is also envisioned that the heater may include a resistance or other type of hot air heater that may provide for a flow of hot air on one or more of the lather generator and/or other portions of the system. It is further envisioned that the heater 26 may be formed using a rigid-type resistive element such as conductive carbon-fiber-type board. In yet other embodiments, a plurality of heaters may be employed each may be different from or the same as each other.

The sensors 20-x may be positioned as desired to acquire corresponding information. For example, the proximity sensor 20-2 may include a transducer pair such as an IR transceiver/receiver (TX/RX) transducer pair comprising, for example, an optical transmitter (TX) 20-2TX and an optical receiver (RX) 20-2RX which may be located separately from each other as shown and may output an IR signal. Accordingly, when an object, such as a hand of a user, is situated at one or more determined locations within the opening 50 it may interact with the IR signal and the optical receiver 20-2RX may detect this interaction and form corresponding proximity information which may be provided to the controller 2. The controller 2 may then detect the presence of the object (e.g., a hand of a user) and may be operative to control the system accordingly such as by controlling the actuator 10 to open the valve 12 and the motor 14 to operate. In yet other embodiments, the proximity sensor may include an optical transmitter 20-2TX and the optical receiver 20-2RX which may be situated apart from, adjacent to, or in close proximity with, each other.

In accordance with embodiments of the present system, the proximity sensor 20-2 may include an image capture device such as a camera which may provide image information to the controller 2. The controller 2 may then employ optical image recognition techniques to determine the presence of a desired object such as a hand of a user in a desired location (e.g., within at least portion of the opening 50 which may be referred to as a hand opening). This may allow a user to move his or her hand freely (e.g., without having to contact a switch or lever) to distribute lather as may be desired in use.

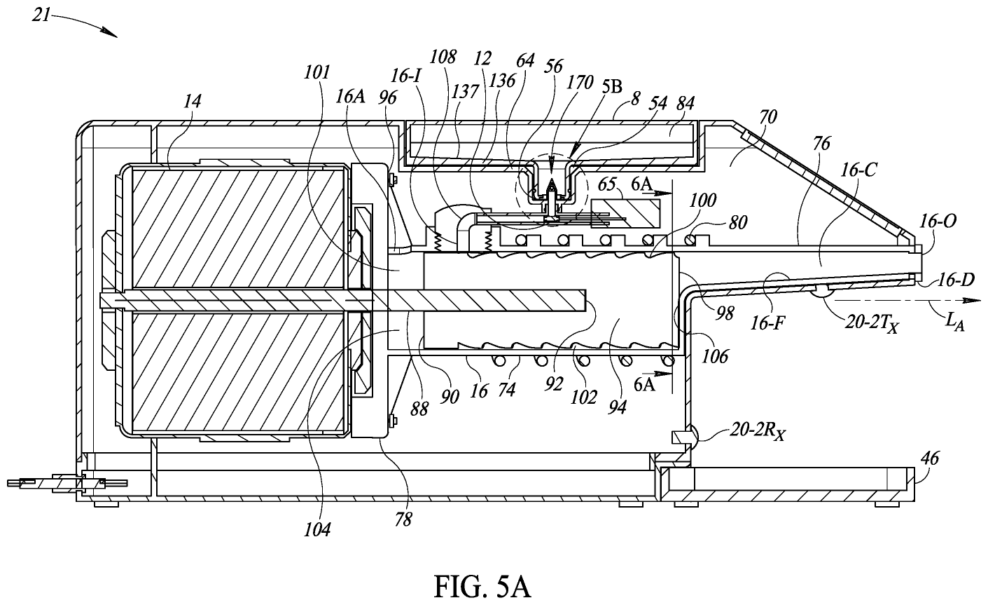

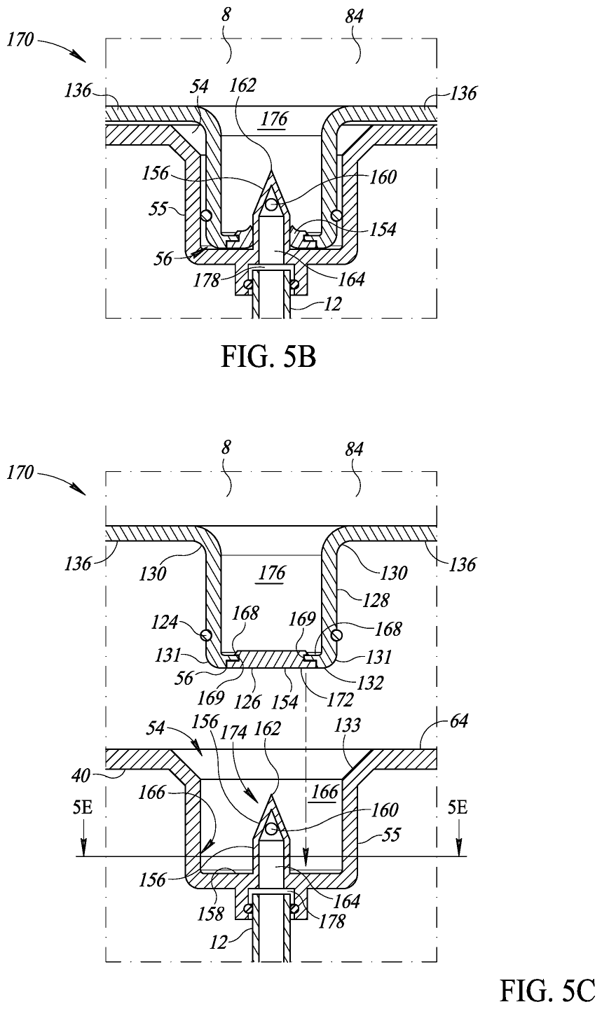

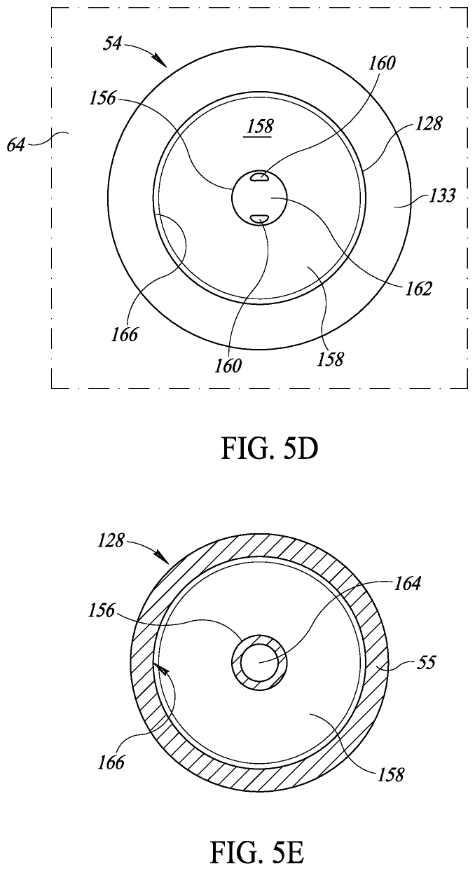

A cross-sectional view of a portion of the lathering system 21 taken along lines 5-5 of FIG. 2 in accordance with embodiments of the present system is shown in FIG. 5A. The outlet port 56 of the mixture cartridge 8 may be coupled to the inlet port 54. When such coupling occurs, a flow actuator may open a mixture cartridge valve (MCV) 170 to enable flow of the fluid (e.g., the lather mixture) within the reservoir 84 to the inlet port 54 via the open MCV 170 and the outlet port 56 such that fluid may be transferred from reservoir 84 to the inlet port 54. The inlet 16-I of the lather generator 16 may be selectively fluidly and/or mechanically coupled to the reservoir 84 via one or more of the valve 12 of the VU 65, the outlet port 56, the inlet port 54 and the MCV 170. Thus, when the mixture cartridge 8 is installed in its operating position relative to the lather generator 16 and when the valve 12 is in the open position, fluid contained within the reservoir 84 such as the lather mixture may flow or otherwise be transferred to the inlet 16-I of the lather generator 16. Conversely, when the valve 12 is the closed position, fluid contained within the reservoir 84 may be restricted or entirely prevented from flowing, or otherwise transferred, to the inlet 16-I of the lather generator 16. The cartridge 8 may include a bottom wall 136 which may have an inner floor 137 that may be inclined or otherwise sloped towards the outlet port 56 so as to direct the fluid, such as the lather solution, contained within the reservoir 84 towards the outlet port 56 under the force of gravity. In yet other embodiments it is envisioned other suitable method to channel the fluid towards outlet port 56 may be provided. In yet other embodiments, the inner floor 137 may be flat, substantially flat, or otherwise planar. This may result in a greater amount of residual liquid being leftover within the reservoir 84 when the cartridge runs out of, or low on, a usable amount of liquid for generating a lather.

The bottom wall 64 may be configured to include the inlet port 54 which may be configured to receive the outlet port 56 of the mixture cartridge 8. The inlet port 54 may be formed integrally with, or separately from, the bottom wall 64. For example, the inlet port 54 may be coupled to the bottom wall 64 and may be removable for cleaning, repairs, replacement, etc.

The inlet port 54 may include any suitable actuator to open the MCV 170 as may be described elsewhere in this application.

The LGS 94 may be configured with spiral or screw-like thread 100 configured to generate a lather from the lather solution when the LGS 94 revolves (at it operating speed such as may occur when the LGS 94 is driven by the motor 14) within the cylindrical cavity of the body 74 of the lather generator 16. The LGS 94 may include one or more of proximal and distal ends 90 and 98, respectively, and a drive coupling such as an opening 92 configured to receive a drive shaft 88 such as an output shaft of the motor 14. In yet other embodiments it is envisioned that the drive coupling of the LGS 94 may include a gear, belt drive, and/or friction drive coupling. Accordingly, the shaft 88 may be coupled to the drive shaft of the motor 14. With regard to gear, belt drives, and/or friction drive couplings, these may make direct contact with a surface of the LGS. For example, an end of the LGS may include a drive surface such as pulley or gear which may contact one of the gear or belt drives or the friction-drive couplings. The LGS may be supported by at least one bearing such a low-friction (e.g., a polymer bearing such as Teflon or the like although other materials are also envisioned) solid bearing situated on a surface of the LGS.

Although the shaft 88 is seen extending partially through the LGS 94, it is envisioned that the shaft 88 may extend partially, substantially, and/or fully through the LGS 94. The LGS 94 may be coupled to the shaft 88 using any suitable method such as bonds, adhesives, screw fits, keyways, friction fits, etc. It is further envisioned that the LGS 94 may be keyed to receive a keyway of the shaft 88 which keying may prevent rotation between the LGS 94 and the shaft 88. It is further envisioned that the shaft 88 may include one or more flanges to properly locate the LGS 94 along the longitudinal axis La.

The body 74 of the lather generator 16 may have an interior cavity 102 with a cylindrical shape (e.g., a circular cross-section) configured to receive the LGS 94 and an interior wall 101. This interior cavity 102 may be referred to as a cylindrical cavity 102 and may be configured to include an open side 104 and an end wall 106 having an opening in communication with a guide channel 16-C of the extension 76. The cylindrical cavity 102 may be in communication with one or more optional gas vents such as openings 16-A which may configured to provide for the passage of gas, such as air, into the cylindrical cavity 102. Accordingly, this gas may be incorporated within the lather mixture to form the lather when the LGS is rotated during use. The extension 76 may include a lower wall 16-F that may be sloped towards the interior cavity 102 such that excess liquid (e.g., lather mixture) and/or lather may be guided back towards the interior cavity 102 after use. This may prevent spillage of the excess liquid. The guide channel 16-C may be situated between the end wall 106 and the outlet 16-O of the lather generator 16. A drip loop 16-D may be situated at the outlet 16-O and may be configured to guide excess liquid and/or lather to drip into the drip tray 46.

The inlet 16-I of the lather generator 16 may include any suitable coupling such as a threaded inset coupling 96 configured to receive a liquid guide such as an elbow 108 coupled thereto and which may be configured to guide the lather mixture to the inlet 16-I of the lather generator 16.

The motor 14 may include a drive shaft which may be coupled to the LGS 94 directly, via a transmission, and/or via another such as an intermediate shaft to drive the LGS 94 during operation. The shaft of the motor may be formed integrally with the shaft 88 as shown and may be configured to drive the LGS 94.

A detailed cross-sectional view of a portion of the system including the MCV 170 of FIG. 5A in accordance with embodiments of the present system is shown in FIG. 5B. An exploded detailed cross-sectional view of a portion of the MCV 170 of FIG. 5B in accordance with embodiments of the present system is shown in FIG. 5C. A top view of a portion of the inlet port 54 of the lathering system 21 in accordance with embodiments of the present system is shown in FIG. 5D. A cross-sectional view of a portion of the port extension 128 of the lathering system 21 taken along lines 5E-5E of FIG. 5C in accordance with embodiments of the present system is shown in FIG. 5E. A bottom view of a portion of the port extension 128 of the lathering system 21 in accordance with embodiments of the present system is shown in FIG. 5F.

More particularly, a portion of the of the mixture cartridge 8 in an uninstalled position (e.g., the mixture cartridge is not installed or has been removed from the body) is shown in FIG. 5C a portion of the mixture cartridge 8 in an installed position (e.g., the mixture cartridge is installed relative to the body for use) is shown in FIG. 5B.

With reference to FIGS. 5B, 5C, 5D, 5E, and 5F, the mixture cartridge 8 may include at least a portion of the MCV 170. The MCV 170 may include one or more of a valve 172 and an actuator 174 to open the valve 172 when the mixture cartridge 8 is installed relative to the body for use. For example, the valve 172 may include a flow restrictor such as a plug 154 (e.g., a silicon plug, a polymer, a metal or polymer foil or film, etc.) which may close an opening 126 of the outlet port 56 prior to installation of the mixture cartridge 8 relative to the body (e.g., FIG. 5B) for use and may permit flow through the opening 126 of the outlet port 56 when the mixture cartridge 8 is installed relative to the body. The plug 154 may be coupled at the distal end 132 of the port extension 128 using any suitable method and may seal the opening 126 of the outlet port 56. It would be appreciated methods to couple the plug 154 to the distal end 132 of the port extension 128 may include, without limitation, bonding, flanges, barbs, friction fits, adhesives, welds, screw fits, pressure fits, etc. For example, the plug 154 may include barbs 168 which may correspond with flanges 169 on a side wall 176 of the port extension 128. In yet other embodiments, it is envisioned that the plug 154 may include a film (e.g., polymer and/or metal such as a laminated polymer and/or aluminum and/or polymer film laminate or the like (which may be compatible for bonding with a material of the mixture cartridge 8 at which location the bonded is to occur) which may be bonded (or otherwise couple to) to the distal end 132 of the port extension 128 so as to block any fluid flow from the outlet port 56 until the laminate is removed, torn, pierced, or otherwise broken.

The washer 124 may be optional and may be fitted within a notched area of the port extension 128 so that it is held in place during installation and/or removal of the mixture cartridge 8 from the body. The washer 124 may be situated close to the proximal end 132 of the port extension 128 to minimize leakage of fluid, such as the lather mixture, past the washer 124. In yet other embodiments, it is envisioned that the washer 124 or gasket may be molded to an exterior wall of the port extension and/or to an interior wall 166 or a bottom wall 158 of the inlet port 54. In yet other embodiments, a gasket and/or washer may be situated between the outlet port extension 128 and adjacent areas of a side wall 166 and/or a bottom wall the 158 of the inlet port 54.

A coupler may be provided to maintain a position of the mixture cartridge 8 relative to the body when the mixture cartridge 8 is in an operative position relative to the body (e.g., is inserted into its operative position). The coupler may include any suitable locking mechanism. For example, one or more portions of the mixture cartridge 8 and/or the body may include a coupler which may maintain the position of the mixture cartridge 8 relative to the body when the mixture cartridge 8 is situated in an operating position relative to the body. It is envisioned that the washer 124 may engage a notch, a detent, ramped portion, or the like, on an adjacent interior wall of the inlet port 54 such as the side wall 166 or vice versa. For example, it is envisioned that the body may include a protrusion that may engage a notch, a detent, or the like on the mixture cartridge 8. The coupler may be configured to engage automatically when the cartridge 8 is installed relative to the body and may release when the mixture cartridge 8 is pulled away from the body with a desired force.

The actuator 174 of the MCV 170 may include any suitable actuator to open the valve 172 such as a spike 156 which may pierce the restrictor such as the plug 154 to establish a fluid coupling between the reservoir 84 and an outlet 178 of the inlet port 54. For example, the spike 156 may have proximal and distal ends. A tip 162 may be located at its distal end and may be configured to pierce or otherwise extend through the plug 154 when the cartridge 8 is installed relative to the body 40. The proximal end of the spike 156 may be coupled to the inlet port 54. For example, the proximal end of the spike 156 may be coupled to, or formed integrally with, one or more of the side wall 166 and the bottom wall 158 of the inlet port 54. The tip 162 of the spike 156 may have any suitable shape such as conical (e.g., needlelike, etc.), beveled, or the like. The spike 156 may be formed form any suitable material such as a polymer or metal (e.g., a syringe needle). The spike 156 may include at least one channel 164 which may extend between at least one opening 160 and an outlet 178 of the inlet port 54 to fluidly couple the reservoir 84 and the outlet 178 of the inlet port 54 when the mixture cartridge 8 is installed relative to the body.

The inlet port 54 may include a chamfer 133 which, in combination with the chamfer 131 of the port extension 128, is configured guide the port extension 128 into the inlet port 54 during insertion of the mixture cartridge 8 into the body. The plug 154 may include weakened areas (e.g., scores, cuts, etc.) which may extend fully or partially across its thickness to enhance separation and/or tearing of portions of the plug 154 at which the spike 156 is inserted. Further, after removal of the mixture cartridge 8 from the body and the spike 156, the plug 154 may be configured to seal the opening 126 of the outlet port 56 to reduce or entirely prevent the flow of the fluid, such as the lather mixture, from the reservoir 84 through the outlet port 56. This may prevent leakage when removing the mixture cartridge 8 from the body.

It is also envisioned that spike may be a metal spike, such as a syringe, having a hub having an opening coupled to a channel of the syringe. A coupler may be provided to couple to a hub so that the channel 164 of the syringe may be coupled to the outlet 178 of the inlet port 54.

When the outlet port extension is coupled to the inlet port, an actuator (configured to open the first valve) may open the first valve and the mixture cartridge may be assumed to be installed relative to the body for use.

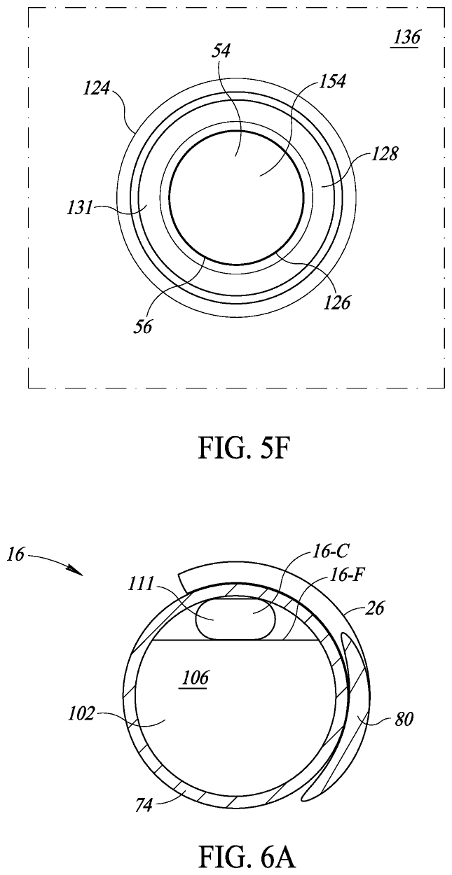

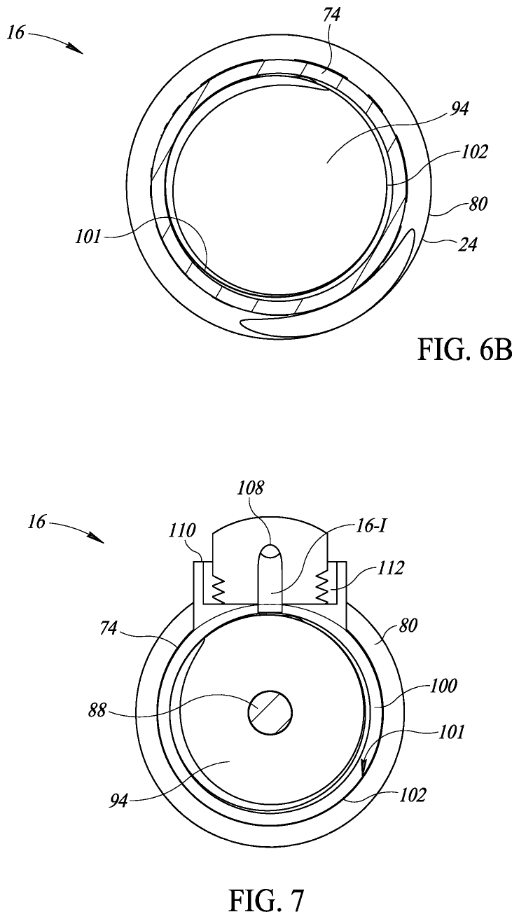

FIG. 6A is a diagram illustrating a cross-sectional view of a portion of the lathering system 21 taken along lines 6A-6A of FIG. 5A in accordance with embodiments of the present system. The LGS 94 is not shown for the sake of clarity. The interior cavity 102 may include the end wall 106 at its distal end. This end wall 106 may include an opening 111 which may couple the interior cavity 102 of the body 74 (FIG. 5A) to the guide channel 16-C of the extension 76. The lower wall 16-F may define at least part of the guide channel 16-C. The IRWHE 80 of the heater 26 may be extend about the body 74 of the lather generator 16. For example, the IRWHE 80 may be coiled partially, or fully, about at least a portion of the body 74.

FIG. 6B is a diagram illustrating a cross-sectional view of a portion of the lathering system 21 taken along lines 6B-6B of FIG. 4 in accordance with embodiments of the present system. The LGS 94 is seen situated within the interior wall 101 which defines a portion of the interior cavity 102 of the body 74 of the lather generator 16.

A cross-sectional view of a portion of the lathering system 21 taken along lines 7-7 of FIG. 4 in accordance with embodiments of the present system is shown in FIG. 7. The LGS 94 is seen within the interior cavity 102 of the body 74 of the lather generator 16 and may include the screw-like thread 100. The body 74 of the lather generator 16 may include an inlet 16-I which may extend between a saddle 110 and the interior wall 101 of the body 74 of the lather generator 16. A coupler 112 such as an insert may be situated within the inlet 16-I of the lather generator 16. The coupler 122 may be configured to couple conduit which may carry fluid such as the lather mixture from the mixture cartridge to the inlet 16-I of the lather generator 16. The coupler 112 may be configured to use any suitable method of coupling such as a threaded coupling (e.g., a luer coupling, etc.), a friction coupling, a snap-fit coupling, a barbed fitting, a fixed coupling, and/or the like. For example, the coupler 112 may be cylindrical in shape and may be formed from the same of a different material than that of the body 74 such as a metallic material (e.g., brass, stainless-steel, etc.) and may provide additional strength to the body 74 of the lather generator 16.

The saddle 110 may provide for a seat upon which a sealing washer may be seated if desired and may further reinforce the body 74 of the lather generator 16. An elbow coupling 108 may be coupled to the inlet 16-I by the coupler 112 and may be configured to receive an outlet end of the valve 12. The sealing washer may be situated between the saddle 110 and the elbow coupling 108. In yet other embodiments, it is envisioned that the valve 12 may be coupled directly to the inlet 16-I by the coupler 112.

The IRWHE 80 of the heater 26 may be extend about the body 74 of the lather generator 16. For example, the IRWHE 80 may be fully or partially coiled about an at least a portion of the body 74.

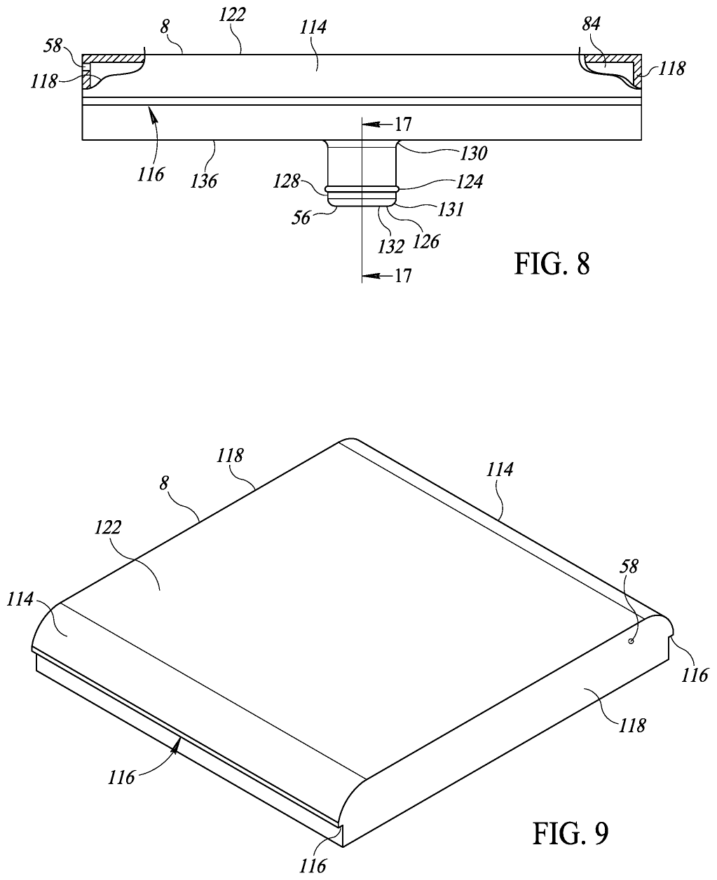

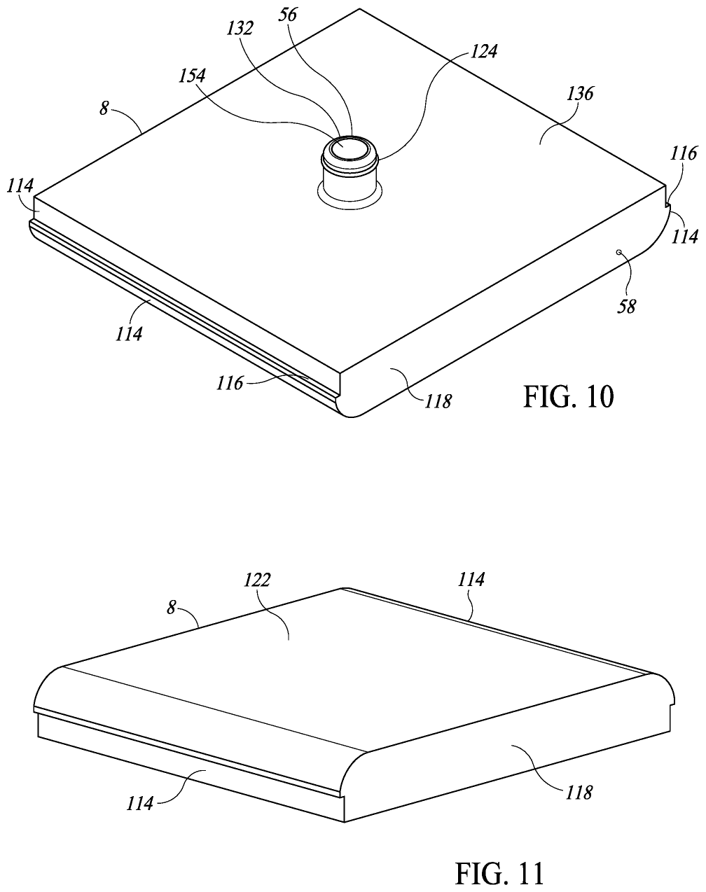

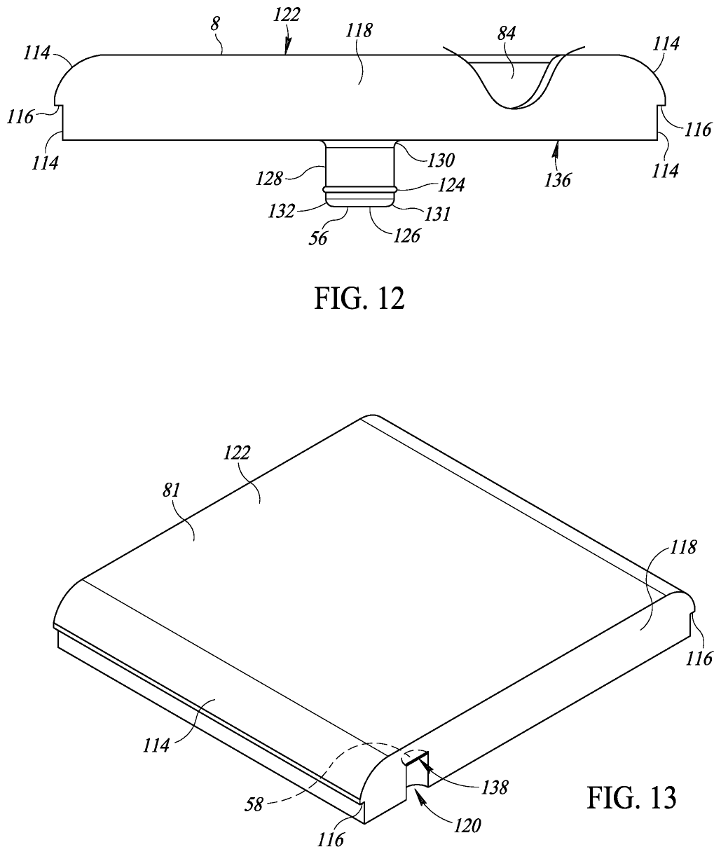

A partially cutaway side view of a portion of the mixture cartridge 8 of the system 21 in accordance with embodiments of the present system is shown in FIG. 8. A top perspective view of a portion of the mixture cartridge 8 of the system 21 in accordance with embodiments of the present system is shown in FIG. 9. A bottom perspective view of a portion of the mixture cartridge 8 of the system 21 in accordance with embodiments of the present system is shown in FIG. 10. A top perspective view of a portion of the mixture cartridge 8 of the system 21 in accordance with embodiments of the present system is shown in FIG. 11. A partially cutaway end view of a portion of the mixture cartridge 8 of the system 21 in accordance with embodiments of the present system is shown in FIG. 12.

With reference to FIGS. 8 through 12, the mixture cartridge 8 may include one or more walls such as side walls 114, end walls 118, a top wall 122, and the bottom wall 136, an outlet port 56, and the reservoir 84. The reservoir 84 may be situated within a cavity of the mixture cartridge 8 and may configured to hold at least a portion of a fluid such as the lather mixture and may be defined, at least in part, by the one or more walls (114, 118, 122, and 136). In accordance with embodiments of the present system, a bag may be situated within the reservoir 84 and may be configured to hold the liquid within the reservoir such as the lather mixture. As the side views may be similar, only a single side view is shown. The bottom wall 136 may have the inner floor 137 that may be inclined or otherwise sloped towards the outlet port 56 so as to direct the fluid, such as the lather solution, contained within the reservoir 84 towards the outlet port 56 under the force of gravity. Accordingly, the bottom wall 136 may include a sloped inner floor 137 with, for example, an incline which is higher at the side walls 114 and end walls 118 and lower at the outlet port 56. This incline may be formed by varying a thickness TIF of the bottom wall 136 as is extends away from the outlet port 56 (e.g., gaining thickness) so as to incline the inner floor 137 and/or by inclining the bottom wall 136 as is extends away from the outlet port 56. Accordingly, fluid within the reservoir 84 may be directed towards the outlet port 56 under the force of gravity.

The outlet port 56 may include one or more of a (male-type) port extension 128 having proximal and distal ends 130 and 132, respectively, a gasket such as a washer 124, a port opening 126, and a chamfer 131. The chamfer 131 may be configured to engage a chamfer of the inlet port 54 to guide coupling of the outlet port 56 with the inlet port 54. The gasket may include any suitable gasket such as the washer 124. The washer 124 may be suitable for sealing a gap between the male type port extension 128 and an adjacent interior wall 166 of the inlet port 54. In yet other embodiments, it is envisioned that the gasket may be situated elsewhere such as within the inlet port 54, within the outlet port 56, and/or in any other suitable location or locations.

The mixture cartridge 8 may include one or more saddles to support at least a portion of the mixture cartridge 8 to enhance stability of the mixture cartridge 8 when in use. The saddles may correspond with a location of corresponding saddles of the body 40 such as the saddles 60. Accordingly, the side walls 114 may include saddles 116. In yet other embodiments, it is envisioned that one or more saddles may be located on one or more of the walls such as in one or more of the side walls 114, end walls 114, a top wall 122, and a bottom wall 136. The body 40 may then include corresponding saddles. The side walls 114 may be similar to each other, similarly, the end walls 118 may be similar to each other.

The vent port 58 may extend through one or more of the walls such as one of the side walls 118 and may be configured to equalize pressure within the reservoir 84 with an ambient air pressure or another desired pressure. Vent ports 58 may be included in one or more of the side walls 114, end walls 118, top wall 122 and bottom wall 136. One or more of the end walls 118 may include the vent port 58.

A liquid such as a lather solution may be located within the reservoir. In accordance with some embodiments, the reservoir 84 may have a capacity of two through four fluid ounces of lather mixture. In accordance with yet other embodiments, other capacities are also envisioned such as one fluid ounce, or four or more fluid ounces, etc. such as 8 fluid ounces, etc.

It may be desirable to prevent liquid such as the lather mixture from passing through the vent port 58. Accordingly, a hydrophobic barrier or plug may be situated at the vent port 58 to seal the vent port 58 so that liquid may not pas therethrough while allowing air to pass therethrough. In yet other embodiments, a plug which may seal the vent port 58 may be removed before use. For example, the plug may be formed integrally with the mixture cartridge 8 and may be frangibly decoupled from the mixture cartridge 8 prior to use.

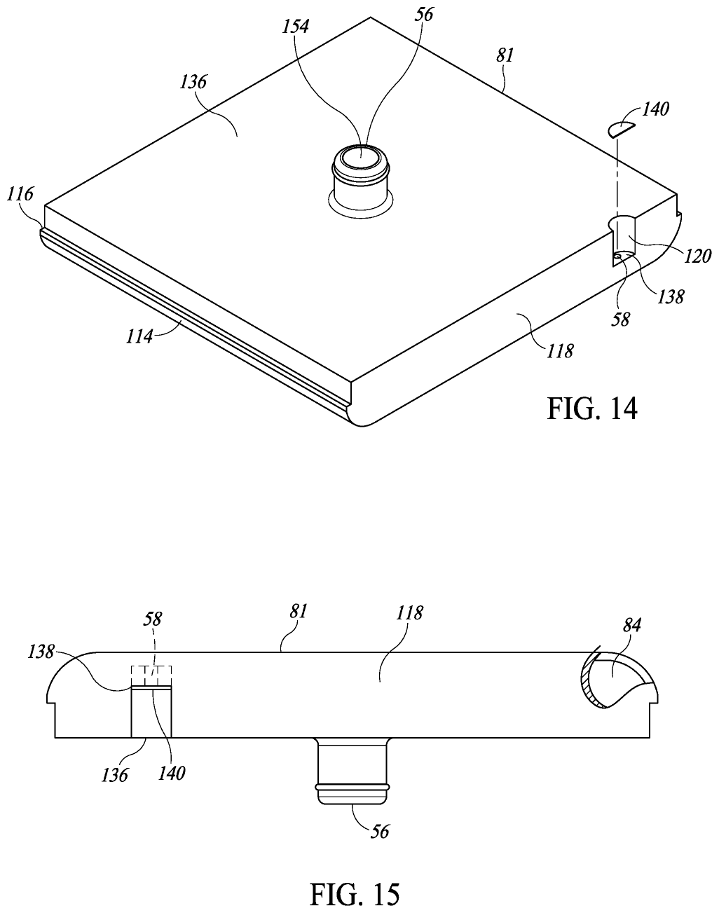

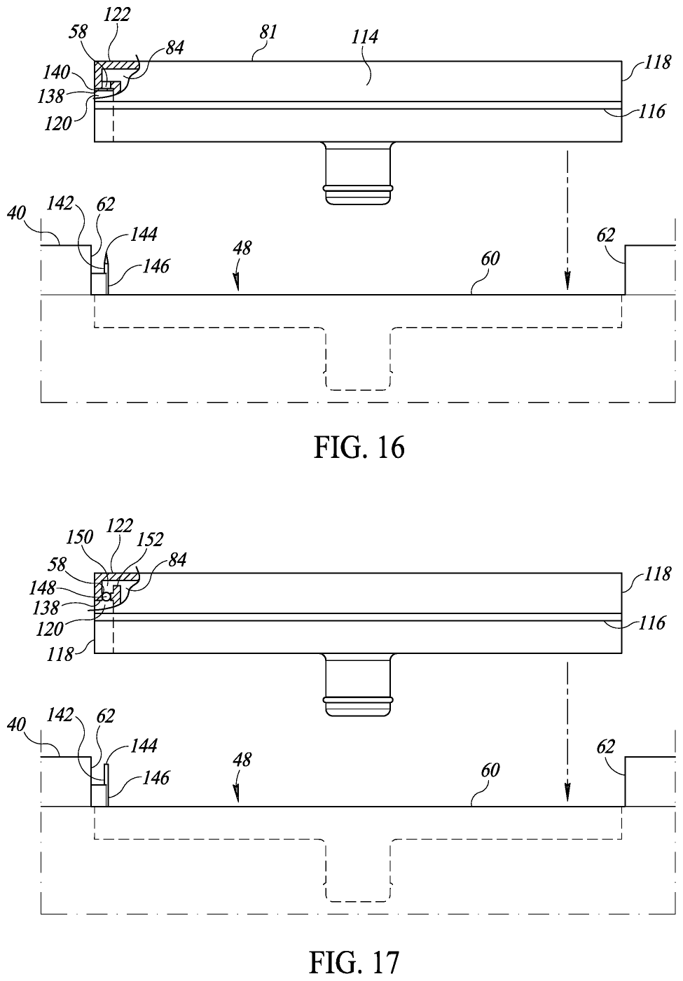

In accordance with embodiments of the present system, it is envisioned that the vent port 58 may be covered by a removable tape, fastener, cover, a barrier (e.g., a hydrophobic barrier, etc.), plug, or the like to prevent the liquid from escaping from the reservoir 84 through the vent port 58 prior to use such as during, shipping, handling, and/or storage of the mixture cartridge 8. Then, prior to installation, the barrier may be removed, pierced, etc. to equalize an ambient pressure with the reservoir 84. In accordance with yet other embodiments of the present system, the vent port 58 may be automatically pierced. This may be illustrated with reference to FIGS. 13, 14, 15, and 16. In particular, FIG. 13 shows a top perspective view of a portion of the mixture cartridge 81 of the system 21 in accordance with embodiments of the present system. FIG. 14 shows a bottom perspective view illustration of a portion of the mixture cartridge 81 of the system 21 in accordance with embodiments of the present system. FIG. 15 shows a partially cutaway end view of a portion of the mixture cartridge 81 of the system 21 in accordance with embodiments of the present system. FIG. 16 shows an exploded side view illustration of the mixture cartridge 81 being inserted within the cavity of the body 40 with an optional spike in accordance with embodiments of the present system; and FIG. 17 shows a partially cutaway exploded side view illustration of the mixture cartridge 81 being inserted within the cavity of the body 40 including the optional spike in accordance with embodiments of the present system.

With reference to FIGS. 13, 14, 15, 16, and 17, the mixture cartridge 81 may be similar to the mixture cartridge 8 and may include one or more walls such as side walls 114, end walls 118, a top wall 122, a bottom wall 136, an outlet port 56, and a reservoir 84. it is envisioned that one of walls such as one of the end walls 118 may include a notch or slot 120 with a top wall 138 and a vent port 58 located in the top wall 138 of the slot 120. A vent port barrier such as a ball (e.g., FIG. 17 and the description thereof), a plug, a silicone valve (e.g., a duckbill valve, etc.) a film, a hydrophobic barrier, and/or the like, may cover the vent port 58.

For example, in embodiments of the system, the vent port barrier may include a film 140 such as a polymer film or the like may be bonded to the top wall 138 to cover the vent port 58 and prevent liquid from within the reservoir 84, such as the lather mixture, from leaking out. The film 140 may be pierced automatically when installing the mixture cartridge 81 into the body or the film 140 may be removed or otherwise removed at least partially from the mixture cartridge 81 manually. Accordingly, the film 140 may include a tab which may extend beyond a periphery of the film 140 and which may be configured to be grasped by user for removing at least a portion of the film 140 from the mixture cartridge 81 so as to expose the vent port 58.

With reference to FIG. 16, a spike 142 may be situated so that it may pierce, cut, and/or otherwise displace the vent port barrier such as the film 140. The spike 142 may include one or more of a tip 144 and a channel 146 or notch through which air may pass and may enter the mixture cartridge through the vent port 58. The spike 142 may be situated so that it may pierce the film 140 when the mixture cartridge 81 is inserted within the cavity 48 of the body 40. The spike 142 may be coupled the body 40 using any suitable method. For example, the spike 142 may be formed integrally with the side wall 62 of the cavity 48 or the spike may couple to the side wall 62 using any suitable coupling method such as a friction fit coupler, a flange and a rail coupler, a threaded coupler, a snap-fit coupler, etc.

The position and orientation of the spike 142 may be such that the tip 144 of the spike 142 can pierce the film 140 and may partially or fully enter the vent port 58. Although the spike 142 may be solid, it is envisioned that in embodiments of the present system the spike 142 may include at least one interior or exterior channels such as channel 146 which may provide for the entry of air at ambient pressure into the reservoir 84 to balance pressure within the reservoir 84 with ambient pressure. It is envisioned that in embodiments of the present system, an exterior channel may be situated in a surface of the spike 142 while an interior channel may be situated within a body of the spike 142 and may have one or more openings in a surface of the spike which may flow couple the reservoir 84 with ambient air.

In accordance with embodiments of the present system, it is envisioned that a displaceable object such as a sphere (e.g., an elastomeric or steel ball or the like) may situated in the vent port 58 to act as a vent port barrier. For example, FIG. 17, shows the spike 142 may be configured to displace the vent port barrier such as a sphere 148. The spike 142 may include the tip 144 (that may be blunt in the present embodiments) and the channel 146 through which air may pass. The spike 142 may be situated so that it may displace the sphere 148 from the vent port 58 located in the top wall of the slot 120 situated at one of the end walls 118 and into a vent channel 150. The sphere 148 may be coupled to the walls of the vent port 58 using any suitable method such as a friction fit, etc. The vent channel 150 may include a restriction 152 which may prevent the displaced sphere 148 from entering into the reservoir 84 if desired. The sphere 148 may be displaced by the spike 146 when the mixture cartridge 81 is inserted within the cavity 48 of the body 40. The spike 142 may be coupled the body 40 using any suitable method. For example, the spike 142 may be formed integrally with the side wall 62 of the cavity 48. The position and orientation of the spike 142 may be such that the tip of the spike can displace the ball 148 and partially or fully enter the vent port 58. Accordingly, when the mixture cartridge 8 is inserted within the cavity 48 of the body 40, the spike may be configured to provide a force to displace the ball from the vent port 58 such that the vent port 58 may provide for the flow of ambient air to the reservoir 84. Further, the spike 148 may be shaped and sized such that it is smaller than vent port 58 not to substantially obstruct the flow of ambient air to the reservoir 84 in which case the channel 46 may be optional. The saddles 116 may rest upon the saddle 60 of the body 40.

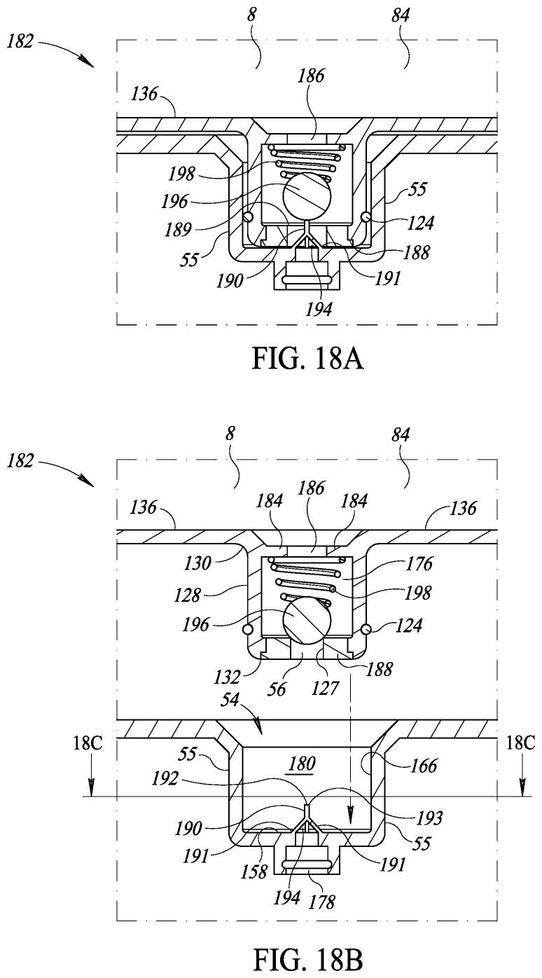

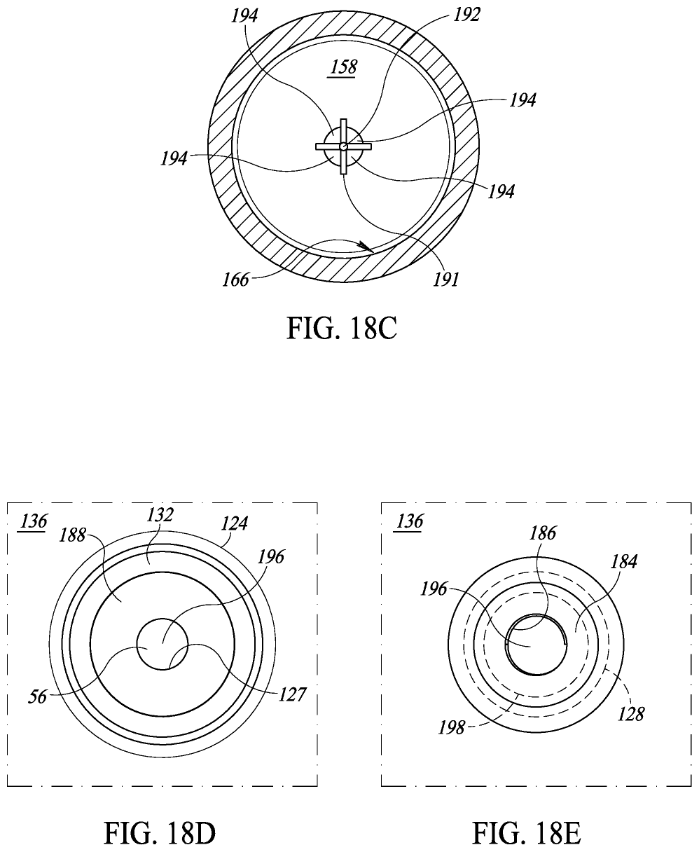

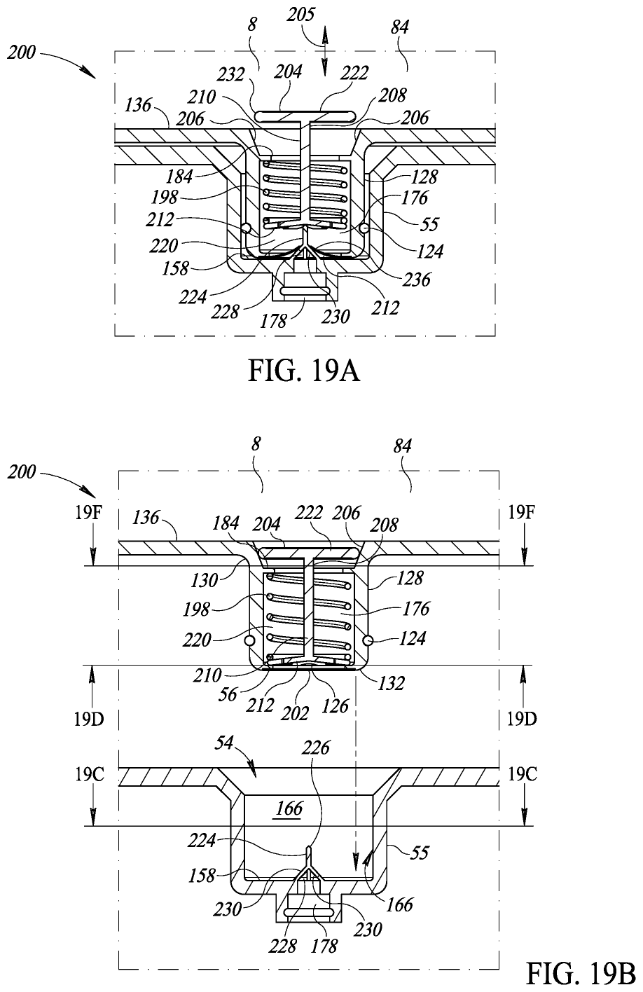

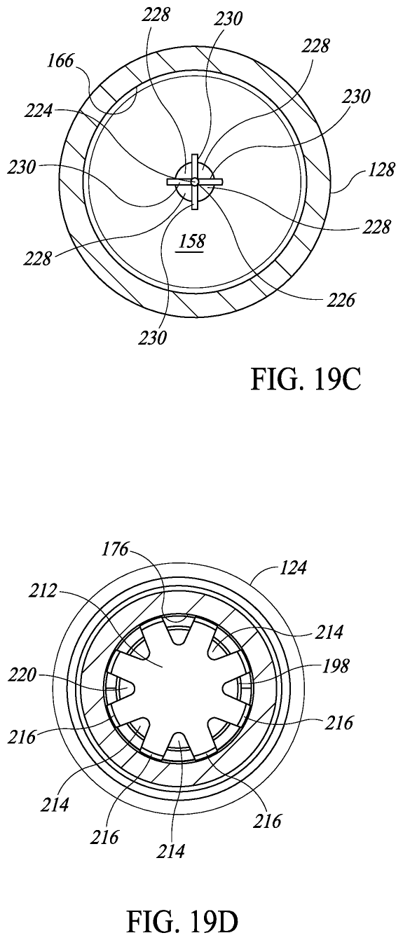

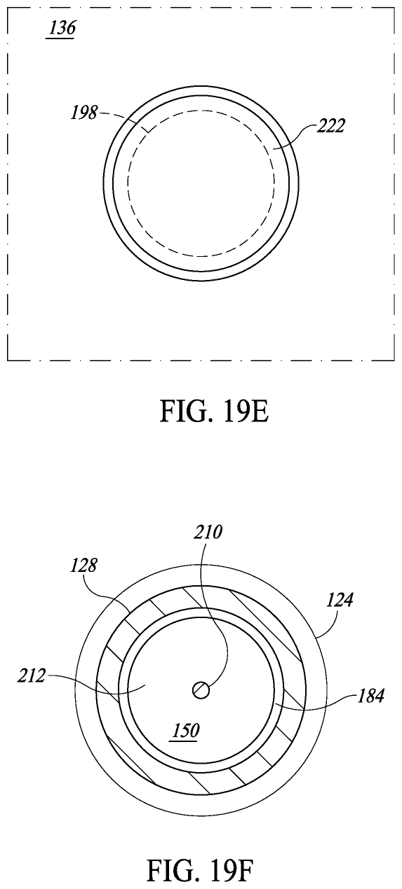

Although a plug type MCV is discussed above, it will be appreciated that other types of MCVs may also be employed. For example, FIGS. 18A, 18B, 18C, 18D, 18E, 19A, 19B, 19C, 19D, 19E, and 19F discuss ball valve type and poppet valve type MCVs. In yet other embodiments, other types of suitable MCVs are also envisioned. Generally, the MCVs may prevent liquid contained in the reservoir of the mixture cartridge, such as lather mixture, from leaking when the mixture cartridge is not installed relative to the body for use. Although several embodiments of MCV valve types of are shown and discussed, it should be appreciated that MCVs having other valve types may be substituted for those shown. Portions of the MCVs may be situated at the inlet and outlet ports.

A ball-type MCV is illustrated in FIG. 18A which shows a cross-sectional view of a portion of a ball-type MCV 182 of the lathering system in accordance with embodiments of the present system. FIG. 18B shows an exploded cross-sectional view of a portion of the MCV 182 of FIG. 18A in accordance with embodiments of the present system. FIG. 18C shows a cross-sectional view of a portion of the MCV 182 taken along lines 18C-18C of FIG. 18B in accordance with embodiments of the present system. FIG. 18D shows a bottom view of a portion of the port extension 128 in accordance with embodiments of the present system. FIG. 18E shows a top view of a portion of the bottom wall 136 and an opening 186 of the port extension 128 in accordance with embodiments of the present system.

With reference to FIGS. 18A, 18B, 18C, 18D, and 18E, the mixture cartridge 8 including a plug 188 may be coupled to the distal end 132 of the port extension 128 and may act as a valve seat 189 for a sphere 196 that may be biased against the valve seat 189 by a biasing member such as a coiled spring 198. The plug 188 may have an opening 127 through which liquid, such as a lather mixture, contained within the reservoir 84 may pass. The spring 198 may be situated between a flange(s) 184 and the sphere 196 and may provide a biasing force to cause the sphere 196 to be biased against the valve seat 189 of the plug 188 such that the sphere 196 may be firmly seated against the valve seat 189 and may close the MCV 182 such that fluid from the reservoir 84 does not pass through the opening 126 when the MCV 182 is closed. The sphere 196 may be formed from any suitable material such as a polymer and/or a metal (e.g., stainless steel). At least a portion of the flange(s) 184 may form the opening 186 configured to provide for the passage of liquid, such as the lather mixture, contained within the reservoir 84 to flow to the port extension 128. The opening 127 may be configured to receive an actuator such as a spike 190 having a proximal end 191 and a distal end 193. The proximal end 191 may be coupled to one or more of the side wall 166 and the bottom wall 158 of the inlet port 54 and the distal end 193 may have a blunt end 192. The shape and size of the actuator such as the spike 190 should be such that it is smaller than the opening 126 and thus does not impede fluid flow when fluid from the reservoir 84 from passing through the opening 26 when the spike 190 is situated in the opening 127 and the MCV 182 is open.

The actuator, such as the spike 190, may have one or more openings 194 which may be coupled to the outlet 178 of the inlet port 54. Accordingly, fluid from the reservoir 84, such as the lather mixture, may pass through the outlet 178 when the MCV 182 is open and into or otherwise through the inlet port 54 and through the outlet 178. The MCV 182 may, thus, be open when a portion of the actuator, such as the spike 190, provides a force to displace the sphere 196 away from the valve seat 189 and into its open position. This may occur when the mixture cartridge 8 is inserted relative to the body as illustrated in FIG. 18B.

When the mixture cartridge 8 is not inserted relative to the body, the sphere 196 may be seated against the valve seat 189 and prevent and/or substantially reduce the flow of liquid from the reservoir 84, such as lather mixture, from passing through the opening 126 (e.g., FIG. 18B). Further, after removal of the mixture cartridge 8 from the body and, thus, the spike 190, the sphere 196 may be configured and biased against the valve seat 189 of the plug 188 to seal the opening 126 of the outlet port 56 to reduce or entirely prevent the flow of the fluid such as the lather solution from the reservoir 84.

A poppet-valve-type MCV is illustrated in FIG. 19A which shows a cross-sectional view of a portion of a ball-type MCV 200 of the lathering system in accordance with embodiments of the present system. FIG. 19B shows an exploded cross-sectional view of a portion of the MCV 200 in accordance with embodiments of the present system. FIG. 19C shows a cross-sectional view of a portion of the MCV 200 taken along lines 19C-19C of FIG. 19B in accordance with embodiments of the present system. FIG. 19D shows a cross-sectional view of a portion of the MCV 200 taken along lines 19D-19D of FIG. 19B in accordance with embodiments of the present system. FIG. 19E shows a top view of the view of a poppet valve of the MCV 200 in accordance with embodiments of the present system. FIG. 19F shows a cross-sectional view of a portion of the MCV 200 taken along lines 19F-19F of FIG. 19B in accordance with embodiments of the present system.

With reference to FIGS. 19A, 19B, 19C, 19D, 19E, and 19F, the port extension 128 may have an optional an optional seal such as a film 202 (e.g., formed from a polymer, a metal such as aluminum, a laminate, etc.) or the like coupled thereto. The film 202 and may function as an initial seal to seal the opening 126 of the outlet port 56 prior to insertion of the mixture cartridge 8 into the body and to prevent the liquid from the reservoir 84 from leaking through the outlet port 56 prior to use. Accordingly, the film 202 may be coupled to the port extension 128 in any suitable location such as at or near the distal end 132 of the port extension 128.

A poppet valve 204 may be situated within a cavity 220 defined by the side wall 176 of the port extension 128. The poppet valve 204 may include one or more of a head 222, a neck 208, a stem 210, a face 232, and a retainer 212. The poppet valve 204 may be biased into a closed position (e.g., as illustrated with respect to FIG. 19B) by a biasing member such as spring 198 (e.g., a coil spring or any other suitable spring that may provide a biasing force) or the like. The spring 198 may be situated between flange 184 and the retainer 212 of the poppet valve 204 and may provide a biasing force to cause the poppet valve 204 to close the MCV 200 such that fluid from the reservoir 84 does not pass through the opening 126 when an actuator 224 is not forcing the poppet valve 204 open such as may occur prior to the mixture cartridge 8 being coupled to the body for use or when the mixture cartridge 8 is not coupled to the body for use.

The poppet valve 204 may be formed from any suitable material or combination of materials such as a polymer, a metal, glass, ceramic, etc. It is envisioned that the biasing member may be formed integrally with the poppet valve 204 and may include other shapes and/or sizes. The port extension 128 may include a valve seat 206 configured to contact and maintain a seal with a portion of the valve 204 such as a portion of the face 232 of the valve 204 when the poppet valve 204 is in the closed position (e.g., FIG. 19B) so that fluid from the reservoir 84 does not substantially pass through the poppet valve 204. When in the open position, such as when the mixture cartridge 8 is installed in the body, the spike may raise the valve 204 such the face 232 may be separated from the valve seat 206 to provide for the passage of fluid from the reservoir 84 through the valve to the outlet 178 of the inlet port 54 (e.g., FIG. 19A). In accordance with some embodiments, the face 232 may include a washer situated about the face 232 to form a seal with the valve seat 206.

The retainer 212 of the poppet valve 204 may be shaped and sized such that it is slightly smaller than an inside of the cavity 220 such that it may be guided by the side wall 176 to stabilize the poppet valve 204 as it moves linearly in relation to the cavity 220 as illustrated by arrow 205. The retainer 212 may include one or more openings or notches 214 (e.g., FIG. 19D) situated between fingers 216 to allow liquid from the reservoir 84 such as lather solution to pass the retainer 212 when the poppet valve 204 is in the open position as illustrated in FIG. 19A while the fingers 216 may be guided by the side wall 176 to stabilize the poppet valve 204. The retainer 212 may further be configured to contact an actuator such as a spike 224 or the like which may lift the retainer 212 and, thus, open the poppet valve 204. Moreover, the retainer 212 may have a concave shape as shown to stabilize it when the spike 224 is, for example, biasing the poppet valve 204 in an open position.

The spike 224 may be similar to the spike 224 and may have proximal and distal ends. The proximal end may be coupled to the bottom wall 158 and/or to the side wall 166 by supports 230 between which openings 228 may be situated. The openings 228 may lead to the outlet 178 of the inlet port 54. The distal end of the spike 224 may include a pointed end 226 configured to pierce the optional film 202. The supports 228 may be configured at an angle to each other to form an opening 236 in the optional film 202 so that fluid from the reservoir 84 may flow through the openings 236 and 230 when the mixture cartridge 8 is inserted into the body.

If the optional film 202 is not used, the distal end of the spike 224 may be mushroom-shaped or blunt as shown on the spike 190 of FIG. 18B. It is further envisioned that the spike 224 may be cylindrical in shape as shown in FIG. 5B and include one or more openings configured to provide a flow passage to the outlet 178 of the inlet port 54 through which fluid from the reservoir 84 may flow.

In accordance with embodiments of the present system mixture cartridges may include electronically controlled valves. It is further envisioned that mixture cartridges may include a cartridge-type valve that may be controlled passively or actively by the controller. In yet other embodiments, mechanically controlled valves are also envisioned.

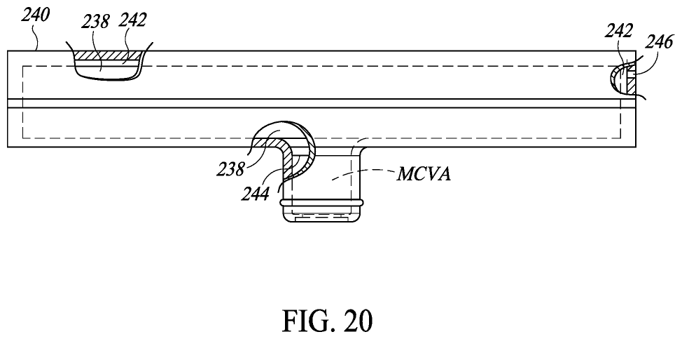

FIG. 20 shows a partially cutaway side view of a portion of a mixture cartridge 240 including a bladder type reservoir 238 in accordance with embodiments of the present system. The mixture cartridge 240 may be similar to the mixture cartridge 8 (e.g., FIG. 8). The reservoir 238 may be defined by a thin deformable material such as a polymer film or the like and may be situated within a cavity 242 of the mixture cartridge 240. The reservoir 238 may include an outlet 244 coupled to an input of the an MCV of the cartridge 240. This may prevent fluid, such as lather solution, situated within the reservoir 238 from spilling outside of the reservoir 238 and within the cavity 242. The mixture cartridge 240 may include a vent 246 to equalize pressure within the cavity 242 with ambient pressure. The reservoir 238 may deform as the liquid contained within, such as the lather solution, is drained from the cartridge 238.

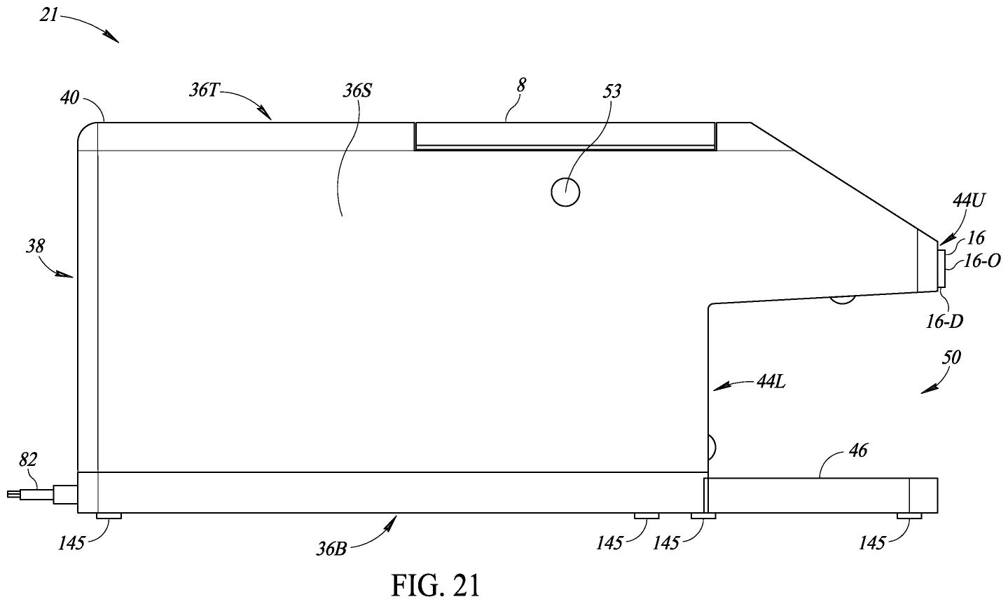

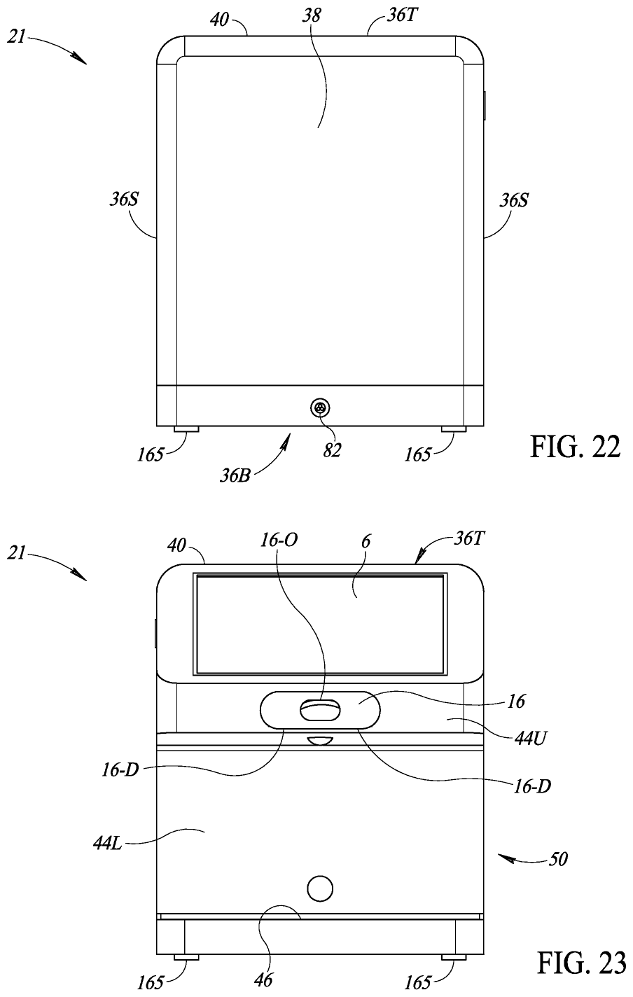

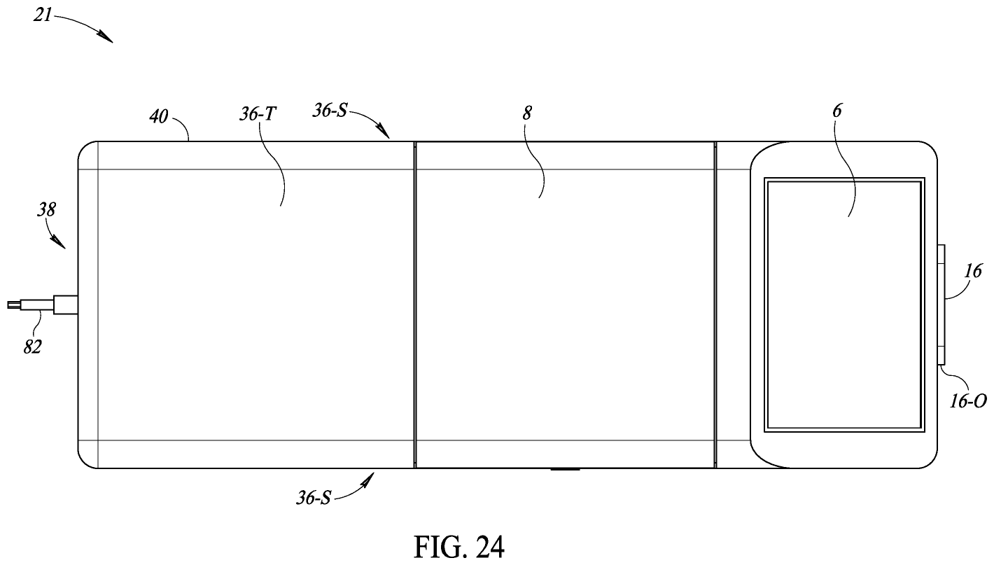

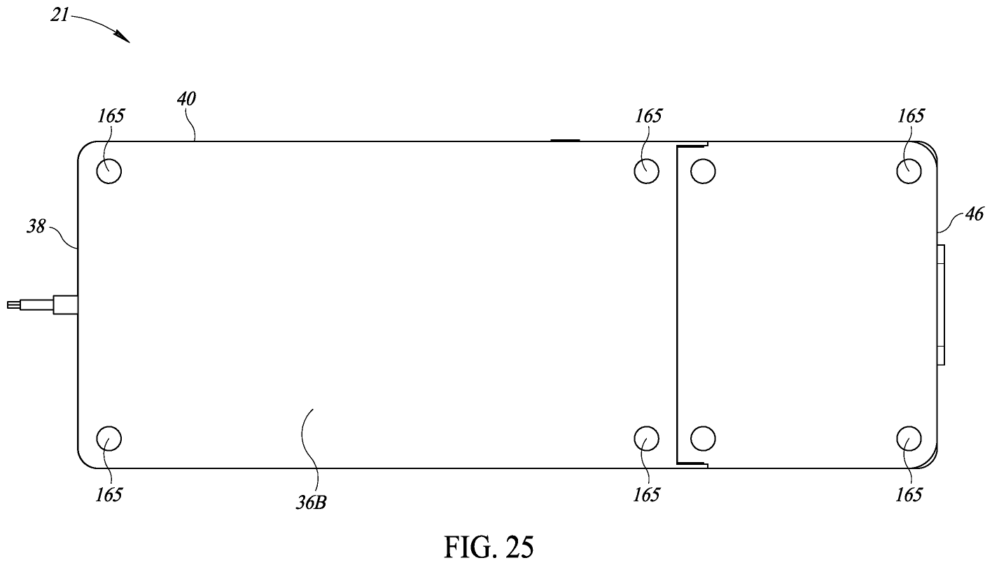

Various views of portions of the lathering system 21 of FIG. 2 will now be shown and described with reference to FIGS. 21, 22, 23, 24, and 25. In particular, FIG. 21 shows a side view of a portion of a lathering system 21 of FIG. 2 in accordance with embodiments of the present system. FIG. 22 shows a rear view of a portion of a lathering system 21 of FIG. 2 in accordance with embodiments of the present system. FIG. 23 shows a front view of a portion of a lathering system 21 of FIG. 2 in accordance with embodiments of the present system. FIG. 24 shows a top view of a portion of a lathering system 21 of FIG. 2 in accordance with embodiments of the present system. FIG. 25 shows a bottom view of a portion of a lathering system 21 of FIG. 2 in accordance with embodiments of the present system.

With reference to FIGS. 21, 22, 23, 24, and 25, the body 40 may include the opening 50 which should be of sufficient size such that a user may insert portions of his or her hand within the opening to receive lather which may be output (e.g., dispensed) at the outlet 16-O of the lather generator 16. The drip loop 16-D may have a sufficient drop relative to other adjacent portions of the lather generator 16 such that it may guide excess liquid and/or lather to drip into the drip tray 46 which may extend beyond a periphery of the outlet 16-O to catch drips of excess liquid and/or lather. This may prevent liquid from flowing back along the extension (e.g., 76, FIG. 4) of the lather generator (e.g., 16, FIG. 4).

The cartridge release 53 may be located in a location that may be convenient for a user to use such as in one or more of the side walls 36S. In yet other embodiments, the cartridge release may be located in any other suitable location. The cartridge 8 is shown attached to the body 40 for use and may have an outer periphery that may be flush with adjacent portions of the body 40 such as one or more of the adjacent side walls 36S and top wall 36T. Pads 145 may be coupled to the bottom walls 36B and configured to provide for anti-vibration and anti-slip mounting as well as ventilation of the bottom wall 36B of the lathering system 21. The pads 145 may be made from any suitable material or materials such as a polymer, rubber, metal, and/or the like, and may have any suitable shape such as flat, etc. The front wall 44 may include a plurality of portions such as a front wall upper 44U and a front wall lower 44L (generally 44X). The rear wall 38 may be located opposite the front wall lower 44L.

The drip loop 16-D may include one or more drip loops and may extend lower than adjacent areas to guide excess liquid and/or lather to the drip tray 46. The one or more drip loops may be formed by a notch, a cutout, a loop, etc., and may have any suitable and/or shape.

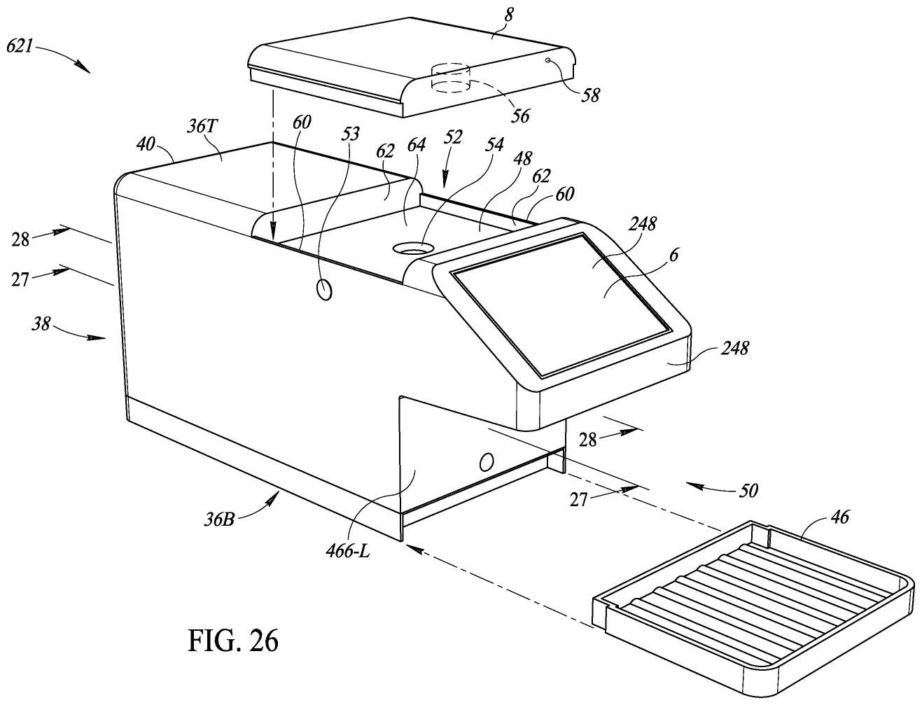

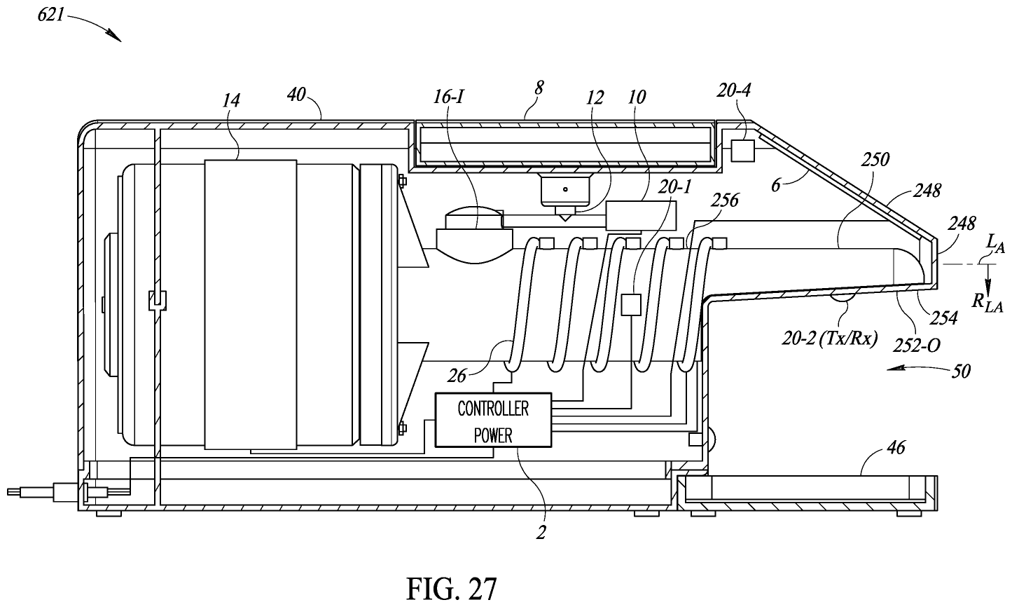

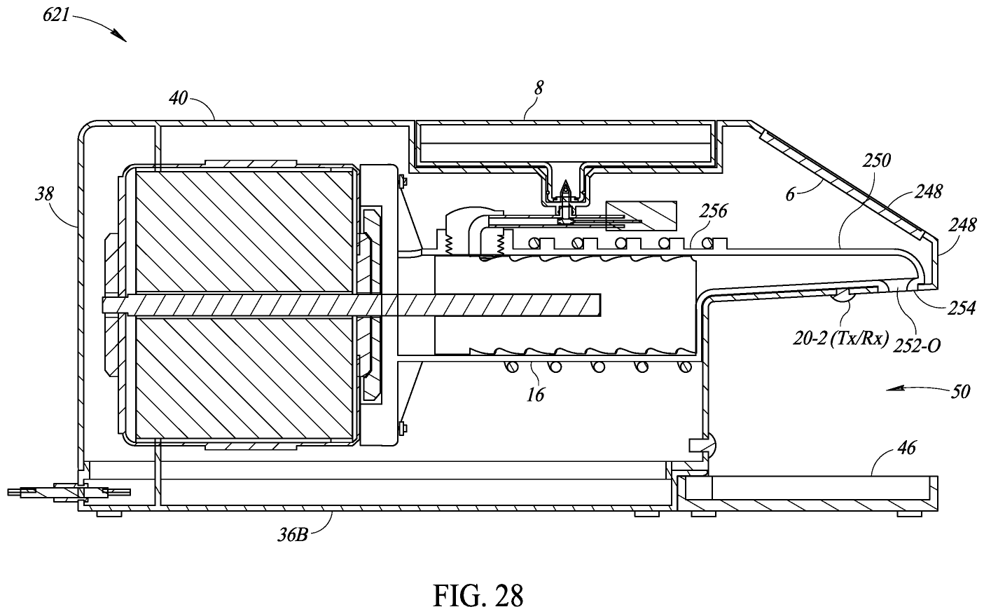

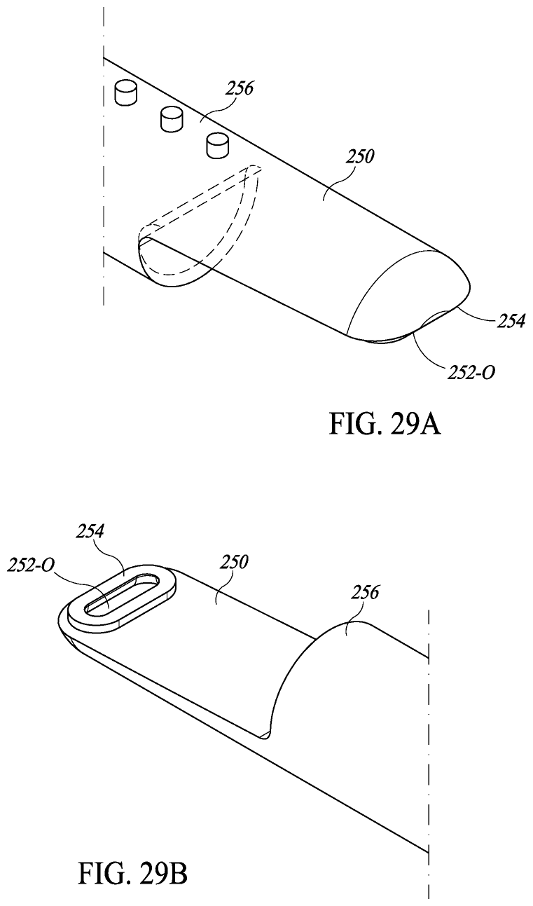

Alternative embodiments using a downward oriented lather generator output will now be discussed with reference to FIGS. 26, 27, 28, 29A, and 29B, wherein FIG. 26 shows a perspective front view of a portion of a lathering system 621 (hereinafter system 621 for the sake of clarity unless the context indicates otherwise) in accordance with embodiments of the present system. FIG. 27 shows a cross-sectional view of a portion of the lathering system 621 taken along lines 27-27 of FIG. 26 in accordance with embodiments of the present system. FIG. 28 shows a cross-sectional view of a portion of the lathering system 621 taken along lines 28-28 of FIG. 26 in accordance with embodiments of the present system. FIG. 29A shows a detailed top perspective view of a portion of a lather generator 256 in accordance with embodiments of the present system. FIG. 29B shows a detailed bottom perspective view of a portion of a lather generator 256 in accordance with embodiments of the present system.

With reference to FIGS. 26, 27, 28, 29A, and 29B, the system 621 may include one or more of a body 40, a controller 2, a display 6, a mixture cartridge 8, a lather generator 16, sensors 20-x (e.g., 20-1, 20-2, and 20-4), and a drip tray 46. The system 621 may be operated under the control of the controller 2 and may be similar to the system 21 of FIG. 2 and similar numerals may be used to denote similar portions. The output of the lather generator 16 may be situated behind and concealed by a front wall upper 248 and an output of the lather generator 16 may be orientated downward towards and/or towards the drip tray 46. Further, the front wall upper 248 may form a portion of a cover or bezel for the display 6.

With reference to FIG. 27, proximity sensors 20-2 (Tx/Rx) may include an infrared transmitter and receiver pair which may detect the presence of an object such as a hand of a user and may form corresponding proximity signal information and provide this information to the controller 2. It is also envisioned that a mechanical switch and/or a capacitive sensors may also be used to detect the present of an object such as the hand of a user. Any suitable proximity sensor may be employed. A humidity sensor 20-4 may provide humidity information to the controller 2 for further analysis in accordance with embodiments of the present system. The humidity sensor may include an opening to sample ambient conditions. This opening may be coupled to ambient air through one or more corresponding openings in the body 621.

With reference to FIGS. 27, 28, 29A, and 29B, the lather generator 16 may include an extension 250 that may be similar to the extension 76 of FIG. 4, however, the extension 250 may include a distal end 254 having an outlet 252-O that may point substantially radially away from the longitudinal axis La substantially in a direction show by RLa.

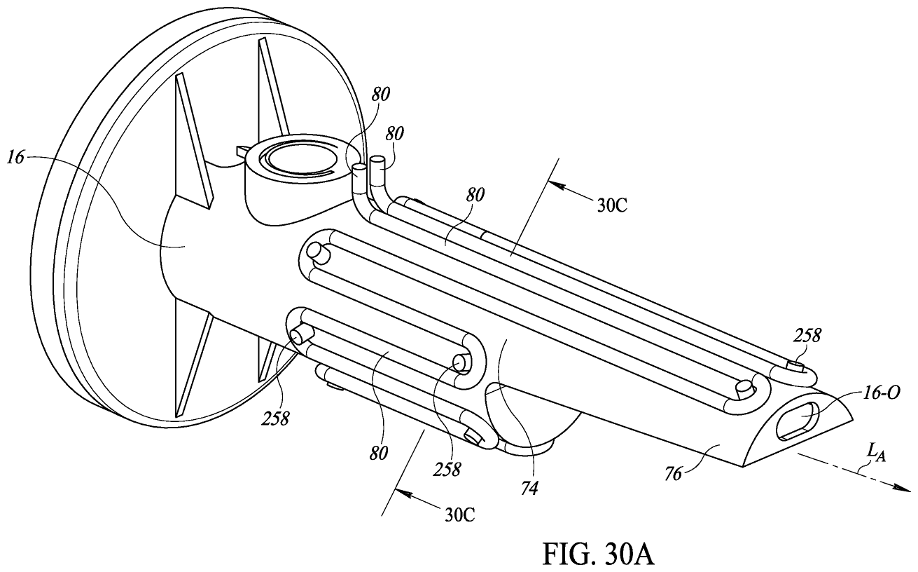

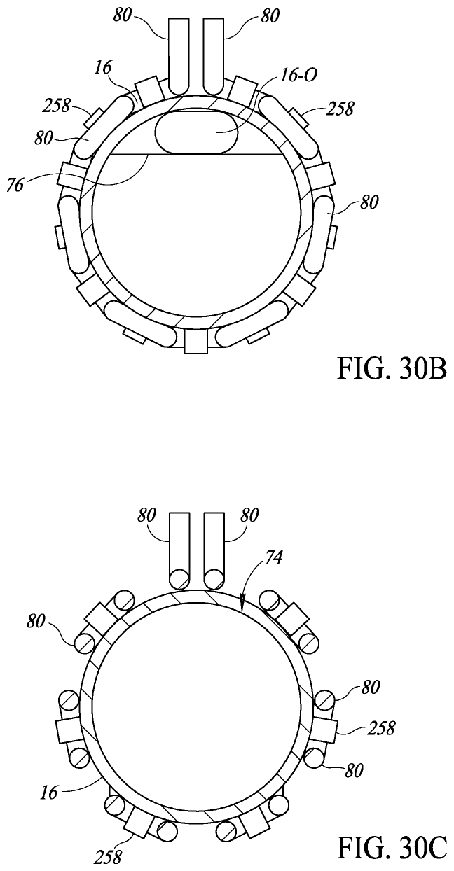

The RWHE may include various patterns as will be discussed with reference to FIGS. 30A, 30B, and 30C. FIG. 30A shows a perspective front view of a portion of heating element 80 for heating the lather generator 16 in accordance with embodiments of the present system. FIG. 30B shows a front view of a portion of the heating element 80 and lather generator 16 in accordance with embodiments of the present system. FIG. 30C shows a cross-sectional view of a portion of the heating elements 80 and lather generator 16 taken along lines 30C-30C of FIG. 30A in accordance with embodiments of the present system.

With reference to FIGS. 30A, 30B, and 30C, the heating elements 80 may be of RWHE type and may extend along at least a portion of the body 74 of the lather generator 16 such as along a longitudinal axis La of the body 74. Guides 258 such as lugs (as shown), studs, flanges, fins, notches, and/or the like may guide the heating element 80 to form a desired pattern. The guides 258 may be discrete as shown and/or may be continuous. The RWHE heating elements 80 may be insulated to form an IRWHE, as may be desired. Further, one or more heating elements 80 may be employed.

It is envisioned that in embodiments of the present system, the heating elements 80 may be coupled to a substrate such as a mesh and in a desired pattern and the combination may be coupled to the lather generator 16. It is further envisioned that the heating elements 80 may be situated within the body 74 of the lather generator 16.

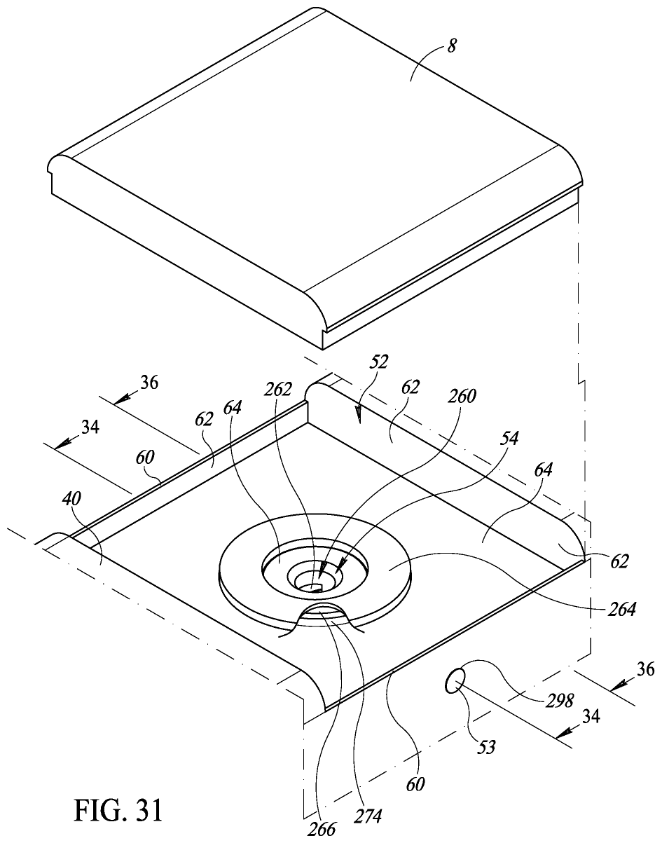

It is envisioned that a mixture cartridge coupling mechanism (MCCM) may be employed to couple the mixture cartridge to the body for use. The MCCM may further employ a mixture cartridge ejector (MCE) such as a passive biasing member (e.g., a coil spring, etc.) and/or an active biasing member (e.g., a cam which may eject the mixture cartridge from coupled position). The cam may be operated by a user (e.g., by depressing a lever) and/or by an actuator. Similarly, the MCCM may be operated passively and/or actively (e.g., by a user and/or by an actuator). These actuators may be operated under the control of the controller and/or a user. Although an MCCM and/or an MCE will be described with reference to FIGS. 31, 32, 33, 34, 35, 36, 37A, 37B, 38, and 39, other MCCMS and/or MCEs are also envisioned.

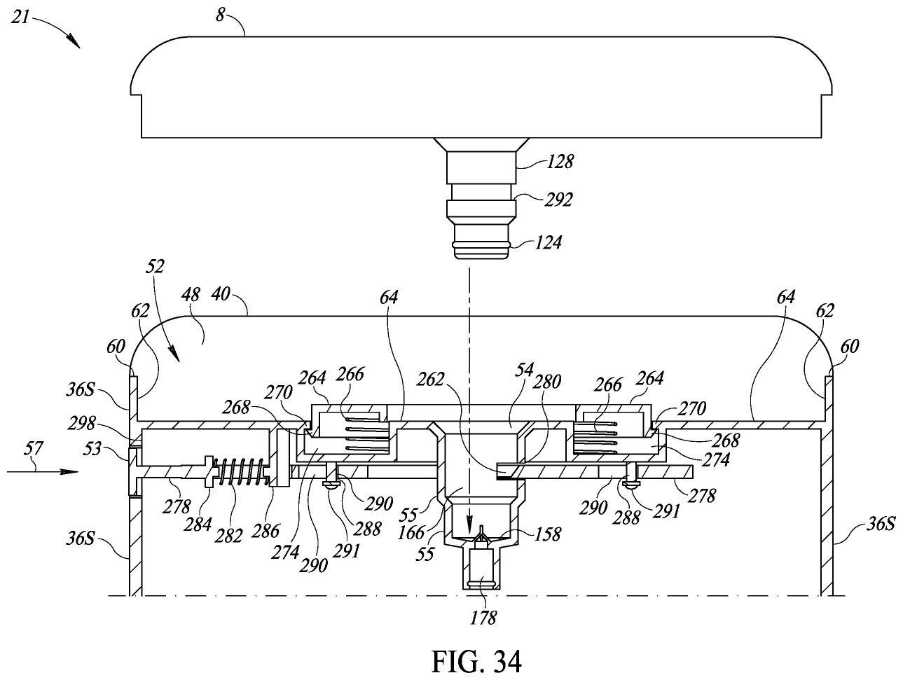

FIG. 31 shows an exploded partially cutaway perspective side view of a portion of the body 40 with an MCCM 260 in accordance with embodiments of the present system. The MCCM 260 may lock the mixture cartridge 8 into its operating position relative to the body 40. Accordingly, the MCCM 260 may include any suitable coupling mechanism such as a mechanical coupling mechanism (e.g., a mechanical latch, etc.) magnetic-type coupling mechanisms (e.g., magnetic and/or electromagnetic), push-to-release-type coupling mechanisms, friction-fit coupling mechanisms, etc. For example, the MCCM 260 may include a latch 262 which may engage a coupler on the mixture cartridge 8 such as a cutout, flange, or notch (e.g., 292, FIG. 34).

A biasing member such as a coil spring 266 (or any other suitable spring or springs) may provide a biasing force to bias the mixture cartridge 8 at least partially away from the floor 64 of the cavity 48 when the latch 262 is disengaged from the coupler of the mixture cartridge 8. The coil spring 266 may be at least partially situated in a spring well 274 formed at the bottom wall 64 and may be at least partially covered by a spring cover 264. The biasing member may be centered about the inlet port 54, however, it would be appreciated that the biasing member may be situated in other locations within the opening 52 or proximate to the opening such that it may provide a biasing force against the mixture cartridge 8. For example, it is envisioned that one or more biasing members may be situated in one or more of the side walls 62. It is further envisioned that the biasing members may be exposed and/or may include other types of biasing members such as wave springs, a leaf springs, etc. It is further envisioned that if two or more biasing members are used, they may be situated adjacent to, or apart from, each other. It is further envisioned that a linkage may couple the mixture cartridge 8 to the biasing member(s) such that the biasing member(s) may provide a biasing force against the mixture cartridge 8. Accordingly, the biasing members may be situated remotely from the opening 52 as may be desired. A release button such as the button 53 may be situated within an opening 298 and may be shaped similarly to the opening 298 but may be sized smaller than the opening 298 such that it may fit within the opening 298.

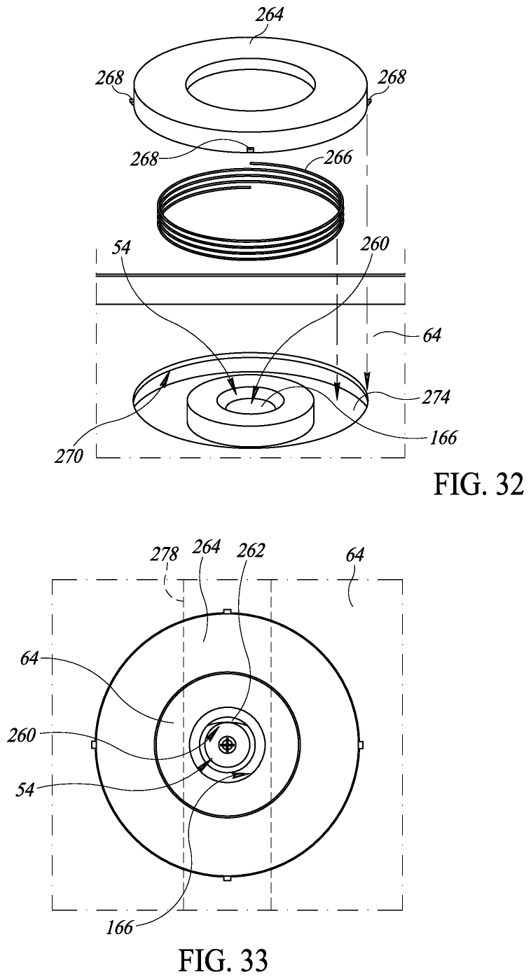

FIG. 32 shows an exploded perspective top view of a portion of the spring cover 264 and MCCM 260 in accordance with embodiments of the present system. The spring cover 264 may lock the coil spring 266 in place within the spring well 274. The spring cover 264 may include one or more tabs 268 which may engage a flange 270 to couple the spring cover 264 to the spring well 274. The coil spring 266 may be in compression when the spring cover 264 is engaged to the flange 270.

FIG. 33 shows a top view of a portion of the inlet port 54 and the MCCM 260 in accordance with embodiments of the present system. The side wall 166 of the inlet port 54 may have an opening configured for the latch 262 to pass therethrough. The latch 262 may be coupled to a release coupler 278. The spring cover 264 may be situated about the inlet port 54.

FIG. 34 shows a partial cross-sectional view of a portion of the lathering system 21 taken along lines 34-34 of FIG. 31 in accordance with embodiments of the present system. The mixture cartridge 8 is shown in side view rather than in cross-section for the sake of clarity. The release coupler 278 may couple the button 53 to the latch 262. It is envisioned that any other suitable methods for coupling the button 53 to the latch 262 are also envisioned such as cables, levers, rods, linkages, etc. which may be controlled by the user and/or controller (e.g., via an actuator controlled by the controller). The latch 262 may extend through an opening 280 of the inlet port housing 55 such that it is at least partially situated within the inlet port 54. The opening 280 may be shaped and/or sized to limit travel of the latch 262 and the button 53 coupled thereto. For example, portions of the latch 262 may contact portions of the opening 280 at a limit of travel of the latch 262. Portions of the latch 262 may extend past an interior periphery of the side wall 166 of the inlet port 54 and may engage a cutout, flange, or notch 292 situated in the outlet port extension 128 of the mixture cartridge 8 so as to retain the mixture cartridge 8 in a desired position relative to the body 40.

The coil spring 282 may provide a biasing force which may act upon the release coupler 278 to bias the latch 262 (in a direction opposite to arrow 57) in a locked position relative to the notch 292 when engaged. The coil spring 282 may be held in position at a first end by a spring mount such as a flange 284 coupled to the release coupler 278 and on a second end by a spring mount such as flange 286.

The release coupler 278 may be slideably coupled to the body 40 using any suitable method. For example, the release coupler 278 may include elongated openings 290 through which supports 288 may pass. Studs, rivets, or screws 291 may be coupled to corresponding supports 288 and prevent the release of the release coupler 278 from the supports 288. In accordance with yet other embodiments, latches formed integrally with the body 40 may slideably couple the release coupler 278 to the body 40.

A length and/or position of the elongated openings 290 may be adjusted to adjust the amount of travel of the coupler 278 relative to the body 40 and the openings 290 and may be configured (e.g., by adjusting length and/or position) to limit travel of the release coupler 278 as may be desired. Plugs or screws 291 may couple to the couplers 288 to slideably couple the release coupler 278 in position relative to the couplers 288. The port extension 128 may include an optional washer 124. It is also envisioned that the optional washer may be coupled to, and situated within, the inlet port housing 54.

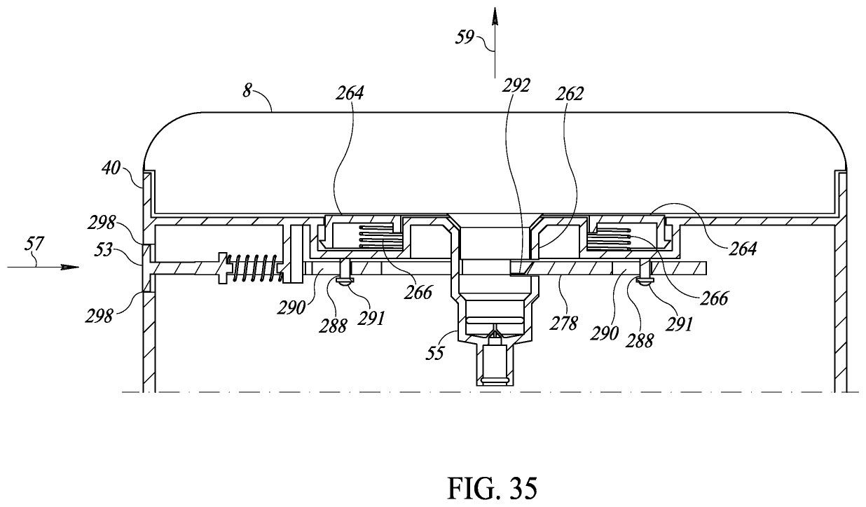

FIG. 35 shows a partial cross-sectional view of a portion of the lathering system of FIG. 34 with the mixture cartridge 8 coupled to the body 40 in accordance with embodiments of the present system. Similarly, to FIG. 34, the mixture cartridge 8 is shown in side view rather than in cross-section for the sake of clarity. The latch 262 may be situated in the lock notch 292 so as to couple the lock notch 292 and hold the mixture cartridge 8 in a substantially locked position relative to the body 40. Further, the mixture cartridge 8 may apply a force upon the spring cover 264 to compress the spring 266 via the spring cover 264. To release the mixture cartridge 8 from the body 40, the button 53 may be depressed in the direction of arrow 57 which may cause the latch 262 to move in the direction of arrow 57 and decouple the latch 262 from the notch 292. Once the latch 262 is decoupled from the notch 292, the spring 266 may then provide a biasing force to at least partially eject the mixture cartridge 8 from the inlet port 54 of the body 40 (e.g., in the direction indicated by arrow 59).

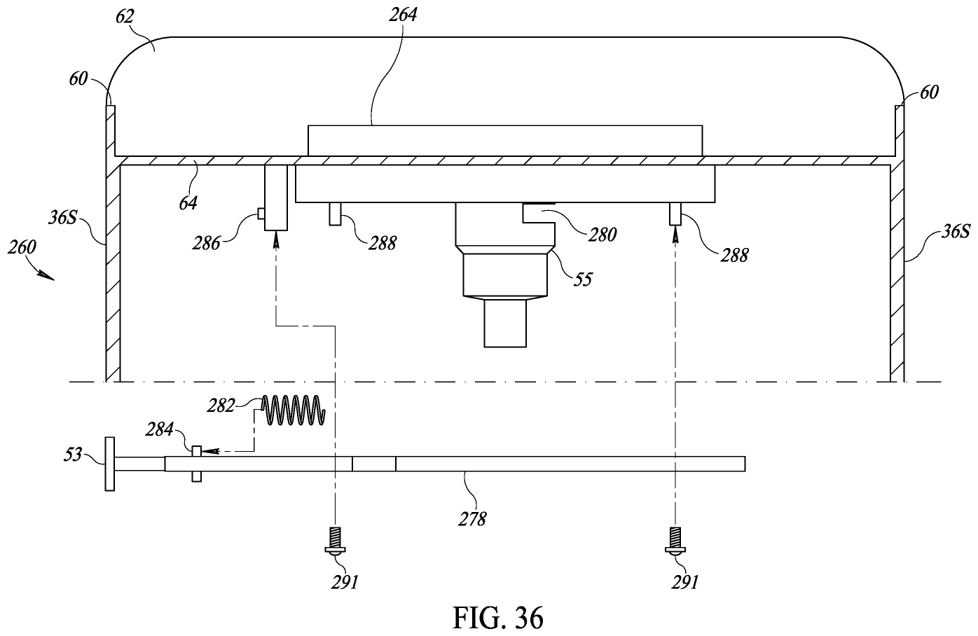

FIG. 36 shows a partial cross-sectional view of a portion of the lathering system 21 taken along lines 36-36 of FIG. 31 in accordance with embodiments of the present system. The opening 280 may be situated within the inlet port housing 55 and may be shaped and sized to provide for the portions of the latch 262 to pass therethrough. Supports 288 may slideably couple the release coupler 278 into position for use and may be configured to limit travel of the release coupler 278. For example, when the button 53 is depressed by a user, one or more of the supports 288 may limit maximum travel of the release coupler 278 and the travel of the release coupler 288 may be limited to two degrees of freedom (e.g., in the direction of arrow 57 and in a direction opposite to that of arrow 57).

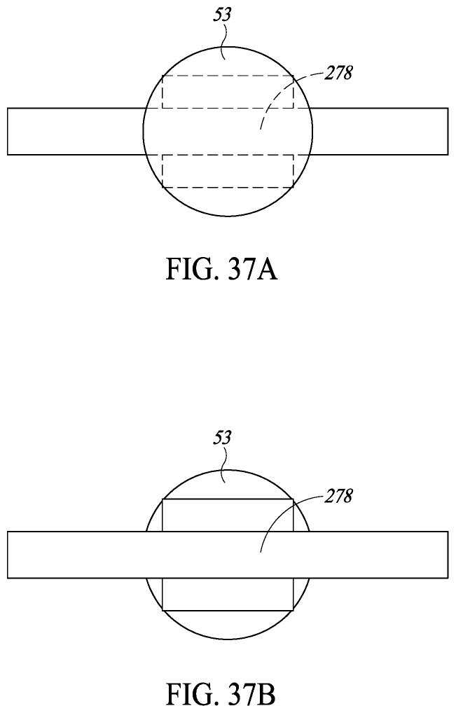

FIG. 37A shows a side view of a portion of the button 53 in accordance with embodiments of the present system. The button 53 may be similarly sized to the release coupler 278 such that either or both may pass through the opening 298 for assembly.

FIG. 37B shows an opposing side view of a portion of the button 53 and the release coupler 278 in accordance with embodiments of the present system.

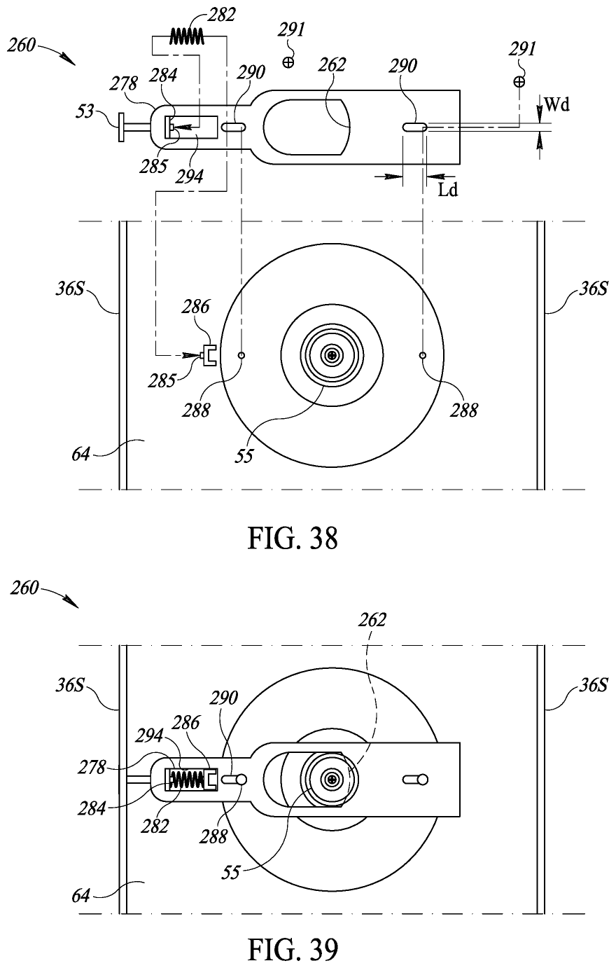

FIG. 38 shows a partial exploded bottom view of a portion of the MCCM 260 in accordance with embodiments of the present system. Spring 282 may fit within opening 294 between flanges 284 and 286. Flanges 284 and 286 may each include a stud 285 projecting from a surface thereof to hold the spring 282 in an operating position. Further, the spring 282 may be held in compression.

FIG. 39 shows a partial bottom view of a portion of the MCCM 260 in accordance with embodiments of the present system. Screws 291 are not shown for the sake of clarity. A width Wd of the elongated openings 290 may be slightly greater than a diameter of the stud 288. A length Ld and/or position of the elongated openings 290 may be vary depending upon desired travel distance relative to the body 40.

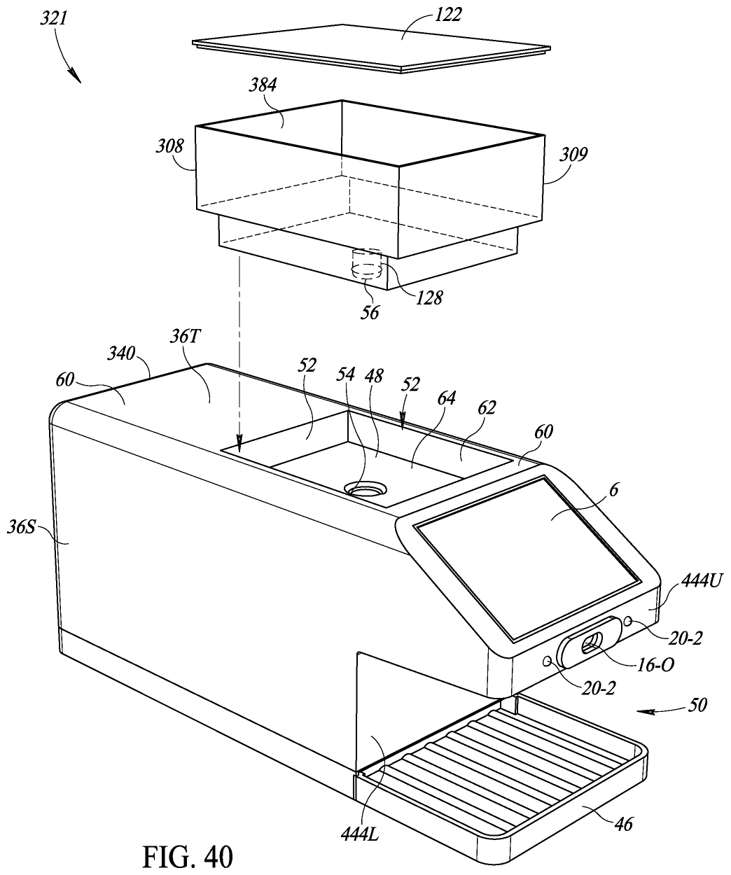

FIG. 40 shows a partial exploded perspective front view of a portion of a lathering system 321 in accordance with embodiments of the present system. The lathering system 321 may be similar to the lathering system 21 and may include a mixture cartridge 308 and a body 340 that may be similar to the mixture cartridge 8 and the body 40, respectively, of the lathering system 21. Accordingly, similar numerals may be used to denote the same or similar portions. The cavity 48 may include the opening 52 and may be configured to receive at least a portion of the mixture cartridge 308 which may be coupled to the body 340.

The mixture cartridge 308 may include a cover 122 which may be removed and/or opened to provide for refilling of a reservoir 384 contained within the mixture cartridge 308. A coupler may be provided to couple the cover 122 to the mixture cartridge 308 using any suitable method. For example, the coupler may include any suitable coupler such as a hinged coupler, a flanged coupler, a friction-type coupler, etc. It is also envisioned that the cover 122 may be removably or fixedly coupled to the mixture cartridge 308 and may include an opening through which fluid, such as the lather mixture, may be added to the reservoir. Additionally, this opening may be configured as a vent to the reservoir 384. For example, a fit of the cover 122 to the reservoir 384 may be non-hermetic such that a pressure within the reservoir 384 may be equalized with an ambient pressure. It is envisioned that the reservoir 384 or cover 122 may include a vent port if desired.

The mixture cartridge 308 may include an outlet port extension 128 which may include an outlet port 56 through which a liquid contained within the reservoir 384 of the mixture cartridge 308, such as a lather solution, may exit and may flow to the inlet port 54.

The cavity 48 may include one or more walls such as saddles 60, side walls 62, and a bottom wall 64 one or more of which may be common with another. For example, portions of the saddles 60 may be formed integrally with the side walls 62 as may be desired. Although the cavity 48 is shown with a square shape, other shapes, such as round, oval, polygonal (e.g., square, rectangular, etc.), are also envisioned. Further, the mixture cartridge 308 may have a size and a shape which may correspond to a shape of the cavity 48.

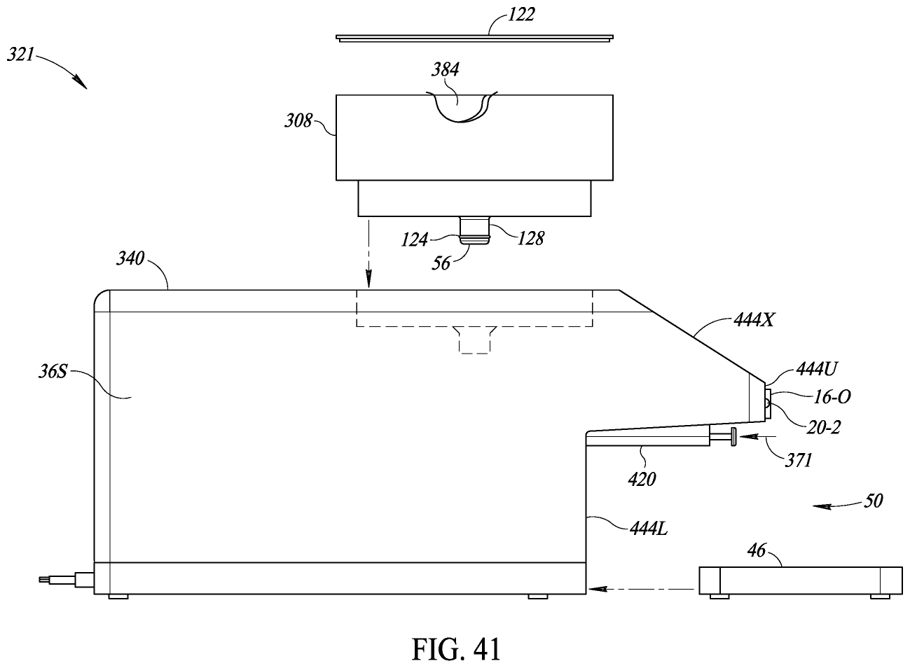

One or more optional proximity sensors 20-2 may be situated in a front wall upper 444U and/or in a front wall lower 444L (generally 444X). It is envisioned that a mechanical sensor such as a switch activated by depressing the mechanical lever may be provided to activate the system 321 to enter a warming mode and/or a dispensing mode to dispense lather. This is illustrated in FIG. 41 which shows a side view of a portion of the lathering system 321 of FIG. 40 in accordance with embodiments of the present system. Switch 420 may be an electromechanical switch and may transmit a signal (which may be conditioned) to a controller of the system to indicate when the switch 420 is depressed (e.g., as indicted by arrow 371). This signal may be indicative of the presence of a user. Upon receiving a signal from the switch 420, the controller may, depending upon a current state enter a warming mode or a dispensing mode. For example, if a current state of the system 321 is a standby mode and the controller receives a signal from the switch 420 (e.g., indicative of a user depressing the switch 420), the controller may begin a warming mode. If it is determined that the system 321 is in a warming mode or in a ready mode, and the controller receives a signal from the switch 420, the controller may decide to begin a lather dispensing mode in which it may dispense lather as long as the switch 420 continues to be depressed.

Although the switch 420 is depicted as a linear push-type switch, other types of switches are also envisioned and it not critical to the invention. It is further envisioned that the switch 420 may be electronically and/or mechanically coupled to the valve which controls flow from the reservoir to the lather generator (e.g., see FIG. 1, valve 12) to open and/or close the valve which may control the flow of liquid such as the lather mixture from the reservoir 384 (e.g., FIG. 4, valve 12). A suitable mechanical coupling may include one or more rods, levers, and/or cables configured to provide a force from the switch 420 (e.g., when depressed) to open the valve. It is further envisioned that the position, orientation, and/or location of the switch 420 may be adjustable by the user as may desired.

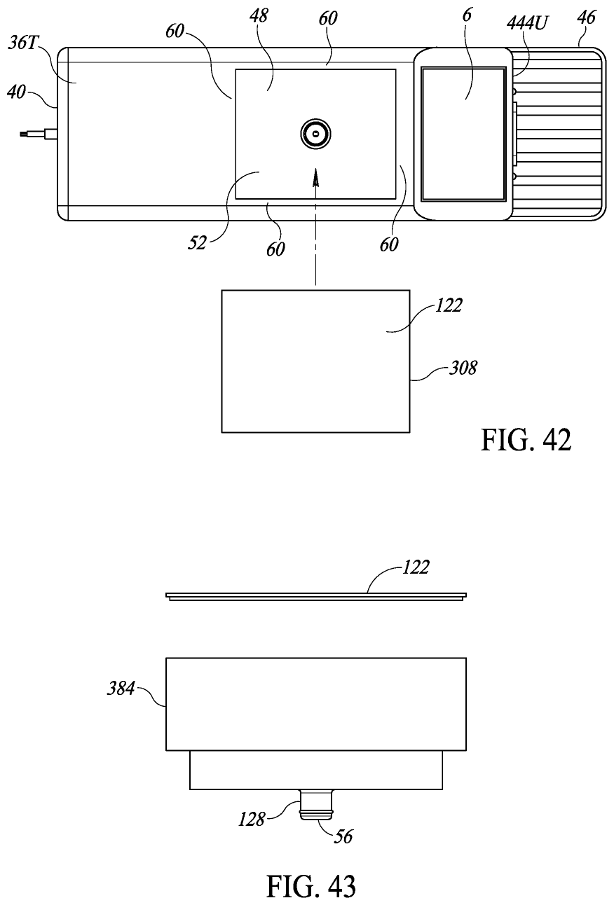

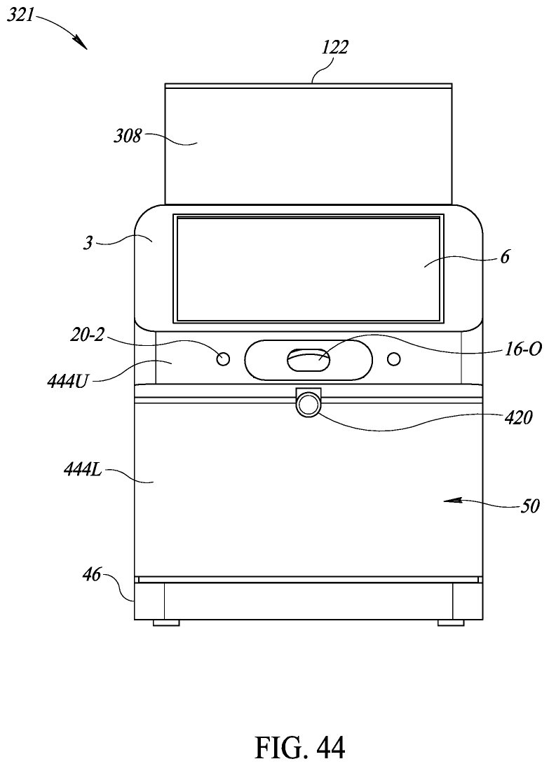

FIG. 42 shows an exploded top view of a portion of a lathering system 321 of FIG. 40 in accordance with embodiments of the present system. FIG. 43 shows a side view of a portion of the mixture cartridge 308 of the lathering system 321 of FIG. 40 in accordance with embodiments of the present system. FIG. 44 shows a front view of a portion of the lathering system 321 of FIG. 40 in accordance with embodiments of the present system. The back and bottom of the lathering system 321 may be similar to the back and bottom, respectively, of the lathering system 21 shown in FIG. 22 and FIG. 25, respectively.

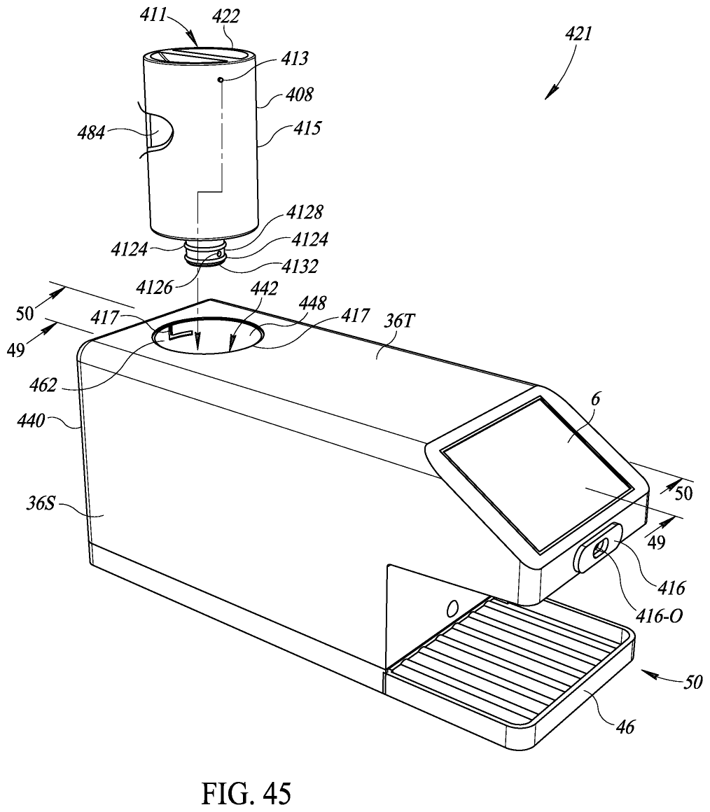

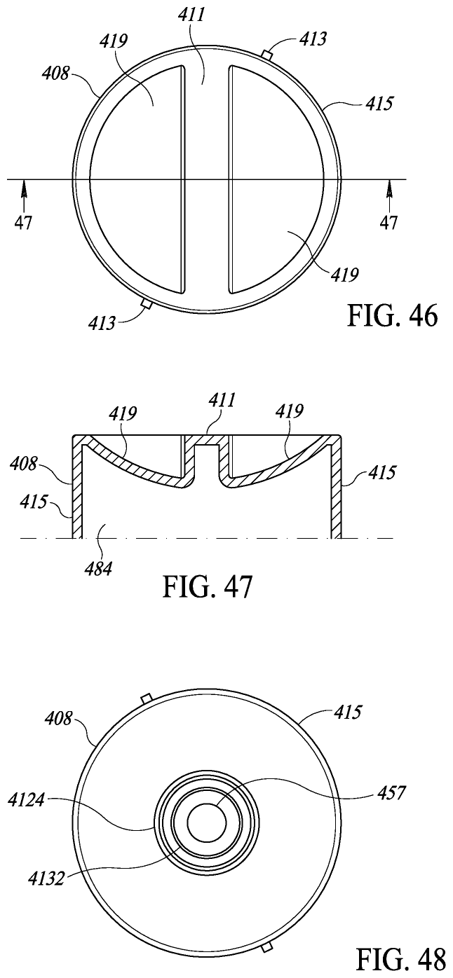

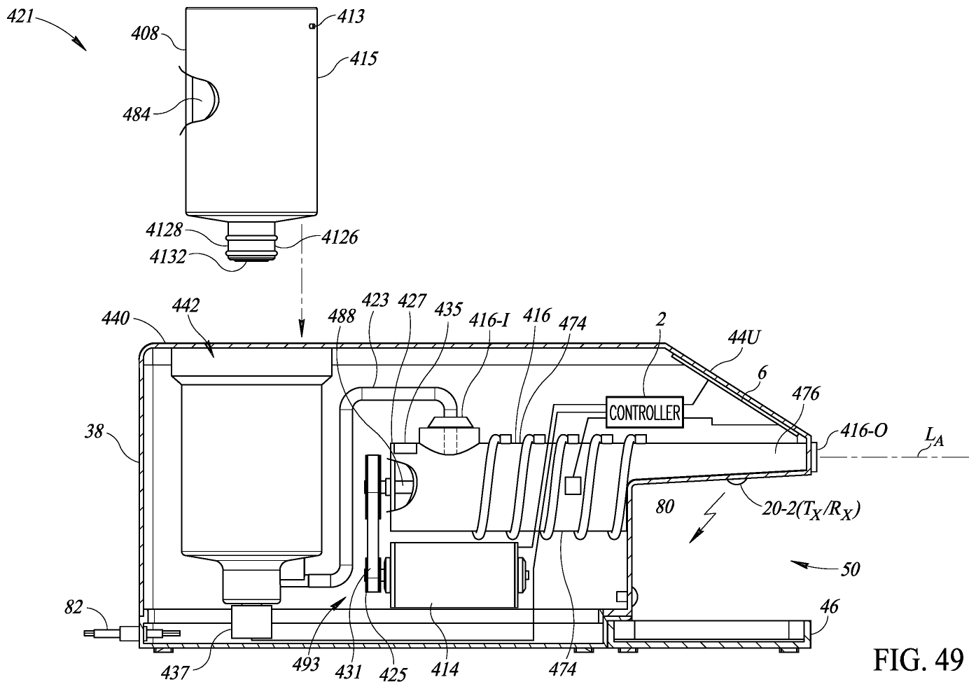

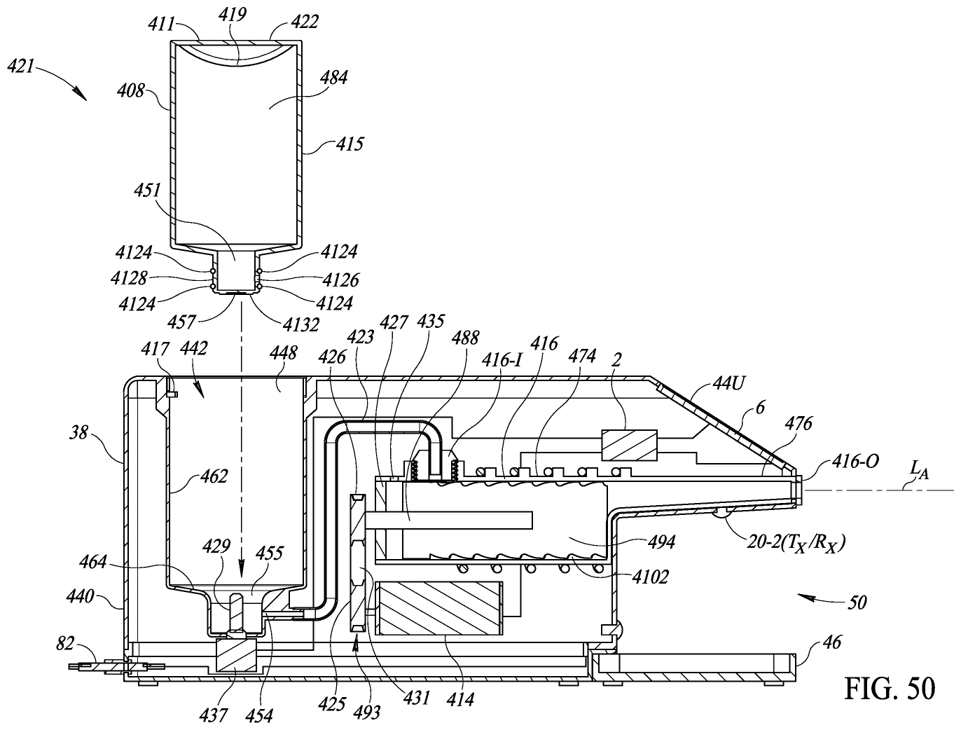

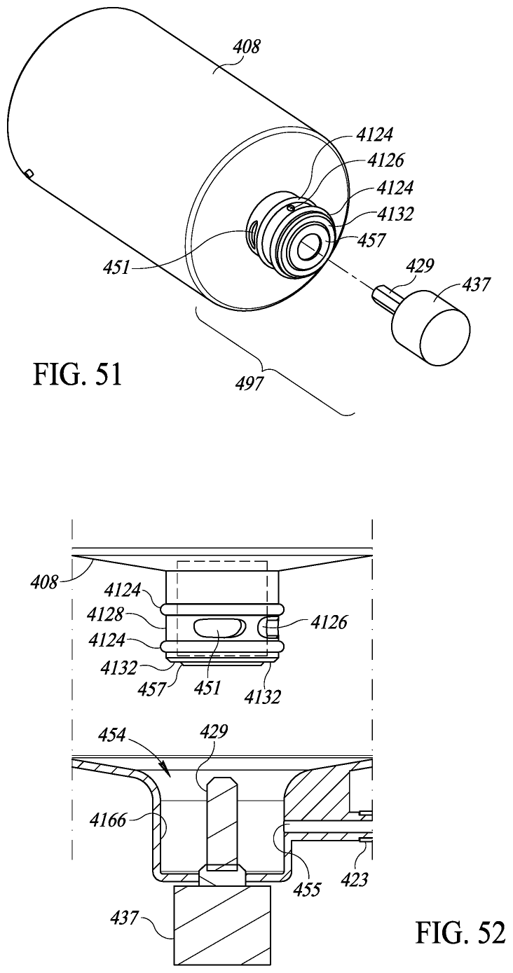

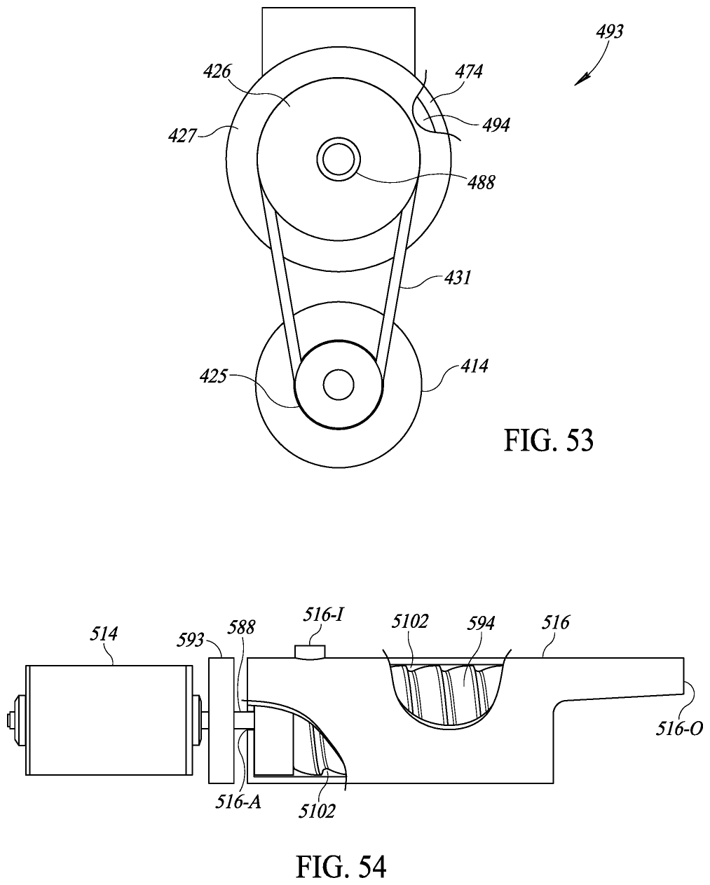

A lather system with a pump configured to pump liquid such as a lather mixture from a reservoir of a mixture cartridge to in inlet of the lather generator will now be discussed with reference to FIGS. 45, 46, 47, 48, 49, 50, 51, 52, and 53. FIG. 45 shows a partial cutaway exploded perspective front view of a portion of a lathering system 421 in accordance with embodiments of the present system. FIG. 46 shows a top view of a mixture cartridge 408 of the lathering system 421 in accordance with embodiments of the present system. FIG. 47 shows a cross-sectional view of a portion of the mixture cartridge 408 taken along lines 47-47 of FIG. 46 in accordance with embodiments of the present system. FIG. 48 shows a bottom view of the mixture cartridge 408 of the lathering system 421 in accordance with embodiments of the present system. FIG. 49 shows a partially cutaway cross-sectional view of a portion of the lathering system 421 taken along lines 49-49 of FIG. 45 in accordance with embodiments of the present system. FIG. 50 shows a cross-sectional view of a portion of the lathering system 421 taken along lines 50-50 of FIG. 45 in accordance with embodiments of the present system. FIG. 51 shows a detailed partially cutaway bottom perspective view of a portion of the mixture cartridge 408 and a motor 437 of the lathering system 421 in accordance with embodiments of the present system. FIG. 52 shows a detailed partially cutaway cross-sectional view of a portion of the mixture cartridge 408 and the motor 437 of the lathering system 421 in accordance with embodiments of the present system. FIG. 53 shows an end view of a belt drive system 493 of the lather system 421 in accordance with embodiments of the present system.

With reference to FIGS. 45, 46, 47, 48, 49, and 50, the lathering system 421 may be similar to the lathering system 21 and may include a mixture cartridge 408 and a body 440 that may be similar to the mixture cartridge 8 and the body 40, respectively, of the lathering system 21. Accordingly, similar numerals may be used to denote the same or similar portions. It is envisioned that the system 421 may include a pump assembly 497 including a pump cartridge 451 and the motor 437 configured to drive the pump cartridge 451 to pump liquid from a reservoir 484 of the mixture cartridge 408 to an inlet 416-I of a lather generator 416. The system 421 may also include a belt drive system 493 for coupling an LGS 494 of a lather generator 416 to a motor 414 for driving the LGS 494 via a belt 431 and an intermediate shaft 488.

The mixture cartridge 408 may be configured to fit within a cavity 448 of the body 440. The cavity 448 may include the opening 442 and may be configured to receive at least a portion of the mixture cartridge 408 which may be coupled to the body 440 for use. The mixture cartridge 408 may include a wall 415 which may define at least part of a cavity in which a reservoir 484 may be situated. The mixture cartridge 408 may be coupled to the body 440 using any suitable coupler. For example, suitable couplers may include friction fits, screw fits, bayonet mounts, magnetic coupling, etc. For example, the couplers may include a bayonet mount having flanges 413 which may be configured to engage with, and lock within, guide slots 417 of the body 440. Accordingly, a user may slide the mixture cartridge 408 into the body 440 and may twist the mixture cartridge 408 to lock it into place relative to the body 440. Similarly, a user may twist the mixture cartridge 408 in an opposite direction and pull upward on the mixture cartridge 408 to remove it from the body 440. It is also envisioned that the an auto locking mechanism may be provided. If it further envisioned that the mixture cartridge 408 may be slid into place and may employ a friction coupler to couple the mixture cartridge 408 to one or more portions of the body 440.

With reference to FIGS. 45, 46, and 47, the mixture cartridge 408 may include a handle 411 which may be situated on a cover 422 of the mixture cartridge 408 and may be configured to be grasped by a user to insert, lock, unlock, and/or remove the mixture cartridge 408 from the body 440. The cover 422 may include channels 419 situated on either side thereof of the handle 411 to enable a user to better grasp the handle 411.

The cavity 448 may include one or more walls such as a side wall 462 and/or a bottom wall 464, one or more of which may be common with one another. For example, portions of the bottom wall 464 may be formed integrally with the side wall 462 and vice versa as may be desired. Although the cavity 448 is shown with a cylindrical shape when viewed from above, other shapes, such as polygonal, elliptical, square, rectangular, etc. are also envisioned. The mixture cartridge 408 may be configured to have a size and a shape which may correspond to a shape of the cavity 448.

The mixture cartridge 408 may have an outlet port extension 4128 having a distal end 4132 and an outlet port 4126 the latter of which may be fluidly coupled to an inlet port 454 of an inlet port well 455 when the mixture cartridge 408 is coupled to the body 440. One or more seals such as washers 4124 may be situated on either side of the outlet port 4126 and may be configured to fluidically seal the outlet port 4126 to a wall 4166 of the inlet port well 454 so that liquid pumped from the outlet port 4126 may enter the inlet port well 454. The mixture cartridge 408 may include a vent port to vent the cavity within to atmospheric pressure. Further, the reservoir 484 may be situated at least in part within a bag (e.g., a polymer bag, an aluminum bag, etc.) situated within the cavity of the mixture cartridge 408. An opening of this bag may be coupled to an inlet of the pump cartridge 451. This bag may collapse as fluid is pumped from the reservoir. In accordance with some embodiments of the present system if a bag is not used, the reservoir 484 may be in fluid communication with the inlet of the pump cartridge 451.

The lather generator 416 may have a body 474 forming a cylinder defining an interior cavity 4102 with the LGS 494 situated therein for generating a lather. The body 474 of the lather generator 416 may be substantially situated between a bearing block 427 and an extension 476 having an outlet 416-O from which lather generated by the lather generator 416 is output. The body 474 of the lather generator 416 may include a vent 435 configured to provide for the passage of ambient air to the interior cavity 4102. It is further envisioned that the body 474 of the lather generator 416 may include an inlet 416-I configured to receive a fluid such as the lather mixture and to provide this fluid to the interior cavity 4102 wherein this fluid may be turned into a lather and thereafter output at the outlet 416-O for use by a user.

The bearing block 427 may be coupled to the body 474 of the lather generator 416 using any suitable method such as a screw fit, a bayonet mount, a friction fit, adhesives, bonds, etc. The bearing block 427 may rotatably support an intermediate shaft 488 which extends into the interior cavity 4102 of the body 474. The LGS 494 may be coupled to the intermediate shaft 488 and may be situated with the interior cavity 4102.

A motor 414 may be coupled to, and drive, the intermediate shaft 488 using any suitable coupling such as a direct drive, a gear drive, a friction drive, and/or the belt drive system 493 as shown. For example, the motor 414 may be coupled to the intermediate shaft 488 using a belt drive in which a belt 431 extends about pulleys 425 and 429, wherein pulley 425 is coupled to an output shaft of the motor 411 and pulley 429 is coupled to the intermediate shaft 488. A belt tension system may be provided to tension the belt as may be desired. Accordingly, the motor 414 may drive the LGS 494 to rotate within the interior cavity 4102 of the lather generator 416 so that the LGS 494 may operate on the lather mixture to generate lather. The sizes of the pulleys 425 and 429 may be varied to change drive ratios as may be desired.

A conduit 423 such as a pipe, a tube, a hose, etc., may fluidly couple the inlet port 455 to inlet 416-I of the lather generator 416. Accordingly, the lather generator 416 may receive a liquid, such as the lather solution, at its inlet 416-I and may operate on this lather solution to build it into a lather which may then be output at the outlet 416-0. The lather generator 416 may be driven by the motor 414 under the control of the controller 2.

The system 421 may include a pump assembly 497 including a pump cartridge 451 and the motor 437 configured to drive the pump

The pump assembly 497 may be configured to pump fluid from the reservoir 484 of the mixture cartridge 408 to the inlet 416-O of the lather generator 416 under the control of the controller 2. More particularly, the motor 437 may have an output shaft 429 which may be configured to couple to an input shaft 457 of the pump cartridge 451 (hereinafter pump cartridge which may include a pump head) to drive the pump cartridge to pump liquid such as the lather mixture contained within the reservoir 484 of the mixture cartridge 408. The output shaft 429 and the input shaft 457 may be correspondingly keyed to prevent slipping when coupled together. Accordingly, the input shaft 457 may be sized and shaped (e.g., keyed if necessary) to receive the input shaft 429. Suitable pumps may include centrifugal pumps, gear pumps, gerotor pumps, peristaltic pumps, screw pumps, trochoid pumps, vane pumps, worm pumps, piston pumps, and the like. The type and size of pump may depend upon an amount of flow of the liquid desired. Suitable pump may include a single-use cartridge-type pump or the like such as the Vernay Q-Series pumps manufactured by Vernay Manufacturing, Griffin, Ga. and/or by the Quantex Arc Ltd., London, UK.

When the mixture cartridge 408 is coupled to the body 440, the outlet 4126 may be fluidically coupled to the inlet port 454, and the input shaft 457 of the pump cartridge 451 may be coupled to the output shaft 429 of the motor 437. Accordingly, the motor 437 may drive the pump cartridge 451 to pump liquid from the reservoir 484 to an outlet 4126 of the mixture cartridge 408 fluidically coupled thereto and thereafter to the inlet port 454.

An input of the pump cartridge 451 may be fluidically coupled to the reservoir 484 to receive liquid contained within the reservoir 484 and an outlet of the pump cartridge 451 may be coupled to the outlet 4126 of the mixture cartridge 408.

A benefit of certain pumps, such as some peristaltic pumps and the Q-Series™ pumps, is that they may act as a shut off valve and prevent the flow of liquid from escaping from the reservoir 484 when not in use. Accordingly, additional flow control devices such as valves and the like to prevent the flow of liquid from the reservoir 484 when the liquid is not being pumped may not be necessary. It is envisioned that embodiments of the present system may include flow control devices which may be operate under the control of the controller 2.

The motor 437 may operate under the control of the controller 2. For example, speed of the output shaft 429 of the motor (e.g., the speed of the motor) driving the pump cartridge 451 such as the motor 437 may be held substantially constant for a substantially fixed flow rate or may be varied to vary the flow rate of the liquid pumped by the pump cartridge 451 such as the lather mixture. The system 421 may provide an interface (mechanical or electronic) with which a user may interact with the system to adjust the speed of the motor 437. Further, user settings for the speed of the motor 437 may be stored in a memory of the system such as USI in association with the user for later use. Moreover, the system may include a slow start in which the speed of the motor 437 may be ramped up during use. This may enable the system to control the flow rate of the pump cartridge 451 in accordance with system and/or user settings.

It is also envisioned that the pump cartridge 451 may be coupled to the output shaft 429 or any other shafts driven by a motor of the system.

The intermediate shaft 488 may be driven (directly or indirectly (e.g., via a transmission) by the motor 414 and/or by the motor 437. This transmission may include any suitable type of transmission (e.g., belt driven, gear driven) and may be of a fixed, multiple and/or variable ratio types. If multiple or variable ratio type transmissions are employed, the gear ratios may be varied by the controller 2, a user, and/or by a transmission controller. Thus, an output shaft of the motor 414 may drive an input shaft of the transmission and an output shaft of the transmission may drive an input shaft of the pump cartridge 451. Then the flow rate of the pump cartridge 451 may be varied by controlling the gear ratio of the transmission even if the speed of the output shaft of the motor driving the pump cartridge 451 is substantially constant.

It is envisioned that in embodiments of the present system the mixture cartridge may include a collapsible mixture cartridge that may collapse when fluid is pumped therefrom. It is further envisioned that the fluid pump may be formed integrally with portions of the mixture cartridge. It is also envisioned that the fluid pump may be coupled to the mixture cartridge by a user. It is further envisioned that the fluid pump may be part of the mixture cartridge and/or body of the lathering system. It is further envisioned that the mixture cartridge may be mounted in a horizontal position as may be desired. Moreover, it is envisioned that pump assembly may be situated within the body and a replaceable mixture cartridge may be coupled to the pump assembly when the mixture cartridge is coupled to the body.

Several methods of coupling a motor to an LGS of the system will now be discussed with reference to FIGS. 54, 55A, 55B, and 56. FIG. 54 shows a portion of a partially cutaway side view of a motor 514 coupled to a lather generator 516 via a transmission 593 in accordance with embodiments of the present system. The lather generator 516 may include an inlet 516-I for receiving a liquid such as a lather mixture, an opening 516-A through which an interior cavity 5102 of the lather generator 516 may receive air, and an outlet 516-O through which a lather solution may exit the lather generator 516. Intermediate shaft 588 may be coupled to an output of the transmission 593 and may support an LGS 594 situated with the interior cavity 5102. The transmission 593 may be of any type. For example, the transmission 593 may be of a planetary gear type. In accordance with yet other embodiments, other types of transmissions are also envisioned.

This configuration may provide for a preferred rotation speed of the LGS 594 during use while maintaining an optimum speed for the motor 514. The opening 516-A may be situated to prevent the spillage of liquid from the interior cavity 5102 as may be desired. In yet other embodiments is envisioned that one or more openings may be provided to provide for the flow of excess liquid from the interior cavity 5102 as may be desired. These excess liquids may be drained to a desired container such as the drip tray via one or more defined paths as may be desired.

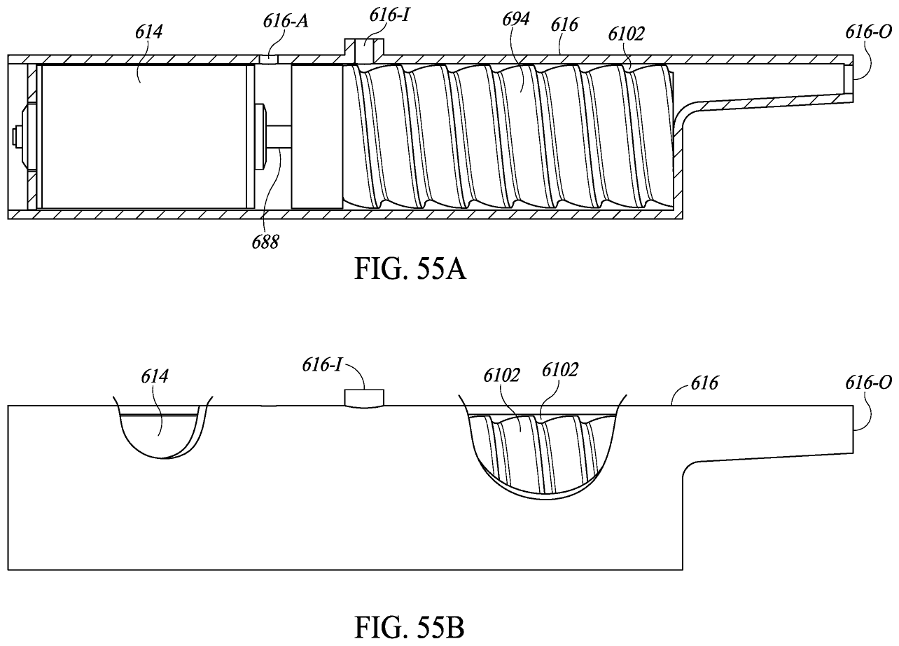

It is also envisioned that the motor may be situated within a cavity of the lather generator. For example, FIG. 55A shows a portion of a cross sectional side view of a motor 614 situated within a cavity 6102 of a lather generator 616 in accordance with embodiments of the present system; and FIG. 55B shows a partially cutaway side view of a portion of the lather generator 616 of FIG. 55A in accordance with embodiments of the present system. With reference to FIG. 55A and FIG. 55B, the lather generator 616 may include an inlet 616-I for receiving a liquid such as a lather mixture, an opening 616-A for receiving air to the interior cavity 6102, an LGS 694, and an outlet 616-0 through which a lather solution may exit the lather generator 616. The LGS 694 may be coupled to a shaft 688 which may be driven by the motor 614. The motor 614 may be fully or partially situated within the cavity 6102 of the lather generator 616. It is further envisioned that the motor 614 may be situated adjacent to the lather generator 616. It is further envisioned that the motor may be situated on either side (e.g., front as opposed to rear as shown) of the LGS 694. For example, it is envisioned that the motor may be situated under an extension of the lather generator and may drive the LGS. It is further envisioned that the LGS 694 may be coupled to the motor 614 via a transmission.

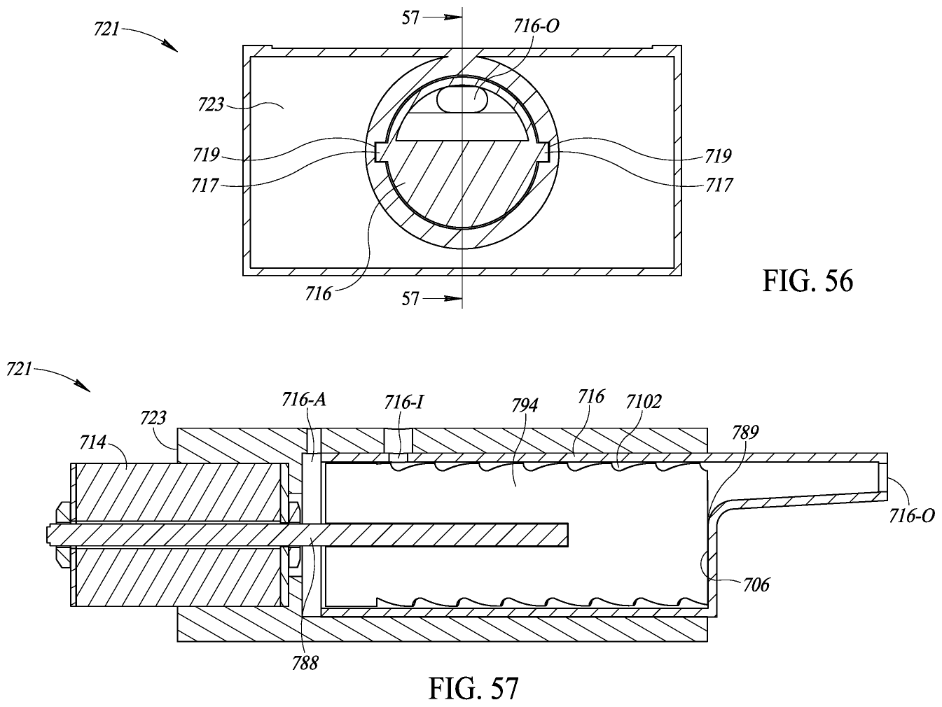

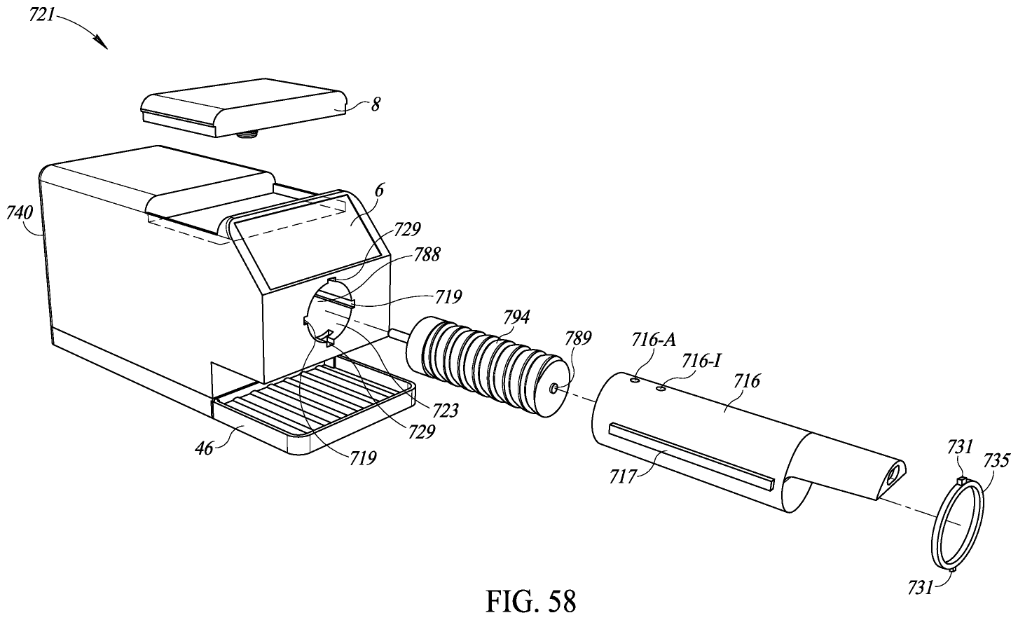

It is envisioned that embodiments of the present system may include a removable lather generator which may be easily removed from a body and a motor which may be coupled thereto. Such embodiments will be described with reference to FIGS. 56, 57, and 58. In particular, FIG. 56 shows a front view of a portion of a lather generator 616 coupled to a carrier 723 of a lathering system 721 in accordance with embodiments of the present system. FIG. 57 shows a cross-sectional view of a portion of the lathering system 721 taken along lines 57-57 of FIG. 56 in accordance with embodiments of the present system. FIG. 58 shows an exploded front perspective view of a portion of the lathering system 721 of FIG. 56 in accordance with embodiments of the present system.

With reference to FIGS. 56 and 57, the carrier 723 may include one or more slots 719 which may be configured to receive corresponding rails 717 of a lather generator 706. The lather generator 716 may include an opening 716-A for venting an interior to atmospheric pressure, an inlet 716-I for receiving a liquid such as a lather mixture, and an outlet 716-O through which a lather may be output. A motor 714 may be coupled to the carrier 723 and may drive a shaft 788 which may support an LGS 794 situated within a cavity 7102 of the lather generator 716. Openings in the carrier 723 may be coupled to corresponding openings of the lather generator 716 such as the opening 716-A and the inlet 716-I to provide for ambient air and the liquid (such as the lather mixture), respectively, to pass therethrough when the lather generator 716 is coupled to the carrier 723. Accordingly, inlet 716-I may be coupled to a reservoir in which the liquid is stored via the corresponding opening of the carrier 723.

Although the LGS 794 is shown supported on a drive shaft 788 of the motor 714 such as shaft 788, it is envisioned that the LGS 794 may be supported by an intermediate shaft as well depending upon design. It is envisioned that the LGS 794 may be fixedly or removably coupled to the shaft 788. For example, the shaft 788 and the LGS 794 may be keyed to couple together and the LGS 794 may be contained within the cavity 7102 by an end wall 706 of the lather generator 716. A bearing such as a low-friction bearing 789, formed from any suitable material or materials (e.g., a polymer bearing such as Teflon or the like although other materials are also envisioned), may be situated between the end wall 706 of the lather generator 716 and an adjacent wall of the LGS 794. In yet other embodiments, it is envisioned that the LGS 794 may be removably coupled to the shaft 788 using any suitable coupler such as a pin, a threaded coupler, etc. and may be removed for cleaning when the coupler is decoupled, removed, or otherwise opened. Thus, the LGS 794 may be easily removed from the shaft 788 for cleaning, service, etc. once the lather generator 716 has been removed from the carrier 723.

With reference to FIG. 58, the lathering system 721 may be similar to the lathering system 21 and may include a body 740 configured to receive a mixture cartridge 8 and having a display 6, a tray 46, the carrier 723, a motor (e.g., the motor 714), the LGS 794, and the lather generator 716. The lather generator 716 may be removably coupled to the carrier 723 using any suitable method such as latches, studs, screws, bayonet mounts, etc. For example, a bayonet-type coupler may include a lock ring 735 which may extend about the lather generator 723 and may include one or more radially extending pins 731 which may engage slots 729 in the carrier 723 and turn to lock and engage the carrier 723 in a bayonet manner for coupling. Other coupling methods such as threaded couplers, friction couplers, pin couplers, etc., are also envisioned in other embodiments.

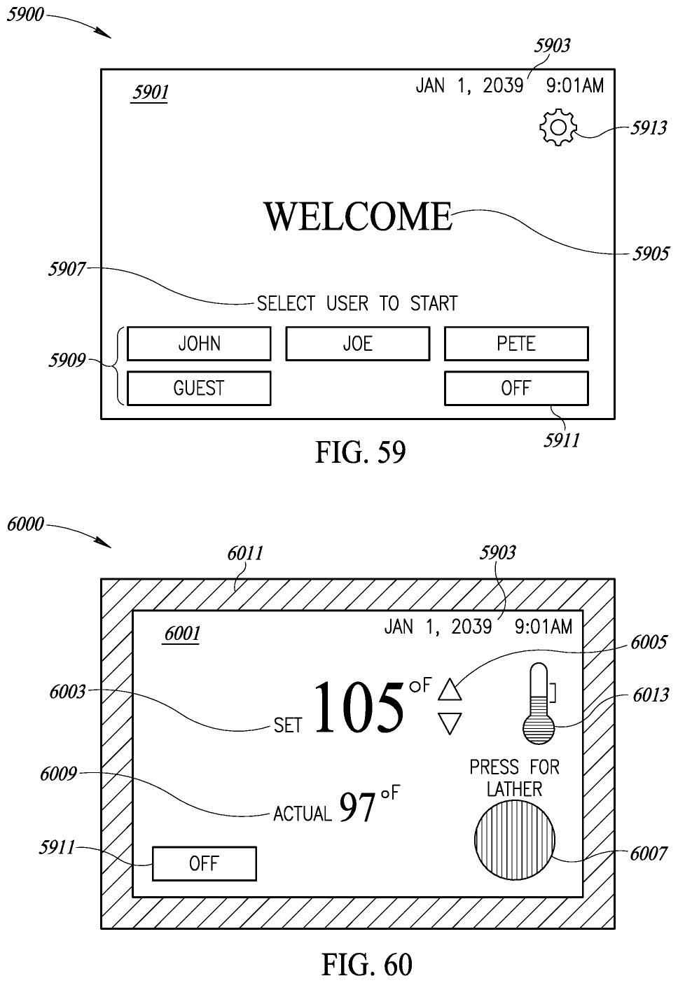

FIG. 59 shows a screen shot 5900 of a portion of a start screen 5901 rendered by a lather system in accordance with embodiments of the present system. Depending upon system settings and configuration, the screen 5901 may be generated upon turning on or entering a standby mode (e.g., upon waking up from a sleep mode) or may remain on constantly in a low-power mode and may be referred to as a start screen 5901. For example, a user may touch a blank screen during a sleep-mode or low-power mode and the system may then sense this input and may then generate and render the start screen 5901.

Screen 5901 may be configurable by a user and/or the system and may include a date area 5903, a message area 5905, an instruction area 5907, user selection item(s) 5909, an off or exit selection item 5911, and a settings selection item 5913. The date area 5903 may include information such as a current day, date and/or time. The message area 5905 may include a message selected from the memory of the system such as “WELCOME” or other message as may be set by the system and/or user and stored in a memory of the system. The instruction area 5907 which may render instructions for use such as “SELECT USER TO START” or “TOUCH TO START.” These instructions may be obtained from a memory of the system and may be mapped to specific operative steps as may be defined by the system and/or user and stored in a memory of the system. The user selection item(s) 5909 may include a selection item for each registered user of the system and each of these selection items may include a name of a corresponding user such as “JOHN,” “JOE,” “PETE,” “GUEST,” etc. in the current embodiment. Selection of one of the user selection items 5909 may be sensed by a controller of the system and the controller may obtain stored settings for the corresponding user from a memory of the system such as USI for the corresponding user. Thereafter, the controller may set settings of the lather system in accordance with USI for the corresponding user. For example, the system may set the temperature setting for the lather generator in accordance with the USI for the corresponding user. The system may further detect changes a user may make to the system and update the USI accordingly. For example, a user may enter a new desired temperature setting during use of the system and the system may update (e.g., by changing) the corresponding setting in accordance with the setting entered by the user rather than the stored setting after confirming with the user and may update the USI accordingly.

With regard to the off or exit selection item 5911, when this selection item is selected by the user, the system may go into an off mode or a sleep mode (depending upon system settings).

With regard to the settings selection item 5913, when this selection item is selected, the system may generate a settings screen for the system. The settings screen may include a plurality of system settings and/or settings for the corresponding user. Information related to these settings may be stored in the USI for the corresponding user. Once a registered user is selected by the user, the system may, depending upon settings, enter a warming mode as may be described with reference to screens 6001 and 6017 discussed below.

If the system is set to only a single user or no registered user, the system may skip the start screen 5901 and immediately go to a working screen such as shown in screens 6001 and 6017 discussed below or any other screen as may set by the system and/or user.

FIG. 60 shows a screen shot 6000 of a portion of an operating mode screen 6001 rendered by a lather system in accordance with embodiments of the present system. The operating mode screen 6001 may be rendered by the system upon entering a warming mode. This screen may be selected for use by a user and/or the system as a default operating screen and may include set temperature information area 6003, actual temperature information area 6009, set temperature selection items such as arrows 6005, a lather selection item 6007, a ready indicator 6011, and a temperature graphic 6013.

The set temperature information 6003 may indicate a temperature that was previously set and/or selected by the system and/or user. For example, if during previous operation (e.g., during previous operation in the operating mode) before the system went to sleep, the user selected a new set temperature, then the controller may then store this setting in a memory of the system and may recall this temperature upon entering the current operating mode. Depending upon system settings, the system may select a default temperature and/or a user selected temperature. For example, when the system is shut or otherwise reset, the system may revert to a default stored temperature setting.

The actual temperature information 6009 may be indicative of the actual (e.g., current) temperature of a lather generator as may be sensed by one or more temperature sensors (e.g., 20-1) of the present system.

The set temperature selection items such as arrows 6005 may be selected by a user to increase or decrease the set temperature information to change the set temperature information. The system may then update and render the set temperature information 6003 that has been updated. The system may further provide a user with an option to have this new set temperature as a default set temperature or to cancel this new set temperature once lather is dispensed by the system during the current use.

Although embodiments of the present system may enter a lather dispense mode and dispense lather using passive sensors such as the proximity sensor, it will be appreciated that embodiments of the present system may provide a user interface (UI) with which a user may select a selection item or enter a gesture to cause the system to dispense lather.

For example, with regard to the lather generation selection item 6007, this selection item may be selected to request lather. Accordingly, when it is determined that that a lather generation selection item has been selected, the controller may be operative to enter a lather dispensing mode (LDM) in which it may be operative to engage one or more actuators to open valves which may control a flow of liquid, such as the lather mixture, from the reservoir to the inlet of the lather generator (e.g., 16-I) and/or may be operative to operate one or more motors coupled to pumps to pump liquid, such as the lather mixture, from the reservoir to the inlet of the lather generator (e.g., 16-I). The controller may further be operative to engage the motor (e.g., 14) and the actuator and/or fluid pump. The controller may further be active to engage a motor which drives an LGS to generate lather from the liquid (e.g., lather mixture) within the lather generator.

The ready indicator 6011 may be rendered by the system to indicate a status of the lather generator with regard to set and actual temperatures. For example, the system may compare the set temperature with the actual temperature. Accordingly, if the set temperature is determined to be greater than the actual temperature, the system may determine that the system is not ready and may generate information indicative of such and render this information using the ready indicator 6011. For example, when it is determined that the system is not ready, the system may render yellow (or any other desired color) in the ready indicator 6011 which may be formed as a frame about an outer periphery of the screen 6001. In yet other embodiments, other types of ready indicators such as an illuminated ring situated about the at the front upper wall or a lighted ring about or at an output of the lather generator (e.g., 106-O) may be employed. Conversely, if the set temperature is determined to be less than or equal to than the actual temperature, the system may determine that the system is ready and may generate information indicative of such. For example, when it is determined that the system is unready, the system may render the ready indicator using a color such as green for example. The system may adjust or otherwise vary the brightness and/or color in accordance with USI and/or system settings of the ready indicator to indicate various status of the system.

The temperature graphic 6013 may be generated and rendered by the system to provide a graphical representation of the set temperature. A thermometer may be filled corresponding to the temperature. Thus, if the set temperature is increased, the thermometer fill may increase accordingly. Conversely, if the set temperature is decreased, the thermometer fill may decrease accordingly.

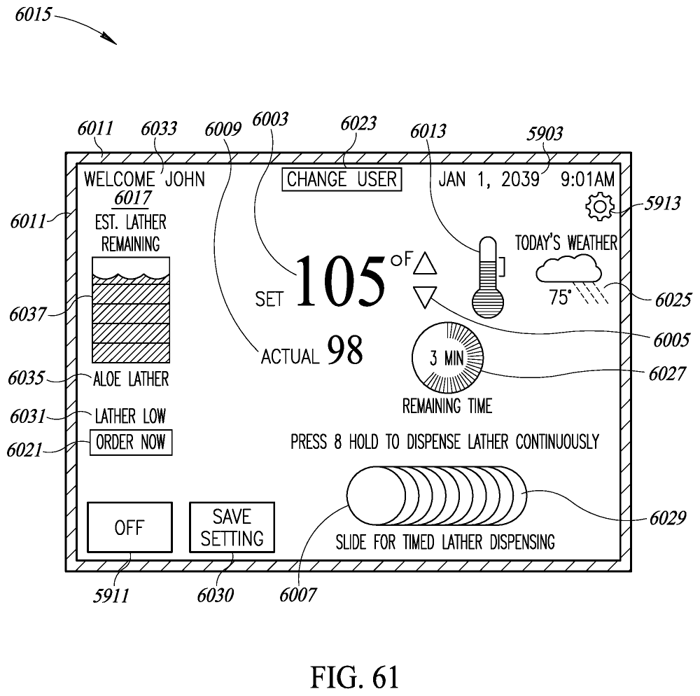

FIG. 61 shows a screen shot 6015 of a portion of an operating mode screen 6017 rendered by a lather system in accordance with embodiments of the present system. The operating mode screen 6017 may be rendered by the system after a registered user is selected. For example, during a standby mode, a selection of a user such as “JOHN” may be selected from the start screen 5901. In yet other embodiments, it is envisioned that the operating mode screen 6017 may be a default screen upon waking up. As the screen 6017 may be similar to screen 6001, similar numerals may be used for the same and/or similar features and advantages as discussed above with respect to FIG. 60. Accordingly, the user is directed to the description of FIG. 60 for these features. It is envisioned that the operating mode screen 6017 may include other features and advantages such as a remaining lather information area 6037, an auto-order lather selection item 6021, a change user selection item 6023, an optional information area 6025, a time remaining area 6027, a timed lather dispensing mode (TLDM) selection item 6029, an update selection item 6030, a user identification area 6033, and a lather low indictor area 6031, and a lather identification area 6035.

With regard to the set temperature area 6003, in current embodiments the set temperature may correspond with the stored temperature settings of the identified registered user (e.g., “JOHN” in the current embodiments) which settings may be stored in the USI for the user corresponding user (e.g., JOHN).

To identify a user, the user may select his or her name through the selection of a selection item or by inputting his or her name using a user interface (UI) of the system. It is envisioned that embodiments of the present system may also employ biometric engines which may obtain a biometric sample from a user and verify that the user is a registered user based upon the biometric sample. The biometric sample may be obtained passively (e.g., via facial recognition, a voice sample (overheard by the system in the course of the user's speech), etc.) or may be obtained actively (e.g., a voice sample (e.g., spoken to the system), a fingerprint sample, a palm print, a writing sample (e.g., a signature, etc.) of the user, etc.). The obtained biometric sample may then be compared with a corresponding sample that was previously stored in association with the USI. Then, if the system determines that the current biometric sample corresponds with, or otherwise matches, the stored biometric sample the system may verify the registered user.

For example, in accordance with some embodiments, a registered user may be identified through using biometric information which may be stored in association with a registered user. Accordingly, a user may be verified (e.g., identified) when a match of corresponding biometric information such as biometric sample information and a biometric input is determined. For example, the system may obtain biometric information from a user such as a voice print for example, a user may say a predetermined word or phrase that the system or the user may select, and the system may store this voice print for later use in association with the user. Accordingly, the system may provide the user with an option to record a selected word or phrase and this recording may be stored as user information in a memory of the system. For example, if a user provides a voice sample such as “lather machine on,” during a user setup process, the system may store this voice information of the user and may then compare this voice information with stored voice information to identify whether the individual providing future voice information is the same user (i.e., a registered user). Accordingly, if it is determined that the user is a registered user, the system may obtain user information related to settings of the corresponding user from USI stored in memory for the corresponding user. Thereafter, the system may set operating parameters in accordance with the settings of the corresponding user as may be set forth in the USI for the user and enter a warming mode. In accordance with yet other embodiments, the system may obtain other biometric samples, such as an image for performing facial recognition, a fingerprint for performing fingerprint analysis, a palm print for performing palm print analysis, a writing sample, etc. If any of the obtained biometric samples is verified as corresponding to a registered user, the system may set operating parameters in accordance with the settings (e.g., as set forth in the USI) of the corresponding user and enter a warming mode or other mode as may be set by the system and/or user. The system may further include capabilities to select other languages, dialects, and/or provide for disabled users. For example, the system may include a mode to magnify icons and/or graphics for those who may desired it.

With regard to the remaining lather information area 6037, this area may be indicative of the percent of fluid remaining in the mixture cartridge since installation. Accordingly, the system may provide an input for the user to select the installation of a new mixture cartridge and/or may read information (e.g., optically, electronically, etc.) from the mixture cartridge to determine parameters of the mixture cartridge being installed such as fluid capacity, etc.

To determine fluid used and, thus, remaining fluid levels, the controller may keep track of or otherwise record a number of uses and a duration of each use of the lather generator. Accordingly, the system may then determine using any suitable analysis technique an amount of liquid such as lather solution which was used by the system from the sum of past uses for the current mixture cartridge. The system may add (e.g., sum) the amount of liquid used in each use and from this information determine a total amount of liquid used and store this information as liquid used information for later use. The system may then render the liquid used information (e.g., indicative of a sum of liquid use for the current mixture cartridge) graphically in the lather information area 6037. In embodiments which use a liquid pump to pump the liquid such as the lather mixture, the system may determine a number of revolutions of the pump (e.g., via sensor information or via control information such as may be available when operating a stepper motor) and may determine an exact amount of liquid (e.g., lather mixture) used based upon the determined number of revolutions and known pumping capacity per revolution and may store this information as liquid used information in a memory of the system.

The system may store pump information which may indicate an amount of fluid pumped by the pump with respect to revolutions, pump capacity per revolution, time, operating intervals, etc. Further, the pump information may include information related to capacity of the pump. For example, if using a piston type pump, one stroke of the pump may be equal to, for example, y ml, where y may be a value stored in a memory of the system and may correspond with a volume of the pump (e.g., in milliliters or ml). The system may then determine a volume of liquid pumped by the pump based upon this volume and an actual stroke (Sact) of the pump (when pumping fluid) divided by the full stroke (Sfull) of the pump. For example, a full stroke of the pump may yield y ml while a half stroke may be ½ y ml. In a similar manner, the system may determine a volume of liquid pumped by each pump per cycle or portion thereof. For example, when using other types of pumps such as a peristaltic pump driven by a stepper motor, the system may store information related to the capacity of the pump for each revolution of the stepper motor. Then, for example, if the system rotates the stepper motor 1 revolution, it may determine the amount of liquid pumped. Further, the system may store information related to the sum of fluid pumped for a plurality of operations (which may be referred to as a sum fluid value) such as from the insertion of a new mixture cartridge. Then, the system may subtract this information (e.g., the sum fluid value (SFV)) from stored cartridge information which may be indicative of a total fluid in each cartridge (which may be referred to as total fluid value (TFV)). Then, the system may then determine a percent of fluid remaining value (PFRV) within the mixture cartridge using the following formula: PFRV=(TFV−SFV)/TFV. Then, the system may graphically and/or numerically render the value of PFRV. Thus, for example, if PFRV is found to be 1, then the graphic on the cartridge will be rendered as full. Then, if PFRV is found to be 0.5, the graphic will be rendered as ½ full.

With regard to the lather low indicator 6031, the system may compare the PFRV with a threshold value for a low lather (e.g., 0.00-1.00). Accordingly, if it is determined that the PFRV is less than or equal to the threshold value (e.g., 0.50), the system may render and/or highlight the lather low indicator 6031. If it is determined that the PFRV is greater than or equal to the threshold value, the lather low indicator 6031 will not be not rendered and/or highlighted.

With regard to the auto-order lather selection item 6021, this selection item may be highlighted to indicate when an auto-order mode is activated and/or to provide a user with an option to manually activate the auto-order mode (e.g., by manually depressing the lather selection item 6021) to electronically order one or more mixture cartridges in accordance with system and/or user settings. For example, the auto-order option may be activated when it is determined that the PFRV is less than or equal to the threshold value (e.g., 0.50 or other value as may be set by the user and/or system), the system may render and/or highlight the auto-order lather indicator 6031 for selection by a user. Accordingly, if a user selects the auto-order selection item 6021, the system may automatically electronically order one or more mixture cartridges and/or types of mixture cartridges (e.g., Lavender, Honey, etc.) depending upon system settings using a merchandise account of a user (e.g., an eBay, amazon, etc. account of the user).

In accordance with embodiments, when the auto-order lather selection item is selected by a registered user, the system may attempt to communicate with a smartphone application and/or a registered website (e.g., Amazon, etc. via any suitable method) to order more lather or mixture cartridge in accordance with system and/or user settings. The system may store account identification, user name, passwords, and/or other system information for authentication of a desired account, access to the desired account, and automated ordering using the desired account. It is envisioned that in yet other embodiments the system may communicate with a smart phone application which may perform the ordering.

With regard to the change user selection item 6023, when this selection item is selected by user, the system may render the start screen such as the start screen 5901 or another screen which may display the names of at least one registered user and corresponding selection items for selection by the user. The user may then select a desired user (e.g., by name, guest, default setting, etc.) and the system upon receiving the selection may obtain user information for the selected user and may set system settings accordingly. For the sake of clarity, it will be assumed that a guest user may be considered a registered user by default. Accordingly, default settings may apply to the guest user and may be changed by a primary user.

It will also be appreciated that the system may restrict access to selected information such as select system settings and select USI to users other than a primary user. Further, access to select information such as USI stored by the system may be restricted and may require authorization by way of a password and/or a biometric identifier. For example, upon detecting that a registered user was selected, the system may request a password be input to authorize access to the USI for the registered user.

With regard to the optional information area 6025, this area may display third-party-sourced information selected by a user for display. The third-party-sourced information may be obtained via a network connection (e.g., the Internet) and may include information available from a third-party source as may be selected by the user. Accordingly, the system may provide the user with an option to select the third-party source such as a weather source (e.g., Accuweather from accuweather.com), a news source (e.g., the wall street journal available at wsj.com, etc.), and/or other sources as may be selected by the user. This information may be updated in real time and may include video information.

With regard to the time remaining area 6027, this area may display an estimated remaining time (ERT) until the actual temperature (T_{ACT}) reaches the set temperature (T_{SET}). For example, the system may obtain an actual temperature from sensors (e.g., 20-2) which detect the actual temperature of the body of the lather generator (e.g., FIG. 4, sensors 20-1). Then, the system may obtain information indicating temperature rise per unit time (TR deg/min) such as temperature rise per minute (e.g., TR=3). The system may then use this information to calculate remaining time using any suitable method such as using the following calculation ERT=(T_{SET}−T_{ACT})/TR min. The system may render the calculated ERT numerically and/or graphically using any suitable method such as that shown. The system may continuously update the ERT and render this information. Further, when the ERT is determined to be equal to 0, the system may change the time remaining area 6027 to a solid color such as green to indicate that the system is ready and may switch to a ready mode and await a lather dispense request from the user or sensors of the system. The system may use heuristic data to determine the ERT, T_{ACT}, T_{ACT}, and TR. For example, the system may store previous operating parameters such as ERT, T_{ACT}, T_{ACT}, and/or TR for a plurality of operating cycles. Then, the system may heuristically analyze this previously stored information and may determine the TR for the current use cycle based upon this analysis.

With regard to the timed LDM (TLDM) selection item 6029, if this selection item is selected (such as by using a sliding gesture such as a left to right gesture which may be performed over the TLDM selection item 6029), the system may recognize this selection as a request to start a TLDM mode for a duration of time as may be set by the user and/or system using a duration of lather dispensing setting (DLDM) value as will be discussed below). For example, assuming that the user has set the DLDM value to 5 seconds in the USI for the user, then, the system may operate the motor (e.g., 12), the actuator controlling the flow of lather mixture and/or the motor controlling the flow of lather mixture in accordance with DLDM value for about 5 seconds such that the lather may be dispensed for about 5 seconds. Accordingly, the user may not have to continuously hold his or her hand in a sensory area to activate the LDM or continuously hold a lather selection item (e.g., 6007) to dispense lather. Rather a single one-step operation such as the sliding gesture discussed above may be used. In yet other embodiments other gestures and or selection items are also envisioned and may be programmable by user.

With regard to the user identification area 6033, the system may determine a name of the current registered user and may render the name of the current registered user for the convenience of the user. This may prevent the user from inadvertently using the lather generator with the settings of another.

With regard to the save settings selection item 6030, when this section item is selected, and the system may update current settings such as the set temperature setting in association with the user settings for the current user and store these settings in a memory of the system. If is determined that the current user is a guest user, the system may only perform the update of current settings subject to previously set permissions. For example, if the primary user set the user information for the guest such that settings cannot be changed, then the system will not update the guest settings absent proper authorization (e.g., from the primary user and/or a password). For example, the system may provide the user with a password entry box in which the user may enter an authorized password and then, upon authenticating the password, the system may perform the update when the current user is a guest account.

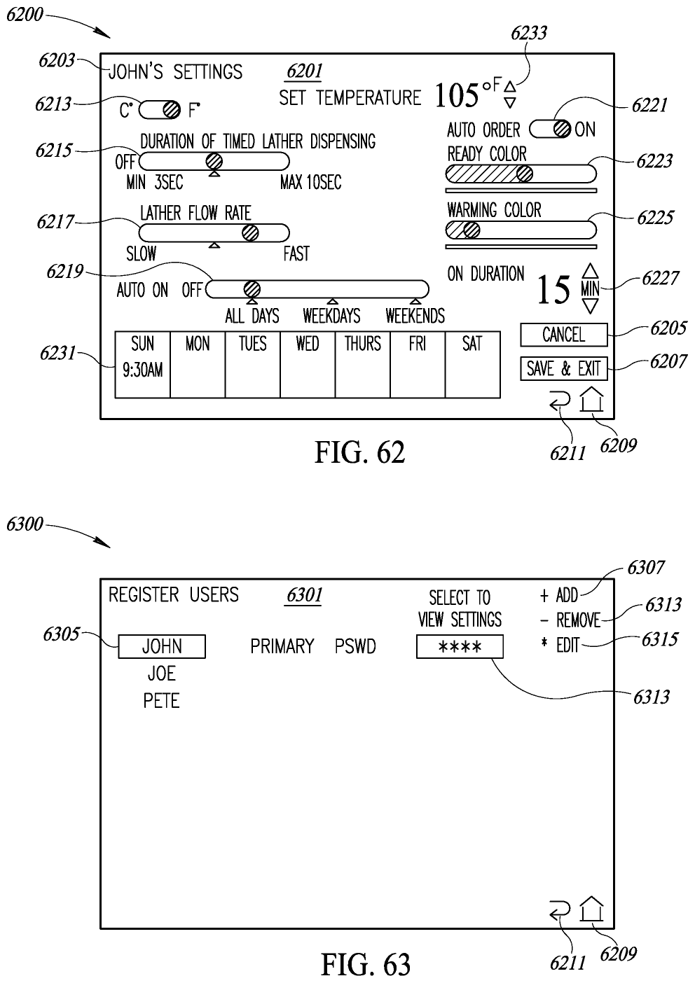

FIG. 62 shows a screen shot 6200 of a portion of a user setting information (USI) screen 6021 rendered by a lather system in accordance with embodiments of the present system. The USI screen 6021 may include a plurality of options to view, set, and/or reset system information such as user setting information (USI) that may be used to control one or more parameters of the system by the controller in accordance with embodiments of the present system. The user settings screen may include information such as one or more of a Celsius or Fahrenheit selection item 6213, a one-step lather dispensing selection item 6215, a lather flow rate selection item 6217, an auto on selection item 6219, an auto order selection item 6221, a ready color selection item 6223, a warming color selection item 6225, an on duration selection item 6227, a settings calendar 6231, a set temperature selection item 6233, a user identification area 6203, and one or more navigation selection items such as a cancel selection item 6205, a save and exit selection item 6207, a back section item 6209, and a home selection item 6211.

With regard to the Celsius or Fahrenheit selection 6213, this selection item may include a slider and may provide a user with a method to select between Celsius or Fahrenheit for temperature settings of the system. Upon detecting selection of the Celsius or Fahrenheit selection, the system may change other corresponding temperature settings accordingly. This may assure that the correct temperature settings are generated and/or rendered by the system. For example, upon detecting that Fahrenheit selection is set, the system may change the set and actual temperature information settings (e.g., 6003 and 6009, respectively) to Fahrenheit measurements. If the Celsius selection is set, the system may change set and actual temperature information settings accordingly.

With regard to the set temperature selection item 6233, this selection item may provide the user with a method to change the set temperature settings of the system for the user.

With regard to the lather dispensing time selection item 6215, this selection item may include a slider with a plurality of settings such as off and minimum through maximum time (e.g., 3-10 seconds) to control the DLDM value (e.g., 6029, FIG. 61). This selection item may further provide an option for a user to select an activation method for the timed LDM selection item such as by selecting to depress a selection item (e.g., a soft key) and/or to perform a gesture such as the sliding gesture to activate the timed LDM.

With regard to the lather flow rate selection item 6217, this optional selection item may be adjusted between a slow and fast setting to control a flow rate of lather output by the system using any suitable method or methods such as control of motor speed that drives the LGS (e.g., FIG. 4, motor 14 and 94 LGS), fluid flow rate by control of speed of a motor of the pump (e.g., 18, FIG. 1; 437, FIG. 50) and/or by controlling an opening of one or more valves through which fluid such as the lather solution may pass (e.g., variable throttling of the fluid to adjust flow rate) and may depend upon system configuration. For example, by increasing the motor speed of the motor driving the LGS, it may take less time for fluid (e.g., lather mixture) entering the lather generator to be formed into a lather and output. Conversely, by lowering the motor speed of the motor driving the LGS, it may take more time for fluid entering the lather generator to be formed into a lather and output. Similarly, by controlling the flow (e.g., by throttling) of fluid such as lather solution entering the lather generator, the output of the lather generator may be controlled. For example, by reducing the flow rate of fluid entering the lather generator (e.g., 16), the output of lather by the lather generator may be reduced over time. Conversely, by increasing the flow rate of fluid entering the lather generator, the output of the lather generator may be increased over time. The system may further determine the flow rate of the fluid entering the lather generator and adjust the speed of the motor driving the LGS accordingly. For example, as the rate of fluid entering the lather generator increases, the controller may increase the speed of the motor driving the LGS. Conversely, as the rate of fluid entering the lather generator decreases, the controller may decrease the speed of the motor driving the LGS. By controlling the speed of the motor driving the LGS and/or the flow rate of the fluid entering the lather generator, the consistency of the lather output by the lather generator may vary as may be selected by the user. Accordingly, options to vary the speed of the motor driving the LGS and/or the flow rate of the liquid entering the LGS may be provided to the user so that the user may vary these settings as desired. Further, by varying these settings a consistency of the lather may vary. In yet other embodiments, the control of flow rate and/or speed of the LGS may be fixed or substantially fixed.

With regard to the auto on selection item 6219, this selection item may control when the system activates a warming mode. Automatic activation of the warming mode may be desirable when a user wishes to have the lather generator warmed and ready passively without having to turn it on or request a warming mode before use. Accordingly, a user may select between off (e.g., manual on mode activation) and all days, weekdays, and weekends. If all days is selected, the system may activate a warming mode at the selected time on all days. If weekdays is selected, the system may activate a warming mode at the selected time on all weekday days. Similarly, if weekends is selected, the system may activate the warming mode at the selected time on all weekend days. With regard to manual warming mode activation, the user may have to manually turn on the system e.g., by selecting a hard or soft key, by activating one or more sensors of the system such as by touching a touch display of the system, through biometric recognition (e.g., optical recognition (e.g., facial analysis), voice activation such as by speaking to the system, and/or other biometric information), and/or by activating a proximity sensor of the system.

With regard to the on-duration selection item 6227, this setting may control an on-duration time of the during a warming mode and/or a dispensing mode. This time may vary as desired by a user. Then once the set duration time is determined to elapse, the system may enter a standby mode (e.g., a sleep state) depending upon system settings.

With regard to the auto order selection item 6221, this selection item may have on and off settings to select whether the auto-order mode is activated. If activated, the system may auto order one or more mixture cartridges depending upon system settings. For example, when it is determined or otherwise estimated that the liquid in the mixture cartridge is below a threshold value, the system may active the auto-order mode. The user may further activate the auto order mode manually by, for example, depressing an auto-order selection item rendered by the system. In accordance with embodiments of the present system, an authorization to perform the auto order mode may be requested prior to ordering.

Ready and warming color selection items 6223 and 6225, respectively, will now be discussed. Generally, these selection items may include a color slider to select a color for the corresponding setting. Sample colors may be rendered on the display under the selection items and may provide the user with a reference for color selection. For example, the warming color selection item 6225 may be set to red to indicate a not-ready status of the system while the lather generator is warming up. The warming color indicator may further be output with a text or graphic indication such as a message which may indicate “system warming, please wait”). The warming indicator may be referred to as a not-ready indicator. The warming color indicator generated in accordance with a setting of the warming color selection item 6225 may be rendered on a rendering device of the system (e.g., 6011, etc.) when the system is warming (e.g., not ready) in which case the actual temperature (T_{ACT}) is less than the set temperature (T_{SET}).

With regard to the ready color selection item 6223, this selection item may provide the user with an option such as a slider to select a color that may be rendered by the system to indicate that it is ready (e.g., as may occur when the actual temperature greater than or equal to the set temperature) and may be ready. This selected color maybe used to indicate the status of the system to the user and may be rendered on a display or other indicator (e.g., a status indicator light) of the system.

The ready color indicator generated in accordance with a setting of the ready color selection item 6223 may be rendered on a rendering device of the system (e.g., 6011, etc.) when the system is ready (e.g., the actual temperature (T_{ACT}) is equal to or greater than the set temperature (T_{SET}).

With regard to the warming color selection item 6225, this selection item may provide the user with an option such as a slider to select a color (e.g., a highlighting color) that may be rendered by the system to indicate that it is still warming (e.g., which may occur when the set temperature is greater than the actual temperature) and may not be ready. This selected color maybe used to indicate the status of the system to the user and may be rendered on a display or other indicator (e.g., a status indicator light) of the system.

The settings calendar 6231 may provide a user with a graphical representation including a graphical representation (e.g., a calendar, etc.) of selected days (e.g., weekend, weekday, all days) during which the system may enter a warming mode at desired dates and times as shown.

With regard to the user identification area 6203, this area may display information related to a user such as the identification of the user (e.g., John) in the current embodiments.

With regard to the navigation selection items, the cancel selection item 6205 may provide a selection item to cancel changes to the user settings information when the cancel selection item 6205 is detected to be depressed, the system may cancel changes before they may be saved to the USI and may continue to render the current screen.

With regard to the save and exit selection item 6207, when it is determined that the exit selection has been selected, the system may update system settings and/or the USI for the current user in accordance with the current settings. Then the system may exit the current window and enter a current window.

With regard to the cancel selection item 6205, when it is determined that the cancel selection item 6205 has been selected, the system may cancel current changes and revert to previous settings.

With regard to the back and home selection items 6209 and 6211, respectively, when it is determined that the user has selected one of these selection items, the system may render a previous screen or a home screen, respectively.

FIG. 63 shows a screen shot 6300 of a portion of a registered user screen 6301 rendered by a lather system in accordance with embodiments of the present system. The registered user screen 6301 may include a plurality of selection items which may be selected to add 6307, remove 6313, or edit 6315 accounts of registered users. A list of registered users 6305 may be rendered and a user may select any of the registered users to view account settings for the registered user. A password entry window 6313 may be provided for a user to enter a password to view the account settings for accounts of registered users that may be password protected such as the primary registered user (e.g., John in the current example). A soft keyboard may be rendered for the user to enter the password. In yet other embodiments, it is envisioned that a voice recognition system may be used for a user to audibly enter the password and/or other inputs.

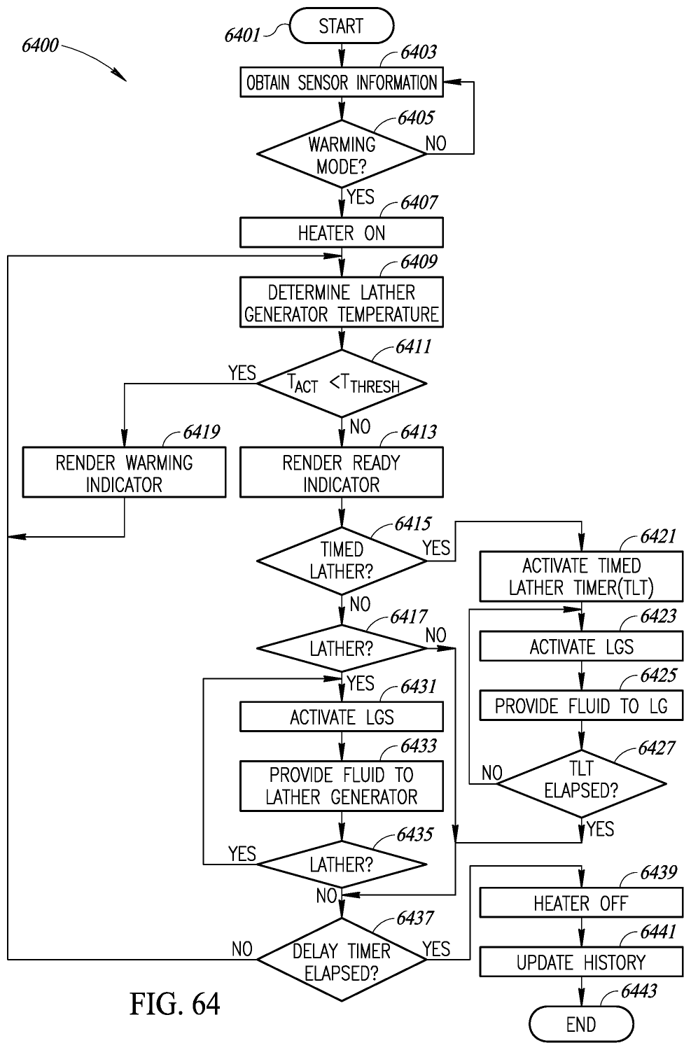

A method to form a lather from a lather mixture will now be discussed with reference to FIG. 64 which illustrates a flowchart 6400 showing a portion of a process to form lather in accordance with embodiments of the present system. The process may be performed using one or more logic devices (e.g., controllers, processors, micro-processors, shift registers, gates, circuits, etc.) communicating over any suitable medium (e.g., a network) to obtain information from, and/or store information to, one or more memories which may be local and/or remote from each other. The process may include one or more of the steps discussed below and may differ from the order in which they are described as may be desired with appropriate discretion. One or more of the following steps may be combined, separated into one or more sub-steps as may be desired, and/or may be skipped depending upon system and/or user settings. During the process, information generated and/or obtained by the process may be encrypted and/or stored for a desired duration (e.g., for a desired period of time) or longer as may be desired in a memory of the system. The process may start during step 6401 and then proceed to step 6403.

During step 6403, the system may obtain sensor information from one or more sensors of the system. For example, the system may obtain proximity information from a proximity sensor (e.g., sensor 20-02), touch-display information from a touchscreen of the system, alarm information from an alarm of the system (e.g., an alarm that may indicate a time, day, and/or date), and/or switch depress information from a switch of the system which may indicate that the switch has been depressed (e.g., switch 420). For example, when a user touches a touch screen or depresses a switch such as switch 420, a corresponding signal including corresponding sensor information may be transmitted to a controller of the system. Similarly, when an object, such as a hand of a user is placed in proximity to the proximity sensors, the proximity sensors may sense this and transmit proximity information to the controller indicating the proximity of the object (e.g., a user's hand in opening 50).

The sensor information may be filtered in accordance with user settings as may be set forth in the USI and/or in accordance with system settings. For example, the USI may set forth information which may indicate which sensors to disable (or filter) and/or which sensors to enable (e.g., to collect sensor information from). Thus, if the USI indicates that a sensor should be disabled, then the controller may filter (e.g., ignore) information from that sensor. In accordance with embodiments of the present system non-critical sensors may be disabled while critical sensors, such as temperature sensors (e.g., 20-1), may not be disabled. Critical and/or non-critical sensors may be defined by system parameters. In accordance with embodiments of the present system, the system may provide a user with a UI with which a user may select sensors to disable or enable and the system may store this information in the USI in association with the user.

For example, the controller may receive touch screen sensor information from a touch-screen display of the system and determine whether it has been touched based upon an analysis of the touch-screen sensor information. Similarly, the controller may receive an alarm signal from an alarm sensor (e.g., indicative of an alarm signal generated by the system to indicate that an alarm time (such as a wake-up time for a selected user such as the primary user in the current embodiments) has elapsed.

In the present embodiments, it will be assumed that the sensor information may be obtained from selected sensors (e.g., sensors which are not filtered) such as a touch-screen of the system (which may generate touch-information), an alarm (e.g., a day, date, time alarm). For example, assuming that a user set the alarm for 7:00 am all days of the week. Then, at this time (e.g., 7:00 am) each day of the week the alarm may generate an alarm signal and transmit this alarm signal to the controller of the system which may then analyze this signal.

After completing step 6403, the system may continue to step 6405. During step 6405, the system may determine whether to enter a warming mode. The system may determine whether to enter a warming mode when sensor information from an enabled sensor is received by the controller. Accordingly, if it is determined that sensor information from an enabled sensor is received, the system may continue to step 6407. If it is determined that sensor information from an enabled sensor is not received, the system may repeat step 6403.

For example, in the current embodiments the touch-screen, alarm, and proximity sensors may be considered to be enabled sensors. Thus, if it is determined that the touch-screen (of the system) has been depressed (e.g., indicative of the touch-screen being touched), an alarm signal is generated (e.g., indicative of a wake-up time having elapsed), and/or a proximity signal is generated, upon receiving these signals the controller may determine to continue to step 6407. If it is determined that the touch-screen (of the system) has not been depressed (e.g., indicative of the touch-screen being touched) and the alarm signal (e.g., indicative of a wake-up time having elapsed) has not been received, the system may repeat 6403.

During step 6407, the system may turn a heater of the system on. More particularly, the heater may be configured to warm at least desired portions of the lather generator and/or other desired portions of the system as may be provided. During this step, the system may be configured to provide power to the heater or heaters of the system such as the IRWHE 80. For example, the system may generate a pulse-width modulated (PWM) power signal to the IRWHE 80 to cause the IRWHE 80 or other type of heater to generate heat which heat may be used to warm at least desired portions of the lather generator. The system may control power to the RWHE by modulating the PWM power signal in accordance with settings as may be set by the system and/or user. This may provide for slower or faster heating of the lather generator as may be desired by the system and/or user.

The system may employ any suitable method to control heating of the RWHE or IRWHE. For example, it is further envisioned that the system may employ a current and temperature feedback system to finely control the temperature of the lather generator. For example, using feedback information such as T_{ACT}, the system may obtain T_{SET} as will be discussed below. The system may then accurately control the temperature of the lather generator by reducing power to the RWHE if it is determined that T_{ACT} is equal to, or greater than, T_{SET}. Further, the system may adjust the power to the IRWHE in relation (e.g., linear or non-linear) to a difference between T_{ACT} and T_{SET}. Accordingly, as the T_{ACT} approaches T_{SET}, the system may lower the power to the IRWHE so that the temperature of the lather generator may be precisely controlled.

It is further envisioned that during the current step, the process may further set a delay timer (DT) with a delay time (T_{DELAY}) as may be set by the USI and/or system settings. For example, the delay time may be set to, for example, 15 minutes. The delay timer may then be activated as a countdown timer to count down this time. The delay time (T_{DELAY}) may be set by the system and/or user and stored in the USI for a corresponding user and may provide an operating time (window) during which the user may request lather. This may be desirable during a current shaving cycle in which lather may be desired more than once and/or when a user does not know exactly when the lather system may be used (e.g., after a shower, etc.). Thus, the system may turn on and provide an operating window such as 15 minutes in the present embodiments. In yet other embodiments, other delay times are also envisioned.

After completing step 6407, the system may continue to step 6409. During step 6409, the system may determine actual temperature (T_{ACT}) of the lather generator. The system may determine the temperature of the lather generator using any suitable method such as obtaining temperature information related to the lather generator from a temperature sensor of the system such as the sensor 20-1 or the like. After completing step 6409, the system may continue to step 6411.

During step 6411, the system may compare T_{ACT} with the temperature set by the current user T_{SET} and determine whether T_{ACT} is less than T_{SET} wherein T_{SET} is the temperature set by the current user and may be obtained directly from the user and/or from the USI for the current user (e.g., the primary user in the current embodiments). Accordingly, if it is determined that T_{ACT} is less than T_{SET}, then the system may continue to step 6419. If it is determined that T_{ACT} is not less than T_{SET} (i.e., indicative of T_{ACT} is equal to, or greater than, T_{SET}), then the system may continue to step 6413.

During step 6419, the process may render a warming indication on a rendering device of the system such as on an indication bezel, a display, etc. The system may highlight the warming indication using a highlight color as may be set by the USI (e.g., FIG. 62, 6225). The warming indication may include textual, graphical, and/or other indicators (e.g., audible, vibratory, etc.) indicating a current status of the system (e.g., the system is warming) such as “warming” and/or an associated highlighting (e.g., FIG. 62 highlighting color 6225). The highlighting color may be rendered on the display in one or more areas such as the highlighting of the lather selection item 6007, the ready indicator 6011, and/or the textual indictor (e.g., “warming,” etc.). Further, bezels, rendering devices such as display screens, and/or the mixture cartridge may be highlighted using the warming color to indicate the status of the system. Accordingly, a user of the system may conveniently ascertain status of the system from near and/or afar. Further, the system may calculate the remaining time for the warming process and may render this time on a rendering device of the system for the convenience of the user. (e.g., 6027, FIG. 61). After completing step 6419, the system may repeat step 6409.

During step 6413, the process may render a ready indication on a rendering device of the system such as on an indication bezel, a rendering device such as a display, etc. The system may highlight the ready indication using a highlight color as may be set by the USI (e.g., 6223, FIG. 62). The ready indication may include textual, graphical, and/or other indicators (e.g., audible, vibratory, etc.) indicating a current status of the system such as “ready” and/or an associated highlighting (e.g., FIG. 62 highlighting color 6223). The highlighting color may be rendered on the display in one or more areas such as the highlighting of the lather selection item 6007, the ready indicator 6011, and/or the textual indictor (e.g., “ready” text). Further, bezels, screens, and/or the mixture cartridge may be highlighted using the ready color to indicate the status of the system. Accordingly, a user of the system may conveniently ascertain status of the system. After completing step 6413, the system may continue to step 6415.

During step 6415, the system may determine whether a timed lather dispensing mode has been selected (e.g., by the user). Accordingly, if it is determined that a timed lather dispensing mode has been selected, the system may continue to 6421. If it is determined that a timed lather dispensing mode has not been selected, the system may continue to step 6417.

The timed lather dispensing mode may be selected when it is determined that a user has input a timed lather dispensing mode selection by selecting a timed lather mode selection item (e.g., 6029, FIG. 61) or by performing a swipe to the right across the display screen upon the timed lather mode selection item. In accordance with yet other embodiments, it is envisioned that other keys and/or gestures (e.g., swipes, etc.) may be mapped to this step and stored in the USI and may be selected by the user.

During step 6417, the system may determine whether a lather dispensing mode has been requested. Accordingly, if it is determined that that a lather dispensing mode has been requested, the system may continue to step 6431 where it may enter a lather dispensing mode (LDM). If it is determined that a lather dispensing mode has not been requested, the system may continue to step 6437. The system may determine that a lather dispensing mode has been requested when a lather dispensing sensor has been activated using any suitable sensory device such as an electromechanical switch (e.g., 420, FIG. 41), an optical sensor (e.g., the proximity sensor 20-2) or a lather selection item (e.g., 6007, FIG. 60 and FIG. 61) has been selected. For example, in the present embodiments, the user may select the lather selection item 6007 or the like to request lather in which case the system may determine that a lather dispensing mode has been selected.

During step 6431, the system may activate the LGS to rotate. Accordingly, a controller of the system may send a drive signal to the motor coupled to the LGS which signal may activate the motor to rotate the LGS.

It is envisioned that the LGS may be driven by motive forces generated by devices other than electric motors such as a wound spring which may be substituted for the motor. A spring control actuator may selectively lock an output shaft coupled to the spring to prevent the spring from being unwound until desired. Prior to use, the spring may be wound and the spring control actuator locked. Thereafter when lather is requested, the spring control actuator may unlock to allow the output shaft be driven by the spring and rotate. Accordingly, an LGS coupled to the output shaft may rotate and generate lather.

After completing step 6431, the process may continue to step 6433. During step 6433, the system may provide a fluid such as a lather mixture to the lather generator. Accordingly, the system may establish fluid flow of the lather mixture from a reservoir of the system to the lather generator. For example, the fluid flow may be established by controlling a valve controlling the flow of fluid from the reservoir to the lather generator to open such that fluid may flow from the reservoir to the lather generator and/or by activating a motor coupled to a pump to pump fluid such as the lather solution from the reservoir to the lather generator depending upon system configuration. Accordingly, the lather generator may be provided with a fluid such as the lather mixture and may generate a lather from this fluid. After completing step 6433, the process may continue to step 6435.

During step 6435, the system may the system may determine whether a lather dispensing mode is requested. As this step may be similar to step 6417 accordingly, the reader is directed to the description of step 6417. Accordingly, if it is determined that that a lather dispensing mode is requested, the system may repeat step 6431. If it is determined that a lather dispensing mode is not requested (e.g., user no longer requests lather), the system may continue to step 6437. Step 6435 may be used to provide a user with an uninterrupted supply of lather.

During step 6437, the system may determine whether the delay time (T_{DELAY}) has elapsed. Accordingly, if it is determined that the delay time (T_{DELAY}) has elapsed, the system may continue to step 6439. If it is determined that the delay time (T_{DELAY}) has not elapsed, the system may repeat step 6409.

During step 6439, the system may turn off the heater. After completing step 6439, the process may continue to step 6441. During step 6441, the process may update history information and store this information in a memory of the system for later use. For example, the system may update information indicative of an actual warm up time for the lather generator. This information may thereafter be used to more accurately calculate a warm-up time for a future use. The system may further update use time and/or fluid (e.g., lather) usage information so that an amount of fluid remaining in the reservoir may be determined. Further the system may update user settings such as T_{SET} as may be desired such that during a next use by the user T_{SET} may reflect the current setting rather than a past setting, depending upon user and/or system settings. For example, the system may request confirmation to update the USI of the current user to reflect a current change in T_{SET}. After completing step 6441, the process may continue to step 6443 where it may end.

During step 6421 the process may activate a timed lather dispensing mode (LDM) timer (TLDMT) for a duration of time as may be set by a DLDM value obtained from the USI for the current user. For example, the DLDM value may be set to 5 (seconds) in which case the system may dispense lather for a duration of time (in seconds) equal to the DLDM value. Accordingly, the system may be configured to operate the motor (e.g., motor 12, FIG. 4), the actuator controlling the flow of lather and/or the motor controlling the flow of lather in accordance with DLDM value for about 5 seconds such that the lather may be dispensed for about 5 seconds. In accordance with embodiments of the present system, the DLDM value may be determined dynamically based upon a length of a swipe of the user across a touch screen of the system over the timed lather mode selection item (e.g., 6029, FIG. 61).

After completing step 6421, the process may continue to step 6423. During step 6423, the system may activate the LGS to rotate. Accordingly, a controller of the system may send a drive signal to the motor coupled to the LGS which signal may activate the motor to rotate the LGS. This step may be similar to step 6431. Accordingly, a further description thereof is not provided. After completing step 6423, the process may continue to step 6425.

During step 6425, the system may provide the lather generator with a fluid such as the lather mixture. Accordingly, the system may establish fluid flow (e.g., of the lather mixture) from a reservoir of the system to the lather generator. For example, the fluid flow may be established by activating a valve controlling the flow of fluid from the reservoir to the lather generator to open such that fluid may flow from the reservoir to the lather generator and/or by activating a motor coupled to a pump to pump fluid such as the lather solution from the reservoir to the lather generator depending upon system configuration. Accordingly, the lather generator may be provided with fluid (such as the lather mixture) to generate a lather. This step may be similar to step 6433. After completing step 6425, the process may continue to step 6427.

During step 6427, the system may determine whether the TLDMT has elapsed. Accordingly, if it is determined that the TLDMT timer (which was set with the DLDM value) has elapsed, the system may continue to step 6437. If it is determined that the TLDMT timer (which was set with the DLDM value) has not elapsed, the system may repeat step 6423.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediary components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the claims, any reference signs placed between parentheses shall not be construed as limiting the claim. The use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first,” “second,” etc. are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A lather generating apparatus, comprising:
an inlet port configured to be coupled to an outlet port of a mixture cartridge to receive a liquid shaving lather solution from the mixture cartridge;
a lather generator having a cavity with first and second openings and a lather generating screw (LGS) situated within the cavity;
at least one motor configured to drive a pump cartridge to pump the liquid shaving lather solution from the mixture cartridge to the first opening of the lather generator, and to drive the LGS to generate a lather from the liquid shaving lather solution and output the generated lather at the second opening of the lather generator; and
a heater configured to heat the lather generator.

2. The apparatus according to claim 1, further comprising a controller configured to control operation of the at least one motor.

3. The apparatus according to claim 2, further comprising at least one sensor, configured to provide sensor information to the controller.

4. The apparatus according to claim 3, wherein the controller is operative to control the operation of the at least one motor based, at least in part, upon an analysis of the sensor information.

5. The apparatus according to claim 3, wherein the controller controls the heater based, at least in part, upon an analysis of the sensor information.

6. The apparatus according to claim 3, wherein the at least one sensor comprises at least one of a temperature sensor, a touchscreen sensor, and a proximity sensor, and is configured to form corresponding sensor information.

7. The apparatus according to claim 1, further comprising the mixture cartridge having the outlet port and a reservoir configured to contain the liquid shaving lather solution.

8. The apparatus according to claim 7, wherein the mixture cartridge further comprises the pump cartridge.

9. A lather generator apparatus, comprising:
a body comprising:
an opening configured to receive at least a portion of a mixture cartridge;
a fluid receiving port situated in the opening and configured to receive a liquid shaving lather solution from the mixture cartridge;
a lather generator configured to receive the liquid shaving lather solution from the fluid receiving port and generate a lather therefrom, the lather generator comprising a lather generating screw (LGS) situated within an inner cavity thereof;
a heater configured to heat the lather generator; and
a controller configured to determine whether a heater mode is active, and to control operation of the heater when it is determined that the heater mode is active.

10. The apparatus according to claim 9, further comprising a pump configured to pump the liquid shaving lather solution from the mixture cartridge to the lather generator, the pump driven by at least one motor operating under the control of the controller.

11. The apparatus according to claim 9, further comprising at least one motor configured to drive the LGS under the control of the controller.

12. The apparatus according to claim 9, further comprising at least one sensor, configured to provide sensor information to the controller.

13. The apparatus according to claim 12, wherein the controller is further configured to determine an actual temperature of the lather generator based upon the sensor information and to determine a set temperature.

14. The apparatus according to claim 13, further comprising a user interface (UI), wherein the controller is further configured to render at least one of the determined actual and set temperatures on the UI.

15. The apparatus according to claim 10, wherein the controller is configured to activate the at least one motor to activate the pump when it is determined that lather is requested.

16. The apparatus according to claim 11, wherein the controller is further configured activate the at least one motor configured to drive the LGS when it is determined that lather is requested.

17. A lather generator apparatus, comprising:
a mixture cartridge;
at least one motor;
a body comprising:
an opening configured to receive at least a portion of the mixture cartridge;
a fluid receiving port situated in the opening and configured to receive a liquid shaving lather solution from the mixture cartridge;
a lather generator configured to receive the liquid shaving lather solution from the fluid receiving port and generate a lather therefrom, the lather generator comprising a lather generating screw (LGS) situated within an inner cavity thereof and driven by the at least one motor;
at least one sensor comprising at least one of a temperature sensor, a proximity sensor, a touch sensor, and a biometric sensor, the at least one sensor forming corresponding sensor information; and
a controller configured to receive the sensor information and determine an actual temperature of the lather generator based upon the sensor information and to determine whether lather is requested.

18. The apparatus according to claim 17, further comprising a user interface comprising a display.

19. The apparatus according to claim 18, wherein the controller is further configured to render at least one of the determined actual temperature of the lather generator and a set temperature on the display.

20. The apparatus according to claim 18, wherein the controller is further configured to render a lather dispensing selection icon on the display.
